(19) United States
(12) Patent Application Publication
(10) Pub. No.: US 2025/0140455 A1
(43) Pub. Date: May 1, 2025

(54) MAGNETIC CORE, MAGNETIC DEVICE, AND ELECTRONIC APPARATUS

(71) Applicant: TDK CORPORATION, Tokyo (JP)

(72) Inventors: Akito HASEGAWA, Tokyo (JP); Yoshiki Kajiura, Tokyo (JP); Kazuhiro Yoshidome, Tokyo (JP)

(73) Assignee: TDK CORPORATION, Tokyo (JP)

(21) Appl. No.: 18/930,358

(22) Filed: Oct. 29, 2024

(30) Foreign Application Priority Data
Oct. 31, 2023 (JP) 2023-187001
Aug. 28, 2024 (JP) 2024-146912

(51) Int. Cl. H01F 1/147; C22C 38/00; C22C 38/02; C22C 38/30; H01F 27/255

(52) U.S. Cl. CPC H01F 1/14733; C22C 38/002; C22C 38/02; C22C 38/30; H01F 27/255; C22C 2202/02

(57) ABSTRACT

A magnetic core includes soft magnetic particles. Large particles denote soft magnetic particles having a particle size of (0.5×D50) or more in a volume-based particle size distribution of the soft magnetic particles. M is within a specific range, where M denotes a median of AL of the large particles, and AL denotes an average distance from one of the large particles to three of the large particles nearest to the one of the large particles.

### TECHNICAL FIELD

The present invention relates to a magnetic core, a magnetic device, and an electronic apparatus.

### BACKGROUND

Patent Document 1 discloses an inductor in which a coil portion and a dust core manufactured by pressing a metal magnetic powder are integrally molded.

In a situation where a metal magnetic powder is used for a dust core, its core loss is readily increased. Using an amorphous alloy powder as the metal magnetic powder reduces core loss; however, it becomes difficult to increase the density of the dust core at the time of molding.

Patent Document 2 and Patent Document 3 disclose use of a mixture of a crystalline alloy magnetic powder and an amorphous alloy magnetic powder.

Patent Document 4 discloses that use of an amorphous soft magnetic powder having a high average working sphericity can provide an inductor or the like with less loss than a conventional inductor or the like.

### PRIOR ARTS

### Patent Documents

[Patent Document 1] JP Patent Application Laid Open No. 2003-309024
[Patent Document 2] JP Patent Application Laid Open No. 2004-197218
[Patent Document 3] JP Patent Application Laid Open No. 2004-363466
[Patent Document 4] JP Patent No. 5110660

### SUMMARY

### Problem to be Solved by the Invention

It is an object of the present invention to provide a magnetic core with improved DC superimposition characteristics and improved core loss.

### Means for Solving the Problem

To achieve the above object, a magnetic core of an exemplary embodiment according to one aspect of the present invention is
a magnetic core including soft magnetic particles,
wherein 1.0 μm<M<(0.5×D50) is satisfied,
where
M denotes a median of AL of large particles;
AL denotes an average distance from one of the large particles to three of the large particles nearest to the one of the large particles; and
the large particles denote soft magnetic particles having a particle size of (0.5×D50) or more in a volume-based particle size distribution of the soft magnetic particles.

D50 may be 4.0 μm or more and 60.0 μm or less.

To achieve the above object, a magnetic core of an exemplary embodiment according to another aspect of the present invention is
a magnetic core including soft magnetic particles,
wherein
0.35 μm<M<(0.5×D50) is satisfied; and
D50 is 0.80 μm or more and less than 4.0 μm,
where
M denotes a median of AL of large particles;
AL denotes an average distance from one of the large particles to three of the large particles nearest to the one of the large particles; and
the large particles denote soft magnetic particles having a particle size of (0.5×D50) or more in a volume-based particle size distribution of the soft magnetic particles.

The following applies to the magnetic core of the exemplary embodiment according to either aspect described above.

A composition of at least some of the soft magnetic particles may be represented by a composition formula (Fe₁₋ₚX1ₚ)_{100-(a+b+c+d+e+f)}BₐP_{b}Si_{c}C_{d}X2ₑX3_{f} in atomic ratio, where
X1 may include at least one selected from the group consisting of Co and Ni;
X2 may include at least one selected from the group consisting of Ti, Cr, Mn, Al, Ga, Ag, Zn, S, Ca, Mg, V, Sn, As, Sb, Bi, N, Au, Cu, a rare earth element, and a platinum-group element;
X3 may include at least one selected from the group consisting of Zr, Nb, Mo, Hf, Ta, and
W; and
0≤p≤0.5,
2.00≤a≤20.00,
0.00≤b≤14.00,
0.00≤c≤15.00,
0.00≤d≤5.00,
0.00≤e≤3.00,
0.00≤f≤9.00, and
70.00≤100−(a+b+c+d+e+f)≤96.00 may be satisfied.

At least some of the soft magnetic particles may contain only Fe or contain Fe and Co and/or Ni.

A magnetic device of an exemplary embodiment of the present invention includes any of the above magnetic cores.

An electronic apparatus of an exemplary embodiment of the present invention includes any of the above magnetic cores.

### BRIEF DESCRIPTION OF THE DRAWING(S)

FIG. 1 is a sectional SEM image of a magnetic core according to an exemplary embodiment of the present invention.

FIG. 2 is a graph showing a distribution of various lengths.

FIG. 3 is an example chart generated in an X-ray crystal structure analysis.

FIG. 4 is a plurality of example patterns obtained by profile fitting of the chart of FIG. 3.

### DETAILED DESCRIPTION

Hereinafter, embodiments of the present invention are described.

### First Embodiment

A magnetic core according to the present embodiment includes soft magnetic particles. The soft magnetic particles include at least large particles described later.

Any method of observing the soft magnetic particles included in the magnetic core may be used. For example, a method of observing a section of the magnetic core using a SEM, a TEM, or the like may be used. Also, a section given by cutting the magnetic core may be polished.

A field of view of a section of the magnetic core may have any size. The field of view is determined so that the field of view includes a total of 10,000 or more soft magnetic particles. One field of view or a plurality of continuous fields of view is preferably determined. However, a plurality of fields of view at separate locations may be determined.

The magnification and the resolution at the time of observing a section of the magnetic core are not limited. The magnification may be 500× to 3,000×. The resolution may be 2560×1920 or more.

Particle sizes of all the soft magnetic particles included in each field of view are measured. The particle sizes of the soft magnetic particles denote their Heywood diameters. Heywood diameters mean projected area diameters. The Heywood diameter of each soft magnetic particle of the present embodiment is represented by (4S/π)^{1/2}, where S denotes the area of the soft magnetic particle in a section.

The volume of each soft magnetic particle is calculated on the supposition that the soft magnetic particle has a spherical shape. That is, the volume of each soft magnetic particle is calculated on the supposition that the volume is represented by (πd³)/6, where d denotes the particle size of the soft magnetic particle. Using the above method, the volumes of all the soft magnetic particles are calculated.

Using the above methods, the particle sizes and the volumes of all the soft magnetic particles included in each field of view are calculated.

Then, from the particle sizes and the volumes of the soft magnetic particles calculated using the above methods, a volume-based particle size distribution of the soft magnetic particles is calculated.

For the calculation of the particle size distribution, intervals need to be determined. In the present embodiment, one hundred intervals that follow a formula shown below are determined. In the formula, xᵢ is equivalent to i, and yᵢ denotes an average particle size (unit: μm) in an interval i, where i=1, 2, 3, . . . , 100 is satisfied. Also, exp(X)=e^{X} is satisfied, where e denotes the base of the natural logarithm (Euler's number).

$${y}_{i} = 0.02 \times exp ( {x}_{i} \times 0.085 )$$

For example, the average particle size in a first interval counted from smaller to larger is, with i=1 substituted into the above formula, 0.02×e^{0.085}=0.022 μm. Similarly, the average particle size in a second interval is 0.02×e^{0.17}=0.024 μm; the average particle size in a fiftieth interval is 0.02×e^{4.25}=1.402 μm; and the average particle size in a hundredth interval is 0.02×e^{8.5}=98.295 μm.

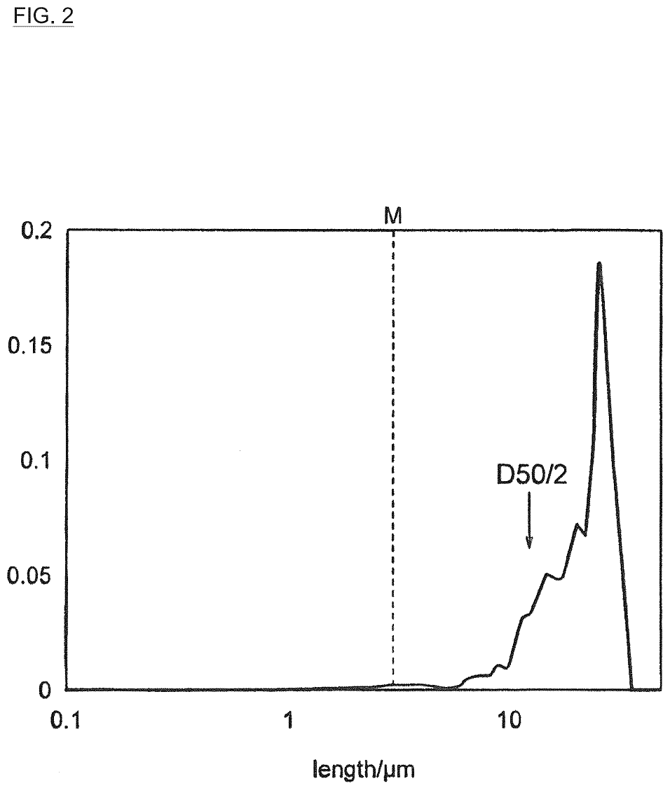

Using the intervals determined with the above method, the volume-based particle size distribution of the soft magnetic particles is calculated. FIG. 2 shows an example result. A curved line shown in FIG. 2 shows the volume-based particle size distribution of the soft magnetic particles. In the graph (FIG. 2), its horizontal axis represents particle sizes.

In FIG. 2, indicated is the location of D50/2 of the volume-based particle size distribution of the soft magnetic particles. Note that D50 of the volume-based particle size distribution of the soft magnetic particles means the corresponding particle size at a volume-based cumulative relative frequency of 50% (0.50).

Soft magnetic particles having a particle size of (0.5×D50) or more are defined as large particles. The soft magnetic particles according to the present embodiment include the large particles. The soft magnetic particles according to the present embodiment may further include particles not classified as the large particles, i.e., particles having a particle size of less than (0.5×D50).

Having a distribution of distances between the large particles within a specific range, the magnetic core according to the present embodiment has more improved DC superimposition characteristics than a magnetic core having a distribution of distances between the large particles outside the specific range.

An average distance from one of the large particles to three of the large particles nearest to the one of the large particles is defined as AL. Specifically, the first to third nearest large particles from a surface of the one of the large particles are identified. Then, respective distances from the surface of the one of the large particles to surfaces of the first to third nearest large particles are measured and averaged to find AL.

AL of all the large particles in each field of view is measured. Then, the median of AL is defined as M.

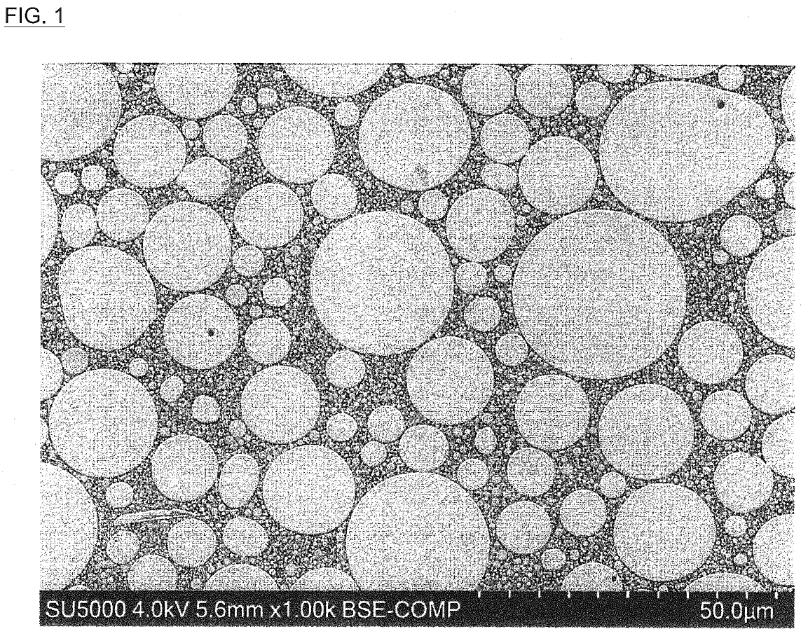

FIG. 2 shows the location of M. The soft magnetic particles included in the magnetic core according to the present embodiment satisfy 1.0 μm<M<(0.5×D50). Note that FIG. 1 is an example sectional SEM image of the magnetic core in which 1.0 μm<M<(0.5×D50) is satisfied.

In a situation where M is too small, the distances between the large particles are too short. Consequently, the large particles tend to be unevenly magnetized, and DC superimposition characteristics are readily reduced.

In a situation where M is too large, the distances between the large particles are too long. Magnetic resistance between the large particles is readily increased, and permeability is readily reduced.

M being within the above range enables the distances between the large particles to be within a suitable range. Consequently, DC superimposition characteristics are readily improved while permeability is maintained.

When the soft magnetic particles included in the magnetic core satisfy 1.0 μm<M<(0.5×D50), the magnetic core has more improved DC superimposition characteristics than a magnetic core under substantially the same conditions as the former magnetic core except that M is too small or too large.

D50 is not limited. D50 may be, for example, 4.0 μm or more and 60.0 μm or less, or 8.0 μm or more and 45.0 μm or less.

M is not limited. M may be, for example, 1.10 μm or more and 15.00 μm or less.

A total area ratio of the area of the soft magnetic particles in a section of the magnetic core to the area of the entire section is not limited. The total area ratio may be, for example, 70% or more and 95% or less. In a situation where the total area ratio is too low, permeability is readily reduced due to too low a packing ratio of the soft magnetic particles in the magnetic core.

A total area ratio of the area of the large particles to the area of the entire section may be 70% or more.

The large particles in the entire section may have an average circularity of 0.50 or more and 0.99 or less.

The large particles according to the present embodiment and/or the particles other than the large particles may have a coating on their surfaces. The coating may be an insulation coating. The coating may be of any type that is formed by coating normally used in this technical field. Examples of such coatings include iron based oxides, phosphates, silicates (water glass), soda-lime glass, borosilicate glass, lead glass, aluminosilicate glass, borate glass, and sulfate glass. Examples of phosphates include magnesium phosphate, calcium phosphate, zinc phosphate, manganese phosphate, and cadmium phosphate. Examples of silicates include sodium silicate. The coating may have any thickness. The thickness may be, for example, 5 nm or more and 100 nm or less on average.

The magnetic core according to the present embodiment may include, other than the soft magnetic particles, a resin. The resin may be of any type. Examples of resins include a silicone resin and an epoxy resin. The magnetic core may have any resin content. The resin content may be, for example, 1.0 parts by mass or more and 5.0 parts by mass or less, or 1.5 parts by mass or more and 3.5 parts by mass or less, with respect to 100 parts by mass of the soft magnetic particles. In a situation where the resin content is too high, the packing ratio of the soft magnetic particles is readily reduced, and permeability is readily reduced. In a situation where an attempt is made to increase the packing ratio of the soft magnetic particles to improve permeability, DC superimposition characteristics are readily reduced.

Further, a portion other than the magnetic material (e.g., the soft magnetic particles) in a section of the magnetic core may be occupied by the resin or by the resin and voids.

The soft magnetic particles may have any microstructure. The soft magnetic particles may have, for example, an amorphous structure or a crystalline structure. The soft magnetic particles (in particular, the large particles) may have a nano-heterostructure. The nano-heterostructure refers to a structure in which initial fine crystals having an average crystal grain size of 0.3 nm or more and 10 nm or less are included in an amorphous solid. When the soft magnetic particles have an amorphous structure or a nano-heterostructure, the amorphous ratio X described later is 85% or more. When the soft magnetic particles have a crystalline structure, the amorphous ratio X described later is less than 85%. Provided that the packing ratio is substantially constant, relative permeability is more improved when the soft magnetic particles (in particular, the large particles) have a nano-heterostructure than when the soft magnetic particles (in particular, the large particles) have an amorphous structure. Further, the soft magnetic particles (in particular, the large particles) may have a structure (nanocrystalline structure) composed of crystals having an average crystal grain size of 1 nm or more and 30 nm or less and a maximum crystal grain size of 100 nm or less. Provided that the packing ratio is substantially constant, when the soft magnetic particles (in particular, the large particles) have a nanocrystalline structure, relative permeability of the magnetic core is further improved. Note that, in soft magnetic particles including crystals or particularly nanocrystals, it is normal for one particle to include multiple crystals. That is, the particle sizes of the soft magnetic particles and crystal grain sizes are different. Any method of calculating the crystal grain sizes may be used. Examples of such methods include a method of calculating the crystal grain sizes by analyzing FWHM of XRD measurement for evaluation of crystallite sizes and a method of calculating the crystal grain sizes by observing crystals using a TEM.

Further, nanocrystals included in the soft magnetic particles (in particular, the large particles) may include Fe based nanocrystals. Fe based nanocrystals refer to crystals having a nanoscale average crystal grain size (specifically, 0.1 nm or more and 100 nm or less) and having a body-centered cubic (bcc) Fe crystal structure. Any method of calculating the average crystal grain size of the Fe based nanocrystals may be used. Examples of such methods include a method of calculating the crystal grain sizes by analyzing FWHM of XRD measurement for evaluation of crystallite sizes and a method of calculating the crystal grain sizes by observation using a TEM. Any method of confirming that the crystal structure is bcc may be used. Examples of such methods include a confirmation method involving XRD and a confirmation method involving an analysis of electron diffraction patterns obtained with a TEM.

In the present embodiment, the Fe based nanocrystals may have an average crystal grain size of 1 to 30 nm. The soft magnetic particles having such an Fe based nanocrystalline structure readily have a high saturation flux density and a low coercive force. That is, soft magnetic properties are readily improved. That is, including the soft magnetic particles makes the magnetic core (magnetic molded body) readily have a low coercive force and a high relative permeability. Further, because the saturation flux density of the magnetic core including the soft magnetic particles is increased, DC superimposition characteristics of the magnetic core are increased. Consequently, the soft magnetic particles having the Fe based nanocrystalline structure enables the magnetic core to readily have improved properties.

Any method of confirming the microstructure of the soft magnetic particles may be used. For example, the microstructure can be confirmed using XRD.

In the present embodiment, the soft magnetic particles having an amorphous ratio X, shown by Formula 1 below, of 85% or more are deemed to have an amorphous structure or a nano-heterostructure, and the soft magnetic particles having an amorphous ratio X of less than 85% are deemed to have a crystalline structure.

$$X = 100 - ( Ic / ( Ic + Ia ) \times 100 ) \qquad Formula 1$$

Ic: Crystal scattering integrated intensity
Ia: Amorphous scattering integrated intensity

The amorphous ratio X is calculated as follows. An X-ray crystal structure analysis of the soft magnetic particles using XRD is carried out. In the analysis, phases are identified, and peaks (Ic: crystal scattering integrated intensity, Ia: amorphous scattering integrated intensity) of crystallized Fe or a crystallized compound are read. From the intensities of these peaks, the crystallization ratio is determined, and the amorphous ratio X is calculated using Formula 1 shown above. A method of calculation is more specifically described below.

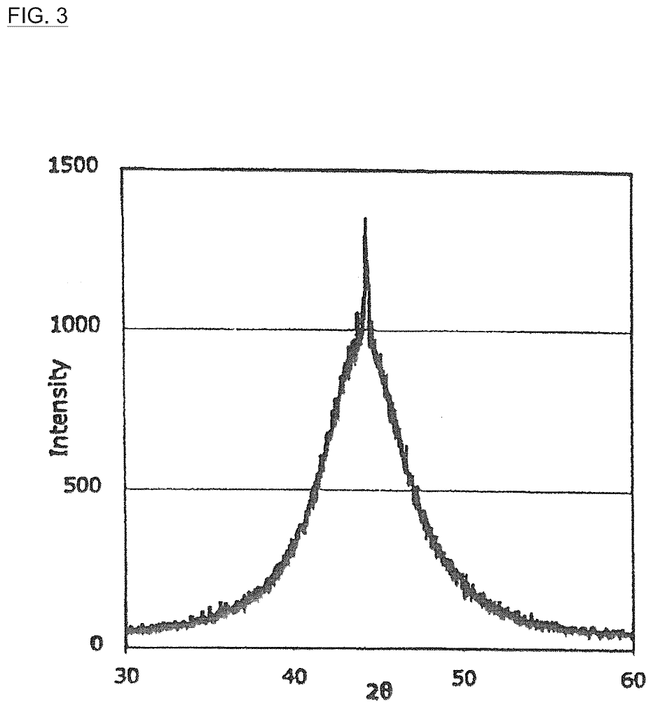

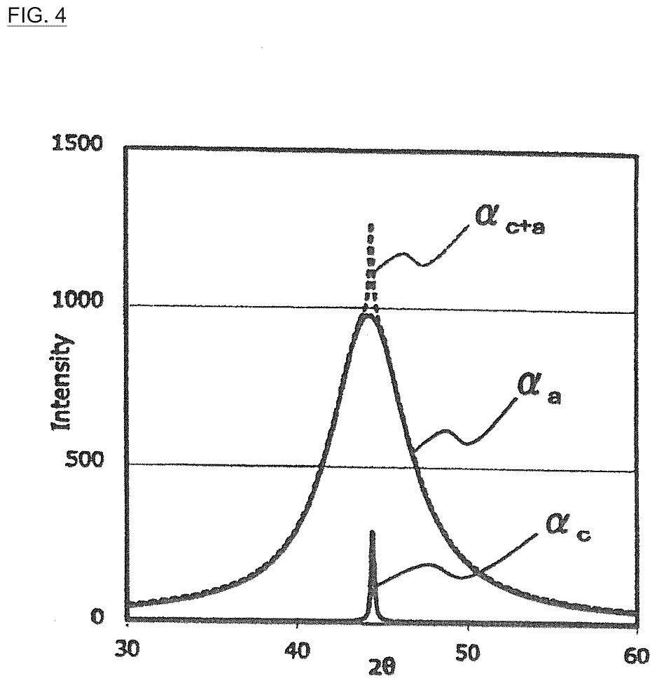

The X-ray crystal structure analysis of the soft magnetic particles according the present embodiment is carried out using XRD to generate a chart like the one shown as FIG. 3. Then, profile fitting is performed to this chart using a Lorentzian function shown as Formula 2 below to generate a crystal component pattern α_{c} showing the crystal scattering integrated intensity, an amorphous component pattern αₐ showing the amorphous scattering integrated intensity, and a pattern α_{c+a} showing a combination of these patterns, as shown in FIG. 4. From the patterns of the crystal scattering integrated intensity and the amorphous scattering integrated intensity, the amorphous ratio X is calculated using Formula 1 shown above. Note that the range of measurement is within a diffraction angle of 2θ=30° to 60°, in which a halo derived from amorphousness can be confirmed. In this range, the difference between the experimental integrated intensities measured using XRD and the integrated intensities calculated using the Lorentzian function is 1% or less.

$$\begin{matrix}[ Mathematical 1 ] & \\ f ( x ) = \frac{h}{1 + \frac{{( x - u )}^{2}}{{w}^{2}}} + b & Formula 2\end{matrix}$$

h: Peak height
u: Peak location
w: Full width at half maximum
b: Background height

The soft magnetic particles may have any composition. The composition, described later, of the soft magnetic particles may be an average composition of all the soft magnetic particles included in the magnetic core.

The composition of at least some of the soft magnetic particles may be represented by a composition formula (Fe₁₋ₚX1ₚ)_{100-(a+b+c+d++f)}BₐP_{b}Si_{c}C_{d}X2ₑX3_{f} (atomic ratio), where
X1 may include at least one selected from the group consisting of Co and Ni;
X2 may include at least one selected from the group consisting of Ti, Cr, Mn, Al, Ga, Ag, Zn, S, Ca, Mg, V, Sn, As, Sb, Bi, N, Au, Cu, a rare earth element, and a platinum-group element;
X3 may include at least one selected from the group consisting of Zr, Nb, Mo, Hf, Ta, and W; and
0≤p≤0.5,
2.00≤a≤20.00,
0.00≤b≤14.00,
0.00≤c≤15.00,
0.00≤d≤5.00,
0.00≤e≤3.00,
0.00≤f≤9.00, and
70.00≤100−(a+b+c+d+e+f)≤96.00 may be satisfied.

A magnetic core including the soft magnetic particles having the composition within the above range readily becomes a magnetic core having excellent DC superimposition characteristics.

The composition of at least some of the soft magnetic particles may be an average composition of the large particles.

Any method of analyzing the composition of the soft magnetic particles may be used. For example, the composition can be confirmed using an ICP analysis. Also, for example, SEM-EDS or an EPMA may be used for the analysis in a section of a molded body including the soft magnetic particles.

Components of the soft magnetic particles are described below in detail.

X1 includes at least one selected from the group consisting of Co and Ni. The magnetic core may include soft magnetic particles satisfying 0≤p≤0.5. A magnetic core including the soft magnetic particles having an Fe content that is not lower than the total content of Co and Ni readily becomes a magnetic core having excellent DC superimposition characteristics.

The magnetic core may include soft magnetic particles having a B content (a) satisfying 2.00≤a≤20.00. A magnetic core including the soft magnetic particles having a B content within the above range readily becomes a magnetic core having excellent DC superimposition characteristics.

The magnetic core may include soft magnetic particles having a P content (b) satisfying 0.00≤b≤14.00. A magnetic core including the soft magnetic particles having a P content within the above range readily becomes a magnetic core having excellent DC superimposition characteristics.

The magnetic core may include soft magnetic particles having a Si content (c) satisfying 0.00≤c≤15.00. A magnetic core including the soft magnetic particles having a Si content within the above range readily becomes a magnetic core having excellent DC superimposition characteristics.

The magnetic core may include soft magnetic particles having a C content (d) satisfying 0.00≤d≤5.00. A magnetic core including the soft magnetic particles having a C content within the above range readily becomes a magnetic core having excellent DC superimposition characteristics.

The magnetic core may include soft magnetic particles having an X2 content (e) satisfying 0.00≤e≤3.00. A magnetic core including the soft magnetic particles having an X2 content within the above range readily becomes a magnetic core having excellent DC superimposition characteristics.

The magnetic core may include soft magnetic particles having an X3 content (f) satisfying 0.00≤f≤9.00. A magnetic core including the soft magnetic particles having an X3 content within the above range readily becomes a magnetic core having excellent DC superimposition characteristics.

The magnetic core may include soft magnetic particles satisfying 70.00≤100−(a+b+c+d+e+f)≤96.00. Such soft magnetic particles have a total content of Fe and X1 of 70.00 at % or more and 96.00 at % or less. A magnetic core including the soft magnetic particles having a total content of Fe and X1 within the above range readily becomes a magnetic core having excellent DC superimposition characteristics.

The above soft magnetic particles may further contain oxygen. 100 mass % soft magnetic particles may have an oxygen content of 0 ppm or more and 10,000 ppm or less based on mass. A magnetic core including the soft magnetic particles having an oxygen content within the above range readily becomes a magnetic core having excellent DC superimposition characteristics.

The above soft magnetic particles may contain, as inevitable impurities, elements other than Fe, X1, B, P, Si, C, X2, and X3 to the extent that the elements do not significantly affect the properties. The oxygen content is as described above. Among the inevitable impurities, elements other than oxygen may constitute 0.1 mass % or less out of 100 mass % soft magnetic particles.

At least some of the soft magnetic particles may contain only Fe or contain Fe and Co and/or Ni as a main component.

The phrase “contain only Fe or contain Fe and Co and/or Ni as a main component” means that the Fe content of the soft magnetic particles is 15 at % or more and 100 at % or less and the total content of Fe, Co, and Ni thereof is 50 at % or more and 100 at % or less.

Note that elements other than the main component in a situation where the soft magnetic particles contain only Fe or contain Fe and Co and/or Ni as the main component are not limited. Examples of such elements include Cr, Al, Si, B, P, C, O, Nb, Zr, Ta, Mn, V, Cu, and S.

When the soft magnetic particles (in particular, the large particles) have a nanocrystalline structure, example compositions of the soft magnetic particles include an Fe—Si—B—Nb—Cu based, an Fe—B—P—Si—Cu based, and an Fe—B—P—Si—Nb—Cr based compositions, which readily have a nanocrystalline structure.

If a soft magnetic powder including the soft magnetic particles having the above composition is subject to a heat treatment in a method of manufacturing the magnetic core described later, the Fe based nanocrystals are readily deposited in the soft magnetic particles. In other words, a soft magnetic powder having the above composition is readily used as a starting raw material of the soft magnetic powder including the soft magnetic particles having deposition of the Fe based nanocrystals.

In a situation where the Fe based nanocrystals are deposited in the soft magnetic particles by the heat treatment, the soft magnetic particles prior to the heat treatment may have an amorphous structure or may have a nano-heterostructure, in which initial fine crystals are present in an amorphous solid. Note that the initial fine crystals may have an average crystal grain size of 0.3 nm or more and 10 nm or less. When the soft magnetic particles have an amorphous structure or a nano-heterostructure, the amorphous ratio X described later is 85% or more.

When the soft magnetic particles (in particular, the large particles) have an amorphous structure, example compositions of the soft magnetic particles include an Fe—Co—B—P—Si—Cr based, an Fe—Co—B—P—Si based, an Fe—B—Si—C—Cr based, and an Fe—B—Si—C based compositions, which readily have an amorphous structure.

When the soft magnetic particles (in particular, the large particles) have a crystalline structure, example compositions of the soft magnetic particles include an Fe based, an Fe—Co based, an Fe—Co—Si based, an Fe—Si—Cr based, an Fe—Co—Si—Cr based, and an Fe—Si—Al based compositions, which readily have a crystalline structure.

The soft magnetic particles (in particular, the particles other than the large particles) may have any composition. The soft magnetic particles may have any composition. At least some of the soft magnetic particles may contain only Fe or contain Fe and Co, Ni, and/or Si as a main component.

The phrase “contain only Fe or contain Fe and Co, Ni, and/or Si as a main component” means that the Fe content of the soft magnetic particles is 15 at % or more and 100 at % or less and the total content of Fe, Co, Ni, and Si thereof is 50 at % or more and 100 at % or less.

Note that elements other than the main component in a situation where the soft magnetic particles contain only Fe or contain Fe and Co, Ni, and/or Si as the main component are not limited. Examples of such elements include Cr, Al, B, P, C, O, Nb, Zr, Ta, Mn, V, Cu, and S.

With the soft magnetic particles (in particular, the particles other than the large particles) having the above composition, the magnetic core having high magnetic properties is readily manufactured.

A method of manufacturing the magnetic core according to the present embodiment is described below; however, methods of manufacturing the magnetic core are not limited to the following method.

First, a soft magnetic powder including the above soft magnetic particles according to the present embodiment is prepared. The soft magnetic powder according to the present embodiment may be prepared by mixing a soft magnetic powder that eventually becomes mostly the large particles and a soft magnetic powder that eventually becomes mostly the particles other than the large particles.

The soft magnetic powder that eventually becomes mostly the large particles can be prepared using, for example, a water atomization method or a gas atomization method. The following description is provided on the premise that the gas atomization method is used; however, the water atomization method is similar to the gas atomization method except that a high-pressure gas injected to a molten metal is replaced by water.

In the gas atomization method, a molten metal in which raw material metals are melted is powderized using the gas atomization method to give the soft magnetic powder. The composition of the molten metal is the same as the composition of the soft magnetic particles eventually obtained. At this time, the molten metal drips from a container having a discharge port to a cooling portion. The temperature of the molten metal is the spray temperature. The spray temperature is not limited. The spray temperature is, for example, 1200° C. or more and 1600° C. or less. The higher the spray temperature, the closer the average circularity tends to be to 1, and the smaller the average particle size tends to be.

Gas injection nozzles having a gas injection port are disposed so as to surround the discharge port. From the gas injection port, a high-pressure gas (gas injected at an injection pressure (gas pressure) of 2.0 MPa or more and 10 MPa or less) is injected to the molten metal dripping from the discharge port. Consequently, the molten metal becomes droplets. Controlling the pressure of the high-pressure gas at this time can change the particle size and the shape of the soft magnetic powder eventually obtained. Specifically, provided that the spray amount of the molten metal is constant, the higher the pressure of the high-pressure gas, the smaller the particle size of the soft magnetic powder eventually obtained. That is, the ratio of the pressure of the high-pressure gas to the spray amount of the molten metal can change the particle size and the shape of the soft magnetic powder.

As the gas injected from the gas injection port, an inert gas (e.g., a nitrogen gas, an argon gas, or a helium gas) or a reducing gas (e.g., an ammonia decomposition gas) is preferred. If the molten metal is less readily oxidized, the gas may be air.

The cooling portion, to which the molten metal drips, may have any shape. The cooling portion may have, for example, a tubular shape having a coolant flow that collides with the molten metal inside. In this situation, controlling the spray amount of the molten metal, the pressure of the high-pressure gas described above, and the water pressure of the coolant flow can change the particle size or the average circularity of the large particles in the magnetic core eventually obtained. That is, the particle size or the average circularity of the soft magnetic particles is controlled by the balance between the spray amount of the molten metal, the pressure of the high-pressure gas, and the water pressure of the coolant flow. The spray amount of the molten metal may be 0.5 kg/min or more and 4.0 kg/min or less. The water pressure may be 5.0 MPa or more and 20.0 MPa or less. Specifically, the larger the spray amount, the larger the particle size tends to be. Also, the lower the water pressure, the closer the average circularity of the large particles tends to be to 1.

The molten metal discharged to the coolant flow collides with the coolant flow. The molten metal further diverges to become finer and is deformed for rapid quenching and solidification, which gives the soft magnetic powder in a solid form. The soft magnetic powder discharged together with the coolant is separated from the coolant in, for example, an external tank, for extraction. Note that the coolant may be of any type. For example, cooling water may be used.

The resultant soft magnetic powder may be subject to a heat treatment. Conditions of the heat treatment are not limited. The heat treatment may be carried out, for example, at 400° C. to 700° C. for 0.1 to 10 hours. When the microstructure of the soft magnetic particles is an amorphous structure or a nano-heterostructure, in which initial fine crystals are present in an amorphous solid, carrying out the heat treatment makes the microstructure of the soft magnetic particles readily become a nanocrystalline structure.

Any method of preparing the soft magnetic powder that eventually becomes mostly the particles other than the large particles may be used. For example, various powderizing methods (e.g., a liquid phase method, a spray pyrolysis method, or a melting method) may be used.

The average particle size of the soft magnetic powder that eventually becomes mostly the particles other than the large particles can be controlled by appropriately removing a coarse powder and/or a fine powder using an air flow classification apparatus.

The above soft magnetic powders may be provided with the coating at this time. Any method of forming the coating may be used.

Then, from the above soft magnetic powders, a magnetic core is manufactured. First, the soft magnetic powders are weighed. Hereinafter, the soft magnetic powder that eventually becomes mostly the large particles is referred to as a powder A, and the soft magnetic powder that eventually becomes mostly the particles other than the large particles is referred to as a powder B. The mixing ratio of the soft magnetic powders is not limited. It may be that, for example, the powder A constitutes 30 mass % or more and 90 mass % or less. The powder B may constitute 10 mass % or more and 70 mass % or less.

Other than the powder A and the powder B, a powder C having an average particle size in between that of the powder A and that of the powder B may further be used. Similarly to the powder B, eventually most of the powder C readily becomes particles that do not apply to the definition of the large particles. The powder C may have any composition and any microstructure. The composition and the microstructure of the powder C may be the same as those of the powder A, may be the same as those of the powder B, or may be different from those of the powder A or the powder B. When the powder C, which has an average particle size in between that of the powder A and that of the powder B, is further used other than the powders A and B, the total of the powders B and C may constitute 10 mass % or more and 70 mass % or less.

Then, the weighed powder B is agglomerated. Specifically, the powder B is mixed with a resin; and then a mold is filled with this mixture, in which the powder B and the resin are mixed, and the mixture is compressed. The amount of the resin may be 0.1 parts by mass or more and 0.3 parts by mass or less with respect to 100 parts by mass of the powder B. The smaller the amount of the resin, the less easy agglomeration of the powder B tends to be. Also, the higher the pressure of compression, the more readily agglomeration of the powder B proceeds to increase M of the magnetic core eventually obtained. The pressure of compression may be, for example, 10 MPa or more and 1,000 MPa or less, or 40 MPa or more and 600 MPa or less.

Then, the powder A, the agglomerated powder B, and a resin are kneaded to give a resin compound. When the powder C is used, the powder C is also kneaded. The amount of the resin may be 1.0 parts by mass or more and 5.0 parts by mass or less or may be 1.5 parts by mass or more and 3.5 parts by mass or less with respect to 100 parts by mass of the soft magnetic powders in the resin compound. The smaller the amount of the resin, the less easy it is to carry out compression molding of the soft magnetic powders; moreover, the magnetic core resulting from compression molding of the soft magnetic powders readily has a lower strength, becoming difficult to be handled.

Kneading makes the agglomerated powder B disintegrate to some degree. The higher the pressure of compression, the less readily the powder B disintegrates; and the lower the pressure of compression, the more readily the powder B disintegrates.

A mold is filled with the resultant resin compound, and then compression molding is carried out to give the magnetic core. Compression molding may be carried out at any molding pressure. The molding pressure may be, for example, 98 MPa or more and 981 MPa or less. Further, the resin included in the resultant magnetic core may be cured by heating.

Normally, the composition and the microstructure of the soft magnetic particles included in the soft magnetic powders prior to compression molding and the composition and the microstructure of the soft magnetic particles included in the magnetic core after compression molding are the same.

Hereinabove, the magnetic core (magnetic molded body) according to the present embodiment has been described; however, magnetic cores (magnetic molded bodies) of the present invention are not limited to the magnetic core of the above embodiment.

Also, the magnetic cores of the present invention may be used for any purpose. The magnetic cores may be included in coil devices (magnetic devices), such as inductors, choke coils, or transformers. Further, the magnetic cores of the present invention may be included in electronic apparatuses, such as DC-DC converters.

### Second Embodiment

Hereinafter, a second embodiment is described. The second embodiment is similar to the first embodiment unless otherwise specified.

Soft magnetic particles included in a magnetic core according to the present embodiment satisfy 0.35 μm<M<(0.5×D50), and D50 of these particles is 0.80 μm or more and less than 4.0 μm.

When the soft magnetic particles included in the magnetic core have a D50 of 0.80 μm or more and less than 4.0 μm and satisfy 0.35 μm<M<(0.5×D50), the magnetic core has more improved DC superimposition characteristics and more improved core loss than a magnetic core under substantially the same conditions as the former magnetic core except that M is too small or too large. In a situation where D50 is too small, M being larger than 0.35 μm does not readily improve core loss of the magnetic core.

### EXAMPLES

Hereinafter, the present invention is described based on further detailed examples; however, the present invention is not limited to these examples.

### (Experiment 1)

In Experiment 1, a powder A, which eventually became mostly large particles, was prepared using a gas atomization method. The powder A had an Fe—Co—B—P—Si—Cr based composition. Specifically, the composition was 57.4Fe-24.6Co-11.0B-3.0P-3.0Si-1.0Cr in atomic ratio.

Conditions of the gas atomization method were as follows. The pressure of a high-pressure gas was 2.0 MPa or more and 10 MPa or less. The spray amount of a molten metal was 0.5 kg/min or more and 4.0 kg/min or less. The atomization conditions and classification conditions were appropriately controlled so that the resultant powder A had a volume-based median diameter (D50) of 20 μm. Note that, as classification of the powder A, sieve classification with a sieve having an opening of 63 μm was at least carried out.

Using an ICP analysis, it was confirmed that the composition of a master alloy and the composition of the powder A of each sample approximately corresponded. It was confirmed that the volume-based median diameter (D50) of the resultant powder A was 20 μm. The volume-based median diameter of the powder A was measured using a laser diffraction method with a dry type particle size distribution measurement instrument.

As a powder B, which eventually became mostly particles other than the large particles, a carbonyl iron powder was used. That is, soft magnetic particles included in the powder B had a composition substantially containing only Fe. A coarse powder and/or a fine powder were appropriately removed using an air flow classification apparatus so that the powder B had a volume-based median diameter (D50) of 0.8 μm. Using an ICP analysis, it was confirmed that the powder B had the intended composition. Using the laser diffraction method with a dry type particle size distribution measurement instrument, it was confirmed that the volume-based median diameter (D50) of the resultant powder B was 0.8 μm.

X-ray diffraction (XRD) measurement was carried out for each powder to measure its amorphous ratio X. When the amorphous ratio X was 85% or more, the powder was deemed to have an amorphous structure. When the amorphous ratio X was less than 85% and the average crystal grain size was 100 nm or less, the powder was deemed to have a nanocrystalline structure. When the amorphous ratio X was less than 85% and the average crystal grain size exceeded 100 nm, the powder was deemed to have a crystalline structure. In Experiment 1, it was confirmed that the powder A had an amorphous structure and that the powder B had a crystalline structure in all samples.

Next, the powder B was agglomerated. First, the powder B and an epoxy resin were mixed. The amount of the epoxy resin added to the powder B was 0.2 parts by mass with respect to 100 parts by mass of the powder B. Then, a mold having a cylindrical shape with a diameter of ø 8 mm was filled with 1 g mixture of the powder B and the epoxy resin. Compression was carried out at a pressure shown in Table 1 for agglomeration. When the agglomerated powder B was prepared for more than 1 g, the above step was repeated multiple times. Note that, in Sample No. 1, the powder B was not compressed and was not agglomerated.

Next, the powder A, the agglomerated powder B, and an epoxy resin were kneaded to give a resin compound. Note that, in Sample No. 1, the powder A, the powder B, and the epoxy resin were kneaded to give a resin compound. The mixing ratio of the powder A to the powder B was 80:20 based on mass. The amount of the epoxy resin was 2.0 parts by mass to 3.0 parts by mass with respect to a total of 100 parts by mass of the powders A and B. The amount of the epoxy resin was controlled so that a magnetic core eventually obtained had a relative permeability μ of 30.

Next, a toroidal mold was filled with the resin compound, and pressure molding was carried out to give a toroidal molded body. The molding pressure was appropriately controlled within a range of 98 MPa or more and 981 MPa or less so that the magnetic core eventually obtained had a relative permeability μ of 30.

After that, the epoxy resin included in the resultant molded body was cured by heating to give the magnetic core. This heat treatment was carried out at 180° C. for 60 minutes. The magnetic core had an outside diameter of 11 mm, an inside diameter of 6.5 mm, and a thickness of 2.5 mm.

A section of the magnetic core of each sample cut in parallel to the molding direction (height direction) was observed using a SEM (SU-5000 manufactured by Hitachi High-Tech Corporation) to calculate D50 using the method described above. Table 1 shows the results.

Further, M was calculated using the method described above and was compared to 1.0 μm and D50/2. Table 1 shows the results.

Relative permeability μ of the toroidal core of each sample was measured using the following method. First, a polyurethane copper wire (UEW wire) was wound around the toroidal core. Inductance of the toroidal core was measured with an LCR meter (4284A manufactured by Agilent Technologies) at a frequency of 1 MHz without application of a direct current. From the inductance, relative permeability μ was calculated. Table 1 shows the results.

Further, Isat of the toroidal core of each sample was measured for evaluation of its DC superimposition characteristics. As the direct current applied to the toroidal core of each sample was increased, its relative permeability was reduced. The value of a direct current at which relative permeability was reduced from μ by 10% during measurement of relative permeability of the toroidal core with application of a direct current was defined as Isat. Table 1 shows the results.

Further, Table 1 shows a rate of improvement of Isat with respect to benchmark Isat of a sample carried out under the same conditions except that the powder B was not agglomerated. When the rate of improvement of Isat was 5.0% or more, DC superimposition characteristics were deemed good. When the rate of improvement of Isat was 7.5% or more, DC superimposition characteristics were deemed better. When the rate of improvement of Isat was 15.0% or more, DC superimposition characteristics were deemed best. Table 1 shows the results.

Further, core loss of the toroidal core of each sample was evaluated. Specifically, around the toroidal core, a primary wire was wound for 24 turns, and a secondary wire was wound for 12 turns. Then, iron loss at 3 MHz, 10 mT, 20° C. to 25° C. was measured with a B—H analyzer (SY-8232 manufactured by IWATSU ELECTRIC CO., LTD.).

Further, a rate of improvement of core loss with respect to benchmark core loss of a sample carried out under the same conditions except that the powder B was not agglomerated was calculated. Table 1 shows the results. When D50 was 4.0 μm or more, a rate of improvement of core loss of 0.1% or more was deemed good.

TABLE 1

| | | | Particle | | | | Core properties | | | | |
|---|---|---|---|---|---|---|---|---|---|---|---|
| | | | size | M comparison | | | | | Rate of | | Rate of |
| | Example/ | Powder B | distribution | | | 0.5 × | | | improvement | Core | improvement |
| Sample | Comparative | pressure | D50 | 1 | M | D50 | μ | Isat | of Isat | loss | of core loss |
| No. | Example | (MPa) | (μm) | (μm) | (μm) | (μm) | (—) | (A) | (%) | kW/m³ | (%) |
| 1 | Comparative | 0 | 20.2 | 1.00 | 0.95 | 10.1 | 30 | 13.9 | — | 2548 | — |
| | Example | | | | | | | | | | |
| 3 | Example | 10 | 20.0 | 1.00 | 1.14 | 10.0 | 30 | 15.0 | 8.0 | 2545 | 0.1 |
| 4 | Example | 29 | 20.2 | 1.00 | 2.01 | 10.1 | 30 | 15.7 | 13.0 | 2545 | 0.1 |
| 5 | Example | 49 | 20.4 | 1.00 | 3.12 | 10.2 | 30 | 16.1 | 15.9 | 2542 | 0.2 |
| 6 | Example | 98 | 20.1 | 1.00 | 3.81 | 10.1 | 30 | 16.3 | 17.4 | 2543 | 0.2 |
| 7 | Example | 294 | 20.2 | 1.00 | 5.10 | 10.1 | 30 | 16.4 | 18.1 | 2544 | 0.1 |
| 8 | Example | 490 | 20.2 | 1.00 | 6.34 | 10.1 | 30 | 16.3 | 17.4 | 2545 | 0.1 |
| 9 | Example | 686 | 20.1 | 1.00 | 7.88 | 10.0 | 30 | 15.8 | 13.8 | 2545 | 0.1 |
| 10 | Example | 981 | 20.2 | 1.00 | 9.72 | 10.1 | 30 | 15.1 | 8.7 | 2545 | 0.1 |
| 11 | Comparative | 1079 | 20.1 | 1.00 | 10.36 | 10.0 | 30 | 14.2 | 2.2 | 2548 | 0 |
| | Example | | | | | | | | | | |

According to Table 1, in each Example (Sample Nos. 3 to 10), in which the powder B agglomerated to satisfy 1.0 μm<M<(0.5×D50), DC superimposition characteristics were improved, and core loss was improved, compared to a Comparative Example (Sample No. 1) in which M was too small due to the powder B not being agglomerated. However, in a Comparative Example (Sample No. 11) in which M was too large due to excessive agglomeration of the powder B, DC superimposition characteristics were not sufficiently improved compared to Sample No. 1.

### (Experiment 2)

Experiment 2 was conducted substantially as in Sample Nos. 1 and 6 except that the mixing ratio of the powder A to the powder B was changed. Table 2 shows the results. Note that, in Tables 2 to 16, Isat and core loss are omitted.

TABLE 2

| | | | | | Particle | | | | Core properties | | |
|---|---|---|---|---|---|---|---|---|---|---|---|
| | | | | Powder | size | M comparison | | | | Rate of | Rate of |
| | Example/ | Mixing ratio | | B | distribution | | | 0.5 × | | improvement | improvement |
| Sample | Comparative | Powder A | Powder B | pressure | D50 | 1 | M | D50 | μ | of Isat | of core loss |
| No. | Example | (wt %) | (wt %) | (MPa) | (μm) | (μm) | (μm) | (μm) | (—) | (%) | (%) |
| 12 | Comparative | 30 | 70 | 0 | 19.8 | 1.00 | 0.98 | 9.9 | 30 | — | — |
| | Example | | | | | | | | | | |
| 13 | Example | 30 | 70 | 98 | 19.7 | 1.00 | 9.52 | 9.9 | 30 | 10.8 | 0.2 |
| 14 | Comparative | 50 | 50 | 0 | 19.8 | 1.00 | 0.97 | 9.9 | 30 | — | — |
| | Example | | | | | | | | | | |
| 15 | Example | 50 | 50 | 98 | 19.9 | 1.00 | 6.47 | 9.9 | 30 | 17.6 | 0.2 |
| 1 | Comparative | 80 | 20 | 0 | 20.2 | 1.00 | 0.95 | 10.1 | 30 | — | — |
| | Example | | | | | | | | | | |
| 6 | Example | 80 | 20 | 98 | 20.1 | 1.00 | 3.81 | 10.1 | 30 | 17.4 | 0.2 |
| 16 | Comparative | 90 | 10 | 0 | 20.2 | 1.00 | 0.93 | 10.1 | 30 | — | — |
| | Example | | | | | | | | | | |
| 17 | Example | 90 | 10 | 98 | 20.1 | 1.00 | 3.20 | 10.1 | 30 | 16.2 | 0.2 |

According to Table 2, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the mixing ratio of the powder A to the powder B being changed.

### (Experiment 3)

Experiment 3 was conducted substantially as in Sample Nos. 1 and 6 except that the volume-based median diameter (D50) of the powder A was changed. Table 3 shows the results.

TABLE 3

| | | Median | | | Particle | | | | Core properties | | |
|---|---|---|---|---|---|---|---|---|---|---|---|
| | | diameter | | Powder | size | M comparison | | | | Rate of | Rate of |
| | Example/ | Powder | Powder | B | distribution | | | 0.5 × | | improvement | improvement |
| Sample | Comparative | A | B | pressure | D50 | 1 | M | D50 | μ | of Isat | of core loss |
| No. | Example | (μm) | (μm) | (MPa) | (μm) | (μm) | (μm) | (μm) | (—) | (%) | (%) |
| 18a | Comparative Example | 4 | 0.8 | 0 | 4.0 | 1.00 | 0.42 | 2.0 | 30 | — | — |
| 19a | Example | 4 | 0.8 | 98 | 4.0 | 1.00 | 1.06 | 2.0 | 30 | 6.5 | 0.2 |
| 18b | Comparative Example | 8 | 0.8 | 0 | 8.0 | 1.00 | 0.95 | 4.0 | 30 | — | — |
| 19b | Example | 8 | 0.8 | 98 | 8.0 | 1.00 | 1.35 | 4.0 | 30 | 10.5 | 0.2 |
| 18 | Comparative Example | 10 | 0.8 | 0 | 10.1 | 1.00 | 0.96 | 5.0 | 30 | — | — |
| 19 | Example | 10 | 0.8 | 98 | 10.1 | 1.00 | 1.66 | 5.0 | 30 | 11.2 | 0.2 |
| 20 | Comparative Example | 15 | 0.8 | 0 | 14.9 | 1.00 | 0.98 | 7.5 | 30 | — | — |
| 21 | Example | 15 | 0.8 | 98 | 14.9 | 1.00 | 2.92 | 7.4 | 30 | 15.2 | 0.2 |
| 1 | Comparative Example | 20 | 0.8 | 0 | 20.2 | 1.00 | 0.99 | 10.1 | 30 | — | — |
| 6 | Example | 20 | 0.8 | 98 | 20.1 | 1.00 | 3.81 | 10.1 | 30 | 17.4 | 0.2 |
| 22 | Comparative Example | 25 | 0.8 | 0 | 26.1 | 1.00 | 0.99 | 13.0 | 30 | — | — |
| 23 | Example | 25 | 0.8 | 98 | 26.3 | 1.00 | 4.78 | 13.1 | 30 | 18.0 | 0.2 |
| 24 | Comparative Example | 30 | 0.8 | 0 | 29.8 | 1.00 | 0.99 | 14.9 | 30 | — | — |
| 25 | Example | 30 | 0.8 | 98 | 30.2 | 1.00 | 5.82 | 15.1 | 30 | 17.6 | 0.2 |
| 26 | Comparative Example | 35 | 0.8 | 0 | 34.8 | 1.00 | 1.00 | 17.4 | 30 | — | — |
| 27 | Example | 35 | 0.8 | 98 | 34.7 | 1.00 | 6.78 | 17.4 | 30 | 16.7 | 0.2 |
| 26a | Comparative Example | 40 | 0.8 | 0 | 40.2 | 1.00 | 1.00 | 20.1 | 30 | — | — |
| 27a | Example | 40 | 0.8 | 98 | 40.1 | 1.00 | 8.33 | 20.1 | 30 | 13.7 | 0.2 |
| 26b | Comparative Example | 50 | 0.8 | 0 | 59.7 | 1.00 | 1.00 | 29.9 | 30 | — | — |
| 27b | Example | 50 | 0.8 | 98 | 60.0 | 1.00 | 15.04 | 30.0 | 30 | 5.2 | 0.2 |

According to Table 3, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the volume-based median diameter (D50) of the powder A being changed.

In particular, in each Example in which D50 was 8.0 μm or more and 45.0 μm or less, DC superimposition characteristics were better.

### (Experiment 4)

Experiment 4 was conducted substantially as in Sample Nos. 1 and 6 except that the volume-based median diameter (D50) of the powder B was changed. Table 4 shows the results.

TABLE 4

| | | Median | | | Particle | | | | Core properties | | |
|---|---|---|---|---|---|---|---|---|---|---|---|
| | | diameter | | Powder | size | M comparison | | | | Rate of | Rate of |
| | | Powder | Powder | B | distribution | | | 0.5 × | | improvement | improvement |
| Sample | Example/ | A | B | pressure | D50 | 1 | M | D50 | μ | of Isat | of core loss |
| No. | Comparative Example | (μm) | (μm) | (MPa) | (μm) | (μm) | (μm) | (μm) | (—) | (%) | (%) |
| 28 | Comparative Example | 20 | 0.5 | 0 | 20.3 | 1.00 | 0.91 | 10.1 | 30 | — | — |
| 29 | Example | 20 | 0.5 | 98 | 20.1 | 1.00 | 3.31 | 10.0 | 30 | 15.7 | 0.2 |
| 1 | Comparative Example | 20 | 0.8 | 0 | 20.2 | 1.00 | 0.95 | 10.1 | 30 | — | — |
| 6 | Example | 20 | 0.8 | 98 | 20.1 | 1.00 | 3.81 | 10.1 | 30 | 17.4 | 0.2 |
| 30 | Comparative Example | 20 | 1.0 | 0 | 20.5 | 1.00 | 0.96 | 10.2 | 30 | — | — |
| 31 | Example | 20 | 1.0 | 98 | 20.4 | 1.00 | 3.93 | 10.2 | 30 | 17.9 | 0.2 |
| 32 | Comparative Example | 20 | 1.5 | 0 | 20.6 | 1.00 | 0.96 | 10.3 | 30 | — | — |
| 33 | Example | 20 | 1.5 | 98 | 20.5 | 1.00 | 4.67 | 10.3 | 30 | 18.1 | 0.2 |
| 34 | Comparative Example | 20 | 2.0 | 0 | 20.7 | 1.00 | 0.98 | 10.3 | 30 | — | — |
| 35 | Example | 20 | 2.0 | 98 | 20.6 | 1.00 | 5.55 | 10.3 | 30 | 17.9 | 0.2 |

According to Table 4, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the volume-based median diameter (D50) of the powder B being changed.

### (Experiment 5)

Experiment 5 was conducted as in Sample Nos. 1 and 6 except that the powder A was provided with a coating by insulation coating. Specifically, a coating treatment was carried out for the powder A using a mechanofusion system (AMS-Lab manufactured by HOSOKAWA MICRON CORPORATION) to provide surfaces of the powder with a P—Zn—Al—O based oxide glass coating. The coating had a thickness of 15 nm. Table 5 shows the results.

TABLE 5

| | | | | Particle | M comparison | | | Core properties | | |
|---|---|---|---|---|---|---|---|---|---|---|
| | | | Powder A | size | | | | | Rate of | Rate of |
| | | Powder B | insulation | distribution | | | 0.5 × | | improvement | improvement |
| Sample | Example/ | pressure | coating | D50 | 1 | M | D50 | μ | of Isat | of core loss |
| No. | Comparative Example | (MPa) | (—) | (μm) | (μm) | (μm) | (μm) | (—) | (%) | (%) |
| 1 | Comparative Example | 0 | Not provided | 20.2 | 1.00 | 0.95 | 10.1 | 30 | — | — |
| 6 | Example | 98 | Not provided | 20.1 | 1.00 | 3.81 | 10.1 | 30 | 17.4 | 0.2 |
| 36 | Comparative Example | 0 | Provided | 20.2 | 1.00 | 0.95 | 10.1 | 30 | — | — |
| 37 | Example | 98 | Provided | 20.2 | 1.00 | 3.79 | 10.1 | 30 | 17.4 | 0.2 |

According to Table 5, in an Example (Sample No. 37) in which the powder B agglomerated to satisfy 1.0 μm<M<(0.5×D50), DC superimposition characteristics were sufficiently improved, and core loss was improved, compared to a Comparative Example (Sample No. 36) carried out under substantially the same conditions except that M was too small due to the powder B not being agglomerated, despite the coating being provided by insulation coating.

### (Experiment 6)

Experiment 6 was conducted as in Sample Nos. 1 and 6 except that the composition and the microstructure of the powder A were changed. Table 6 shows the results.

In Sample Nos. 38 and 39, the composition of the powder A was, in atomic ratio, 66.8Fe-16.7Co-11.0B-4.5P-1.0Si. In Sample Nos. 40 and 41, the composition of the powder A was, in atomic ratio, 72.7Fe-10.8B-11.6Si-2.7C-2.2Cr. In Sample Nos. 42 and 43, the composition of the powder A was, in atomic ratio, 81.6Fe-13.4B-3.4Si-1.6C. Using XRD, it was confirmed that all of the powders A of Sample Nos. 38 to 43 had an amorphous structure.

In Sample Nos. 44 and 45, the composition of the powder A was, in atomic ratio, 73.5Fe-13.5Si-9.0B-3.0Nb-1.0Cu. In Sample Nos. 46 and 47, the composition of the powder A was, in atomic ratio, 82.0Fe-11.0B-5.0P-1.0Si-1.0Cu. In Sample Nos. 48 and 49, the composition of the powder A was, in atomic ratio, 78.0Fe-9.0B-3.0P-3.0Si-6.0Nb-1.0Cr. Also, the powders A of Sample Nos. 44 to 49, prepared using the gas atomization method, were then subject to a heat treatment to deposit nanocrystals having a crystal grain size of 30 nm or less to reduce the amorphous ratio X to 10%. The heat treatment was carried out specifically at 400° C. to 650° C. for 10 to 60 minutes. Using XRD, it was confirmed that all of the powders A of Sample Nos. 44 to 49 had a nanocrystalline structure.

In Sample Nos. 50 and 51, the composition of the powder A was a composition substantially containing only Fe. In Sample Nos. 52 and 53, the composition of the powder A was, in atomic ratio, 50.0Fe-50.0Co. In Sample Nos. 54 and 55, the composition of the powder A was, in atomic ratio, 83.6Fe-4.4Co-12.0Si. In Sample Nos. 56 and 57, the composition of the powder A was 89.4Fe-8.6Si-2.0Cr. In Sample Nos. 58 and 59, the composition of the powder A was 80.5Fe-9.0Co-8.5Si-2.0Cr. In Sample Nos. 60 and 61, the composition of the powder A was 73.7Fe-16.4Si-9.9Al. Using XRD, it was confirmed that all of the powders A of Sample Nos. 50 to 61 had a crystalline structure.

TABLE 6

| | | | | | | Particle | | | | Core properties | | |
|---|---|---|---|---|---|---|---|---|---|---|---|---|
| | | Composition | | | | size | M comparison | | | | Rate of | Rate of |
| | Example/ | Powder | Powder | Powder B | Powder A | distribution | | | 0.5 × | | improvement | improvement |
| Sample | Comparative | A | B | pressure | microstructure | D50 | 1 | M | D50 | μ | of Isat | of core loss |
| No. | Example | (—) | (—) | (MPa) | (—) | (μm) | (μm) | (μm) | (μm) | (—) | (%) | (%) |
| 1 | Comparative | FeCoBPSiCr | Fe | 0 | Amorphous | 20.2 | 1.00 | 0.95 | 10.1 | 30 | — | — |
| | Example | | | | | | | | | | | |
| 6 | Example | FeCoBPSiCr | Fe | 98 | Amorphous | 20.1 | 1.00 | 3.81 | 10.1 | 30 | 17.4 | 0.2 |
| 38 | Comparative | FeCoBPSi | Fe | 0 | Amorphous | 20.4 | 1.00 | 0.96 | 10.2 | 30 | — | — |
| | Example | | | | | | | | | | | |
| 39 | Example | FeCoBPSi | Fe | 98 | Amorphous | 20.3 | 1.00 | 3.80 | 10.1 | 30 | 17.4 | 0.2 |
| 40 | Comparative | FeBSiCCr | Fe | 0 | Amorphous | 20.3 | 1.00 | 0.96 | 10.1 | 30 | — | — |
| | Example | | | | | | | | | | | |
| 41 | Example | FeBSiCCr | Fe | 98 | Amorphous | 20.3 | 1.00 | 3.81 | 10.2 | 30 | 17.5 | 0.2 |
| 42 | Comparative | FeBSiC | Fe | 0 | Amorphous | 20.2 | 1.00 | 0.97 | 10.1 | 30 | — | — |
| | Example | | | | | | | | | | | |
| 43 | Example | FeBSiC | Fe | 98 | Amorphous | 20.1 | 1.00 | 3.86 | 10.0 | 30 | 17.4 | 0.2 |
| 44 | Comparative | FeSiBNbCu | Fe | 0 | Nanocrystalline | 20.3 | 1.00 | 0.95 | 10.1 | 30 | — | — |
| | Example | | | | | | | | | | | |
| 45 | Example | FeSiBNbCu | Fe | 98 | Nanocrystalline | 20.3 | 1.00 | 3.81 | 10.1 | 30 | 17.3 | 0.2 |
| 46 | Comparative | FeBPSiCu | Fe | 0 | Nanocrystalline | 20.2 | 1.00 | 0.95 | 10.1 | 30 | — | — |
| | Example | | | | | | | | | | | |
| 47 | Example | FeBPSiCu | Fe | 98 | Nanocrystalline | 20.2 | 1.00 | 3.89 | 10.1 | 30 | 17.4 | 0.2 |
| 48 | Comparative | FeBPSiNbCr | Fe | 0 | Nanocrystalline | 20.2 | 1.00 | 0.96 | 10.1 | 30 | — | — |
| | Example | | | | | | | | | | | |
| 49 | Example | FeBPSiNbCr | Fe | 98 | Nanocrystalline | 20.3 | 1.00 | 3.83 | 10.1 | 30 | 17.4 | 0.2 |
| 50 | Comparative | Fe | Fe | 0 | Crystalline | 20.1 | 1.00 | 0.94 | 10.0 | 30 | — | — |
| | Example | | | | | | | | | | | |
| 51 | Example | Fe | Fe | 98 | Crystalline | 20.4 | 1.00 | 3.77 | 10.2 | 30 | 17.5 | 0.2 |
| 52 | Comparative | FeCo | Fe | 0 | Crystalline | 20.3 | 1.00 | 0.98 | 10.2 | 30 | — | — |
| | Example | | | | | | | | | | | |
| 53 | Example | FeCo | Fe | 98 | Crystalline | 20.0 | 1.00 | 3.85 | 10.0 | 30 | 17.4 | 0.2 |
| 54 | Comparative | FeCoSi | Fe | 0 | Crystalline | 20.2 | 1.00 | 0.97 | 10.1 | 30 | — | — |
| | Example | | | | | | | | | | | |
| 55 | Example | FeCoSi | Fe | 98 | Crystalline | 20.2 | 1.00 | 3.71 | 10.1 | 30 | 17.5 | 0.2 |
| 56 | Comparative | FeSiCr | Fe | 0 | Crystalline | 20.3 | 1.00 | 0.94 | 10.1 | 30 | — | — |
| | Example | | | | | | | | | | | |
| 57 | Example | FeSiCr | Fe | 98 | Crystalline | 20.1 | 1.00 | 3.81 | 10.1 | 30 | 17.3 | 0.2 |
| 58 | Comparative | FeCoSiCr | Fe | 0 | Crystalline | 20.3 | 1.00 | 0.98 | 10.1 | 30 | — | — |
| | Example | | | | | | | | | | | |
| 59 | Example | FeCoSiCr | Fe | 98 | Crystalline | 20.1 | 1.00 | 3.75 | 10.1 | 30 | 17.5 | 0.2 |
| 60 | Comparative | FeSiAl | Fe | 0 | Crystalline | 20.2 | 1.00 | 0.95 | 10.1 | 30 | — | — |
| | Example | | | | | | | | | | | |
| 61 | Example | FeSiAl | Fe | 98 | Crystalline | 20.4 | 1.00 | 3.83 | 10.2 | 30 | 17.4 | 0.2 |

According to Table 6, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition and the microstructure of the powder A being changed.

### (Experiment 7)

Experiment 7 was conducted as in Sample Nos. 1 and 6 except that the composition of the powder A was changed. Mainly the total content of Fe and Co in the composition of the powder A was changed. Table 7 shows the results. As for Experiments 7 to 12, omitted is description of Comparative Examples carried out substantially as in their corresponding samples except that M was too small due to the powder B not being agglomerated.

TABLE 7

| | | | | | | Particle | | | | Core properties | | |
|---|---|---|---|---|---|---|---|---|---|---|---|---|
| | | | Median | | | size | | | | | Rate of | Rate of |
| | Example/ | | diameter | | Powder | distri- | M comparison | | | | improve- | improve- |
| | Com- | Composition | Powder | Powder | B | bution | | | 0.5 × | | ment | ment of |
| Sample | parative | Powder A | A | B | pressure | D50 | 1 | M | D50 | μ | of Isat | core loss |
| No. | Example | Atomic ratio | (μm) | (μm) | (MPa) | (μm) | (μm) | (μm) | (μm) | (—) | (%) | (%) |
| 101 | Example | Fe_{48.30}Co_{20.70}B_{6.50}P_{14.50}Si_{9.00}Cr_{1.00} | 20 | 0.8 | 98 | 20.3 | 1.00 | 3.83 | 10.2 | 30 | 7.0 | 0.2 |
| 102 | Example | Fe_{49.00}Co_{21.00}B_{7.00}P_{14.00}Si_{8.00}Cr_{1.00} | 20 | 0.8 | 98 | 20.2 | 1.00 | 3.84 | 10.1 | 30 | 17.5 | 0.2 |
| 103 | Example | Fe_{50.05}Co_{21.45}B_{7.50}P_{13.50}Si_{9.00}Cr_{1.00} | 20 | 0.8 | 98 | 20.5 | 1.00 | 3.80 | 10.3 | 30 | 17.6 | 0.2 |
| 104 | Example | Fe_{51.10}Co_{21.90}B_{8.00}P_{12.00}Si_{6.00}Cr_{1.00} | 20 | 0.8 | 98 | 20.3 | 1.00 | 3.82 | 10.1 | 30 | 17.6 | 0.2 |
| 105 | Example | Fe_{52.15}Co_{22.35}B_{8.50}P_{10.50}Si_{5.50}Cr_{1.00} | 20 | 0.8 | 98 | 20.5 | 1.00 | 3.85 | 10.3 | 30 | 17.5 | 0.2 |
| 106 | Example | Fe_{53.20}Co_{22.80}B_{9.00}P_{9.00}Si_{5.00}Cr_{1.00} | 20 | 0.8 | 98 | 20.2 | 1.00 | 3.88 | 10.1 | 30 | 17.7 | 0.2 |
| 107 | Example | Fe_{54.25}Co_{23.25}B_{9.50}P_{7.50}Si_{4.50}Cr_{1.00} | 20 | 0.8 | 98 | 20.3 | 1.00 | 3.81 | 10.1 | 30 | 17.4 | 0.2 |
| 108 | Example | Fe_{55.30}Co_{23.70}B_{10.00}P_{6.00}Si_{4.00}Cr_{1.00} | 20 | 0.8 | 98 | 20.2 | 1.00 | 3.86 | 10.1 | 30 | 17.7 | 0.2 |
| 109 | Example | Fe_{56.35}Co_{24.15}B_{10.50}P_{4.50}Si_{3.50}Cr_{1.00} | 20 | 0.8 | 98 | 20.2 | 1.00 | 3.82 | 10.1 | 30 | 17.5 | 0.2 |
| 6 | Example | Fe_{57.40}Co_{24.60}B_{11.00}P_{3.00}Si_{3.00}Cr_{1.00} | 20 | 0.8 | 98 | 20.1 | 1.00 | 3.81 | 10.1 | 30 | 17.4 | 0.2 |
| 110 | Example | Fe_{58.45}Co_{25.05}B_{10.00}P_{3.00}Si_{2.50}Cr_{1.00} | 20 | 0.8 | 98 | 20.5 | 1.00 | 3.86 | 10.3 | 30 | 17.5 | 0.2 |
| 111 | Example | Fe_{59.50}Co_{25.50}B_{9.00}P_{3.00}Si_{2.50}Cr_{0.50} | 20 | 0.8 | 98 | 20.4 | 1.00 | 3.87 | 10.2 | 30 | 17.4 | 0.2 |
| 112 | Example | Fe_{60.55}Co_{25.95}B_{8.00}P_{3.00}Si_{2.00}Cr_{0.50} | 20 | 0.8 | 98 | 20.4 | 1.00 | 3.86 | 10.2 | 30 | 17.7 | 0.2 |
| 113 | Example | Fe_{61.60}Co_{26.40}B_{7.00}P_{2.50}Si_{2.00}Cr_{0.50} | 20 | 0.8 | 98 | 20.4 | 1.00 | 3.87 | 10.2 | 30 | 17.4 | 0.2 |
| 114 | Example | Fe_{63.00}Co_{27.00}B_{6.00}P_{2.00}Si_{1.50}Cr_{0.50} | 20 | 0.8 | 98 | 20.1 | 1.00 | 3.83 | 10.1 | 30 | 17.4 | 0.2 |
| 115 | Example | Fe_{64.40}Co_{27.60}B_{5.00}P_{1.50}Si_{1.00}Cr_{0.50} | 20 | 0.8 | 98 | 20.3 | 1.00 | 3.83 | 10.1 | 30 | 17.5 | 0.2 |
| 116 | Example | Fe_{65.80}Co_{28.20}B_{2.50}P_{1.50}Si_{1.50}Cr_{0.50} | 20 | 0.8 | 98 | 20.1 | 1.00 | 3.81 | 10.1 | 30 | 17.5 | 0.2 |
| 117 | Example | Fe_{67.20}Co_{28.80}B_{2.00}P_{1.50}Si_{0.50} | 20 | 0.8 | 98 | 20.2 | 1.00 | 3.81 | 10.1 | 30 | 17.7 | 0.2 |
| 118 | Example | Fe_{67.90}Co_{29.10}B_{1.50}P_{1.50} | 20 | 0.8 | 98 | 20.5 | 1.00 | 3.83 | 10.3 | 30 | 7.1 | 0.2 |

According to Table 7, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 102 to 117, in which the total content of Fe and Co was 70.00 at % or more and 96.00 at % or less, the rates of improvement of Isat were better compared to Sample Nos. 101 and 118, in which the total content of Fe and Co was outside the above range. It is assumed that a reason why the rate of improvement of Isat of Sample No. 101 was low was that its low magnetic element content reduced magnetic properties compared to other samples. It is assumed that a reason why the rate of improvement of Isat of Sample No. 118 was low was that its lower amorphousness of the powder A than other samples reduced magnetic properties compared to other samples.

### (Experiment 8)

Except that the Fe content, the Co content, and the Ni content of the powder A were changed, Experiment 8 was conducted as in Sample No. 106 and a Comparative Example carried out substantially as in Sample No. 106 except that M was too small due to the powder B not being agglomerated. Table 8 shows the results.

TABLE 8

| | | | | | | Median | | | Particle |
|---|---|---|---|---|---|---|---|---|---|
| | | | | | | diameter | | Powder | size |
| | Example/ | Composition | | | | Powder | Powder | B | distribution |
| Sample | Comparative | Powder A | | | | A | B | pressure | D50 |
| No. | Example | Atomic ratio | | | | (μm) | (μm) | (MPa) | (μm) |
| 121 | Example | Fe_{76.00}Co_{0.00}B_{9.00}P_{9.00}Si_{5.00}Cr_{1.00} | | | | 20 | 0.8 | 98 | 20.1 |
| 122 | Example | Fe_{68.40}Co_{7.60}B_{9.00}P_{9.00}Si_{5.00}Cr_{1.00} | | | | 20 | 0.8 | 98 | 20.4 |
| 123 | Example | Fe_{60.80}Co_{15.20}B_{9.00}P_{9.00}Si_{5.00}Cr_{1.00} | | | | 20 | 0.8 | 98 | 20.1 |
| 106 | Example | Fe_{53.20}Co_{22.80}B_{9.00}P_{9.00}Si_{5.00}Cr_{1.00} | | | | 20 | 0.8 | 98 | 20.2 |
| 124 | Example | Fe_{45.60}Co_{30.40}B_{9.00}P_{9.00}Si_{5.00}Cr_{1.00} | | | | 20 | 0.8 | 98 | 20.2 |
| 125 | Example | Fe_{38.00}Co_{38.00}B_{9.00}P_{9.00}Si_{5.00}Cr_{1.00} | | | | 20 | 0.8 | 98 | 20.3 |
| 126 | Example | Fe_{30.40}Co_{45.60}B_{9.00}P_{9.00}Si_{5.00}Cr_{1.00} | | | | 20 | 0.8 | 98 | 20.2 |
| 127 | Example | Fe_{68.40}Ni_{7.60}B_{9.00}P_{9.00}Si_{5.00}Cr_{1.00} | | | | 20 | 0.8 | 98 | 20.2 |
| 128 | Example | Fe_{60.80}Ni_{15.20}B_{9.00}P_{9.00}Si_{5.00}Cr_{1.00} | | | | 20 | 0.8 | 98 | 20.4 |
| 129 | Example | Fe_{53.20}Ni_{22.80}B_{9.00}P_{9.00}Si_{5.00}Cr_{1.00} | | | | 20 | 0.8 | 98 | 20.2 |
| 130 | Example | Fe_{45.60}Ni_{30.40}B_{9.00}P_{9.00}Si_{5.00}Cr_{1.00} | | | | 20 | 0.8 | 98 | 20.2 |
| 131 | Example | Fe_{38.00}Ni_{38.00}B_{9.00}P_{9.00}Si_{5.00}Cr_{1.00} | | | | 20 | 0.8 | 98 | 20.1 |
| 132 | Example | Fe_{30.40}Ni_{45.60}B_{9.00}P_{9.00}Si_{5.00}Cr_{1.00} | | | | 20 | 0.8 | 98 | 20.1 |
| 133 | Example | Fe_{68.40}Co_{3.80}Ni_{3.80}B_{9.00}P_{9.00}Si_{5.00}Cr_{1.00} | | | | 20 | 0.8 | 98 | 20.4 |
| 134 | Example | Fe_{60.80}Co_{7.60}Ni_{7.60}B_{9.00}P_{9.00}Si_{5.00}Cr_{1.00} | | | | 20 | 0.8 | 98 | 20.5 |
| 135 | Example | Fe_{45.60}Co_{15.20}Ni_{15.20}B_{9.00}P_{9.00}Si_{5.00}Cr_{1.00} | | | | 20 | 0.8 | 98 | 20.2 |
| 136 | Example | Fe_{38.00}Co_{19.00}Ni_{19.00}B_{9.00}P_{9.00}Si_{5.00}Cr_{1.00} | | | | 20 | 0.8 | 98 | 20.3 |
| 137 | Example | Fe_{30.40}Co_{22.80}Ni_{22.80}B_{9.00}P_{9.00}Si_{5.00}Cr_{1.00} | | | | 20 | 0.8 | 98 | 20.3 |
| | | | | | | | | Core properties | |
| | | | | | | | | Rate of | Rate of |
| | | | | M comparison | | | | improve- | improve- |
| | | | | | | 0.5 × | | ment | ment of |
| | | | Sample | 1 | M | D50 | μ | of Isat | core loss |
| | | | No. | (μm) | (μm) | (μm) | (—) | (%) | (%) |
| | | | 121 | 1.00 | 3.80 | 10.1 | 30 | 17.4 | 0.2 |
| | | | 122 | 1.00 | 3.81 | 10.2 | 30 | 17.5 | 0.2 |
| | | | 123 | 1.00 | 3.88 | 10.1 | 30 | 17.4 | 0.2 |
| | | | 106 | 1.00 | 3.88 | 10.1 | 30 | 17.7 | 0.2 |
| | | | 124 | 1.00 | 3.88 | 10.1 | 30 | 17.5 | 0.2 |
| | | | 125 | 1.00 | 3.84 | 10.1 | 30 | 17.4 | 0.2 |
| | | | 126 | 1.00 | 3.88 | 10.1 | 30 | 7.1 | 0.2 |
| | | | 127 | 1.00 | 3.85 | 10.1 | 30 | 17.6 | 0.2 |
| | | | 128 | 1.00 | 3.81 | 10.2 | 30 | 17.4 | 0.2 |
| | | | 129 | 1.00 | 3.86 | 10.1 | 30 | 17.4 | 0.2 |
| | | | 130 | 1.00 | 3.83 | 10.1 | 30 | 17.7 | 0.2 |
| | | | 131 | 1.00 | 3.81 | 10.0 | 30 | 17.4 | 0.2 |
| | | | 132 | 1.00 | 3.81 | 10.1 | 30 | 7.0 | 0.2 |
| | | | 133 | 1.00 | 3.81 | 10.2 | 30 | 17.5 | 0.2 |
| | | | 134 | 1.00 | 3.86 | 10.3 | 30 | 17.7 | 0.2 |
| | | | 135 | 1.00 | 3.82 | 10.1 | 30 | 17.5 | 0.2 |
| | | | 136 | 1.00 | 3.82 | 10.2 | 30 | 17.7 | 0.2 |
| | | | 137 | 1.00 | 3.87 | 10.1 | 30 | 7.1 | 0.2 |

According to Table 8, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 106, 121 to 125, 127 to 131, and 133 to 136, in which the Fe content was not lower than the total content of Co and Ni, the rates of improvement of Isat were better compared to Sample Nos. 126, 132, and 137, in which the Fe content was lower than the total content of Co and Ni. It is assumed that a reason why the rates of improvement of Isat of Sample Nos. 126, 132, and 137 were low was reduction of their magnetic properties compared to other samples.

### (Experiment 9)

Experiment 9 was conducted as in Sample Nos. 40 and 41 except that mainly the C content and the Cr content of the powder A were changed. Table 9 shows the results.

TABLE 9

| | | | | | | Particle | | | | Core properties | | |
|---|---|---|---|---|---|---|---|---|---|---|---|---|
| | | | Median | | | size | | | | | Rate of | Rate of |
| | Example/ | | diameter | | Powder | distri- | M comparison | | | | improve- | improve- |
| | Com- | Composition | Powder | Powder | B | bution | | | 0.5 × | | ment | ment of |
| Sample | parative | Powder A | A | B | pressure | D50 | 1 | M | D50 | μ | of Isat | core loss |
| No. | Example | Atomic ratio | (μm) | (μm) | (MPa) | (μm) | (μm) | (μm) | (μm) | (—) | (%) | (%) |
| 141 | Example | Fe_{72.70}B_{12.00}Si_{12.10}C_{0.00}Cr_{3.20} | 20 | 0.8 | 98 | 20.4 | 1.00 | 3.88 | 10.2 | 30 | 7.1 | 0.2 |
| 142 | Example | Fe_{72.70}B_{12.00}Si_{12.30}C._{0.00}Cr_{3.00} | 20 | 0.8 | 98 | 20.5 | 1.00 | 3.83 | 10.2 | 30 | 17.6 | 0.2 |
| 143 | Example | Fe_{72.70}B_{12.00}Si_{12.60}C_{0.00}Cr_{2.70} | 20 | 0.8 | 98 | 20.4 | 1.00 | 3.84 | 10.2 | 30 | 17.4 | 0.2 |
| 144 | Example | Fe_{72.70}B_{12.00}Si_{12.80}C_{0.00}Cr_{2.50} | 20 | 0.8 | 98 | 20.4 | 1.00 | 3.80 | 10.2 | 30 | 17.4 | 0.2 |
| 145 | Example | Fe_{72.70}B_{11.80}Si_{12.60}C_{0.50}Cr_{2.40} | 20 | 0.8 | 98 | 20.5 | 1.00 | 3.85 | 10.3 | 30 | 17.5 | 0.2 |
| 146 | Example | Fe_{72.70}B_{11.50}Si_{12.40}C_{1.00}Cr_{2.40} | 20 | 0.8 | 98 | 20.5 | 1.00 | 3.85 | 10.2 | 30 | 17.7 | 0.2 |
| 147 | Example | Fe_{72.70}B_{11.00}Si_{11.80}C_{2.30}Cr_{2.20} | 20 | 0.8 | 98 | 20.4 | 1.00 | 3.83 | 10.2 | 30 | 17.5 | 0.2 |
| 41 | Example | Fe_{72.70}B_{10.80}Si_{11.60}C_{2.70}Cr_{2.20} | 20 | 0.8 | 98 | 20.3 | 1.00 | 3.81 | 10.2 | 30 | 17.5 | 0.2 |
| 148 | Example | Fe_{72.70}B_{10.50}Si_{11.20}C_{3.50}Cr_{2.10} | 20 | 0.8 | 98 | 20.4 | 1.00 | 3.83 | 10.2 | 30 | 17.6 | 0.2 |
| 149 | Example | Fe_{72.70}B_{10.30}Si_{11.00}C_{4.00}Cr_{2.00} | 20 | 0.8 | 98 | 20.4 | 1.00 | 3.82 | 10.2 | 30 | 17.7 | 0.2 |
| 150 | Example | Fe_{72.70}B_{9.80}Si_{10.50}C_{5.00}Cr_{2.00} | 20 | 0.8 | 98 | 20.1 | 1.00 | 3.87 | 10.1 | 30 | 17.6 | 0.2 |
| 151 | Example | Fe_{72.70}B_{9.60}Si_{10.30}C_{5.50}Cr_{1.90} | 20 | 0.8 | 98 | 20.2 | 1.00 | 3.86 | 10.1 | 30 | 7.0 | 0.2 |

According to Table 9, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 41 and 142 to 150, in which the C content was 0 at % or more and 5.00 at % or less and the X2 (Cr) content was 0 at % or more and 3.00 at % or less, the rates of improvement of Isat were better compared to Sample No. 141, in which the X2 content exceeded 3.00 at %, and Sample No. 151, in which the C content exceeded 5.00 at %. It is assumed that a reason why the rate of improvement of Isat of Sample No. 141 was low was that the higher the X2 content, the lower the magnetic properties, particularly the saturation flux density, tended to be. It is assumed that a reason why the rate of improvement of Isat of Sample No. 151 was low was that its high C content reduced amorphousness to reduce magnetic properties.

### (Experiment 10)

Experiment 10 was conducted as in Sample Nos. 42 and 43 except that mainly the B content and the Fe content of the powder A were changed; as in Sample Nos. 44 and 45 except that mainly the B content and the Si content of the powder A were changed; as in Sample Nos. 46 and 47 except that mainly the B content and the Si content of the powder A were changed; and as in Sample Nos. 48 and 49 except that mainly the B content, the P content, and the Nb content of the powder A were changed. Table 10 shows the results.

TABLE 10

| | | | | | | Median | | | Particle |
|---|---|---|---|---|---|---|---|---|---|
| | | | | | | diameter | | Powder | size |
| | Example/ | Composition | | | | Powder | Powder | B | distribution |
| Sample | Comparative | Powder A | | | | A | B | pressure | D50 |
| No. | Example | Atomic ratio | | | | (μm) | (μm) | (MPa) | (μm) |
| 161 | Example | Fe_{85.20}B_{9.80}Si_{3.40}C_{1.60} | | | | 20 | 0.8 | 98 | 20.1 |
| 162 | Example | Fe_{84.00}B_{11.00}Si_{3.40}C_{1.60} | | | | 20 | 0.8 | 98 | 20.3 |
| 163 | Example | Fe_{82.80}B_{12.20}Si_{3.40}C_{1.60} | | | | 20 | 0.8 | 98 | 20.3 |
| 43 | Example | Fe_{81.60}B_{13.40}Si_{3.40}C_{1.60} | | | | 20 | 0.8 | 98 | 20.1 |
| 164 | Example | Fe_{80.40}B_{14.60}Si_{3.40}C_{1.60} | | | | 20 | 0.8 | 98 | 20.5 |
| 165 | Example | Fe_{79.30}B_{15.70}Si_{3.40}C_{1.60} | | | | 20 | 0.8 | 98 | 20.4 |
| 166 | Example | Fe_{78.10}B_{16.90}Si_{3.40}C_{1.60} | | | | 20 | 0.8 | 98 | 20.5 |
| 167 | Example | Fe_{76.90}B_{18.10}Si_{3.40}C_{1.60} | | | | 20 | 0.8 | 98 | 20.1 |
| 168 | Example | Fe_{75.00}B_{20.00}Si_{3.40}C_{1.60} | | | | 20 | 0.8 | 98 | 20.5 |
| 169 | Example | Fe_{74.50}B_{20.50}Si_{3.40}C_{1.60} | | | | 20 | 0.8 | 98 | 20.3 |
| 171 | Example | Fe_{73.50}B_{7.00}Si_{15.50}Cu_{1.00}Nb_{3.00} | | | | 20 | 0.8 | 98 | 20.2 |
| 172 | Example | Fe_{73.50}B_{7.50}Si_{15.00}Cu_{1.00}Nb_{3.00} | | | | 20 | 0.8 | 98 | 20.3 |
| 173 | Example | Fe_{73.50}B_{8.00}Si_{14.50}Cu_{1.00}Nb_{3.00} | | | | 20 | 0.8 | 98 | 20.4 |
| 45 | Example | Fe_{73.50}B_{9.00}Si_{13.50}Cu_{1.00}Nb_{3.00} | | | | 20 | 0.8 | 98 | 20.3 |
| 174 | Example | Fe_{73.50}B_{10.00}Si_{12.50}Cu_{1.00}Nb_{3.00} | | | | 20 | 0.8 | 98 | 20.2 |
| 175 | Example | Fe_{73.50}B_{11.00}Si_{11.50}Cu_{1.00}Nb_{3.00} | | | | 20 | 0.8 | 98 | 20.2 |
| 47 | Example | Fe_{82.00}B_{11.00}P_{5.00}Si_{1.00}Cu_{1.00} | | | | 20 | 0.8 | 98 | 20.2 |
| 181 | Example | Fe_{82.00}B_{9.00}P_{5.00}Si_{3.00}Cu_{1.00} | | | | 20 | 0.8 | 98 | 20.3 |
| 182 | Example | Fe_{82.00}B_{7.00}P_{5.00}Si_{5.00}Cu_{1.00} | | | | 20 | 0.8 | 98 | 20.4 |
| 183 | Example | Fe_{82.00}B_{5.00}P_{5.00}Si_{7.00}Cu_{1.00} | | | | 20 | 0.8 | 98 | 20.2 |
| 184 | Example | Fe_{82.00}B_{3.00}P_{5.00}Si_{9.00}Cu_{1.00} | | | | 20 | 0.8 | 98 | 20.3 |
| 185 | Example | Fe_{82.00}B_{2.00}P_{5.00}Si_{10.00}Cu_{1.00} | | | | 20 | 0.8 | 98 | 20.4 |
| 186 | Example | Fe_{82.00}B_{1.00}P_{5.00}Si_{11.00}Cu_{1.00} | | | | 20 | 0.8 | 98 | 20.5 |
| 191 | Example | Fe_{78.00}B_{6.00}P_{2.50}Si_{2.50}Cr_{1.00}Nb_{10.00} | | | | 20 | 0.8 | 98 | 20.4 |
| 192 | Example | Fe_{78.00}B_{7.00}P_{2.50}Si_{2.50}Cr_{1.00}Nb_{9.00} | | | | 20 | 0.8 | 98 | 20.4 |
| 193 | Example | Fe_{78.00}B_{8.00}P_{3.00}Si_{2.50}Cr_{1.00}Nb_{7.50} | | | | 20 | 0.8 | 98 | 20.5 |
| 49 | Example | Fe_{78.00}B_{9.00}P_{3.00}Si_{3.00}Cr_{1.00}Nb_{6.00} | | | | 20 | 0.8 | 98 | 20.3 |
| 194 | Example | Fe_{78.00}B_{10.00}P_{3.00}Si_{3.00}Cr_{1.00}Nb_{3.00} | | | | 20 | 0.8 | 98 | 20.3 |
| 195 | Example | Fe_{78.00}B_{11.00}P_{3.00}Si_{3.00}Cr_{1.00}Nb_{3.00} | | | | 20 | 0.8 | 98 | 20.1 |
| 196 | Example | Fe_{78.00}B_{12.00}P_{3.00}Si_{3.00}Cr_{1.00}Nb_{3.00} | | | | 20 | 0.8 | 98 | 20.1 |
| | | | | | | | | Core properties | |
| | | | | | | | | Rate of | Rate of |
| | | | | M comparison | | | | improve- | improve- |
| | | | | | | 0.5 × | | ment | ment of |
| | | | Sample | 1 | M | D50 | μ | of Isat | core loss |
| | | | No. | (μm) | (μm) | (μm) | (—) | (%) | (%) |
| | | | 161 | 1.00 | 3.81 | 10.1 | 30 | 17.4 | 0.2 |
| | | | 162 | 1.00 | 3.87 | 10.1 | 30 | 17.7 | 0.2 |
| | | | 163 | 1.00 | 3.83 | 10.2 | 30 | 17.5 | 0.2 |
| | | | 43 | 1.00 | 3.86 | 10.0 | 30 | 17.4 | 0.2 |
| | | | 164 | 1.00 | 3.87 | 10.2 | 30 | 17.5 | 0.2 |
| | | | 165 | 1.00 | 3.83 | 10.2 | 30 | 17.7 | 0.2 |
| | | | 166 | 1.00 | 3.83 | 10.2 | 30 | 17.6 | 0.2 |
| | | | 167 | 1.00 | 3.85 | 10.1 | 30 | 17.7 | 0.2 |
| | | | 168 | 1.00 | 3.83 | 10.3 | 30 | 17.4 | 0.2 |
| | | | 169 | 1.00 | 3.81 | 10.2 | 30 | 7.1 | 0.2 |
| | | | 171 | 1.00 | 3.84 | 10.1 | 30 | 7.1 | 0.2 |
| | | | 172 | 1.00 | 3.88 | 10.1 | 30 | 17.4 | 0.2 |
| | | | 173 | 1.00 | 3.81 | 10.2 | 30 | 17.6 | 0.2 |
| | | | 45 | 1.00 | 3.81 | 10.1 | 30 | 17.3 | 0.2 |
| | | | 174 | 1.00 | 3.82 | 10.1 | 30 | 17.7 | 0.2 |
| | | | 175 | 1.00 | 3.83 | 10.1 | 30 | 17.6 | 0.2 |
| | | | 47 | 1.00 | 3.9 | 10.1 | 30 | 17.4 | 0.2 |
| | | | 181 | 1.00 | 3.9 | 10.1 | 30 | 17.5 | 0.2 |
| | | | 182 | 1.00 | 3.9 | 10.1 | 30 | 17.5 | 0.2 |
| | | | 183 | 1.00 | 3.9 | 10.1 | 30 | 17.7 | 0.2 |
| | | | 184 | 1.00 | 3.9 | 10.1 | 30 | 17.5 | 0.2 |
| | | | 185 | 1.00 | 3.9 | 10.1 | 30 | 17.4 | 0.2 |
| | | | 186 | 1.00 | 4.0 | 10.1 | 30 | 7.1 | 0.2 |
| | | | 191 | 1.00 | 3.81 | 10.2 | 30 | 7.1 | 0.2 |
| | | | 192 | 1.00 | 3.80 | 10.2 | 30 | 17.6 | 0.2 |
| | | | 193 | 1.00 | 3.87 | 10.2 | 30 | 17.7 | 0.2 |
| | | | 49 | 1.00 | 3.81 | 10.2 | 30 | 17.6 | 0.2 |
| | | | 194 | 1.00 | 3.83 | 10.1 | 30 | 17.4 | 0.2 |
| | | | 195 | 1.00 | 3.82 | 10.1 | 30 | 17.6 | 0.2 |
| | | | 196 | 1.00 | 3.87 | 10.1 | 30 | 17.6 | 0.2 |

According to Table 10, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 43, 45, 47, 49, 161 to 168, 172 to 175, 181 to 185, and 192 to 196, in which the B content was 2.00 at % or more and 20.00 at % or less, the Si content was 0 at % or more and 15.00 at % or less, and the X3 (Nb) content was 0 at % or more and 9.00 at % or less, the rates of improvement of Isat were better compared to Sample No. 169, in which the B content exceeded 20.00 at %; Sample No. 171, in which the Si content exceeded 15.00 at %; Sample No. 186, in which the B content fell below 2.00 at %; and Sample No. 191, in which the X3 content exceeded 9.00 at %. It is assumed that a reason why the rates of improvement of Isat of Sample Nos. 169 and 186 were low was that too high or too low a B content reduced the amorphousness to reduce magnetic properties. It is assumed that a reason why the rate of improvement of Isat of Sample No. 171 was low was that its high Si content reduced the saturation flux density to reduce magnetic properties. It is assumed that a reason why the rate of improvement of Isat of Sample No. 191 was low was that its high X3 content reduced the Curie point, reducing the saturation flux density at room temperature to reduce magnetic properties.

### (Experiment 11)

With mainly X2 and/or the X2 content of the powder A being changed, Experiment 11 was conducted (each sample and a corresponding Comparative Example carried out substantially as in the sample except that M was too small due to the powder B not being agglomerated). Note that, in Sample No. 200, X2 was not contained. Also note that, in Sample Nos. 201 to 262, Fe and Co of Sample No. 200 were partly substituted by X2. Tables 11A to 11C show the results.

TABLE 11A

| | | | | | | Median | | | Particle |
|---|---|---|---|---|---|---|---|---|---|
| | | | | | | diameter | | Powder | size |
| | Example/ | Composition | | | | Powder | Powder | B | distribution |
| Sample | Comparative | Powder A | | | | A | B | pressure | D50 |
| No. | Example | Atomic ratio | | | | (μm) | (μm) | (MPa) | (μm) |
| 200 | Example | Fe_{53.90}Co_{23.10}B_{9.00}P_{9.00}Si_{5.00} | | | | 20 | 0.8 | 98 | 20.2 |
| 201 | Example | Fe_{53.87}Co_{23.09}B_{9.00}P_{9.00}Si_{5.00}Cu_{0.05} | | | | 20 | 0.8 | 98 | 20.4 |
| 202 | Example | Fe_{53.55}Co_{22.95}B_{9.00}P_{9.00}Si_{5.00}Cu_{0.50} | | | | 20 | 0.8 | 98 | 20.4 |
| 203 | Example | Fe_{53.20}Co_{22.80}B_{9.00}P_{9.00}Si_{5.00}Cu_{1.00} | | | | 20 | 0.8 | 98 | 20.3 |
| 204 | Example | Fe_{51.80}Co_{22.20}B_{9.00}P_{9.00}Si_{5.00}Cu_{3.00} | | | | 20 | 0.8 | 98 | 20.5 |
| 205 | Example | Fe_{53.87}Co_{23.09}B_{9.00}P_{9.00}Si_{5.00}Al_{0.05} | | | | 20 | 0.8 | 98 | 20.3 |
| 206 | Example | Fe_{53.55}Co_{22.95}B_{9.00}P_{9.00}Si_{5.00}Al_{0.50} | | | | 20 | 0.8 | 98 | 20.2 |
| 207 | Example | Fe_{53.20}Co_{22.80}B_{9.00}P_{9.00}Si_{5.00}Al_{1.00} | | | | 20 | 0.8 | 98 | 20.2 |
| 208 | Example | Fe_{51.80}Co_{22.20}B_{9.00}P_{9.00}Si_{5.00}Al_{3.00} | | | | 20 | 0.8 | 98 | 20.4 |
| 209 | Example | Fe_{53.87}Co_{23.09}B_{9.00}P_{9.00}Si_{5.00}Ti_{0.05} | | | | 20 | 0.8 | 98 | 20.1 |
| 210 | Example | Fe_{53.55}Co_{22.95}B_{9.00}P_{9.00}Si_{5.00}Ti_{0.50} | | | | 20 | 0.8 | 98 | 20.5 |
| 211 | Example | Fe_{53.20}Co_{22.80}B_{9.00}P_{9.00}Si_{5.00}Ti_{1.00} | | | | 20 | 0.8 | 98 | 20.3 |
| 212 | Example | Fe_{53.87}Co_{23.09}B_{9.00}P_{9.00}Si_{5.00}V_{0.05} | | | | 20 | 0.8 | 98 | 20.5 |
| 213 | Example | Fe_{53.55}Co_{22.95}B_{9.00}P_{9.00}Si_{5.00}V_{0.50} | | | | 20 | 0.8 | 98 | 20.4 |
| 214 | Example | Fe_{53.20}Co_{22.80}B_{9.00}P_{9.00}Si_{5.00}V_{1.00} | | | | 20 | 0.8 | 98 | 20.5 |
| 215 | Example | Fe_{53.87}Co_{23.09}B_{9.00}P_{9.00}Si_{5.00}Mn_{0.05} | | | | 20 | 0.8 | 98 | 20.3 |
| 216 | Example | Fe_{53.55}Co_{22.95}B_{9.00}P_{9.00}Si_{5.00}Mn_{10.50} | | | | 20 | 0.8 | 98 | 20.4 |
| 217 | Example | Fe_{53.20}Co_{22.80}B_{9.00}P_{9.00}Si_{5.00}Mn_{1.00} | | | | 20 | 0.8 | 98 | 20.5 |
| | | | | | | | | Core properties | |
| | | | | | | | | Rate of | Rate of |
| | | | | M comparison | | | | improve- | improve- |
| | | | | | | 0.5 × | | ment | ment of |
| | | | Sample | 1 | M | D50 | μ | of Isat | core loss |
| | | | No. | (μm) | (μm) | (μm) | (—) | (%) | (%) |
| | | | 200 | 1.00 | 3.88 | 10.1 | 30 | 17.7 | 0.2 |
| | | | 201 | 1.00 | 3.82 | 10.2 | 30 | 17.5 | 0.2 |
| | | | 202 | 1.00 | 3.87 | 10.2 | 30 | 17.6 | 0.2 |
| | | | 203 | 1.00 | 3.84 | 10.1 | 30 | 17.7 | 0.2 |
| | | | 204 | 1.00 | 3.82 | 10.2 | 30 | 17.6 | 0.2 |
| | | | 205 | 1.00 | 3.82 | 10.1 | 30 | 17.7 | 0.2 |
| | | | 206 | 1.00 | 3.89 | 10.1 | 30 | 17.5 | 0.2 |
| | | | 207 | 1.00 | 3.87 | 10.1 | 30 | 17.4 | 0.2 |
| | | | 208 | 1.00 | 3.83 | 10.2 | 30 | 17.5 | 0.2 |
| | | | 209 | 1.00 | 3.85 | 10.1 | 30 | 17.5 | 0.2 |
| | | | 210 | 1.00 | 3.82 | 10.3 | 30 | 17.5 | 0.2 |
| | | | 211 | 1.00 | 3.85 | 10.1 | 30 | 17.4 | 0.2 |
| | | | 212 | 1.00 | 3.88 | 10.2 | 30 | 17.4 | 0.2 |
| | | | 213 | 1.00 | 3.87 | 10.2 | 30 | 17.7 | 0.2 |
| | | | 214 | 1.00 | 3.88 | 10.3 | 30 | 17.5 | 0.2 |
| | | | 215 | 1.00 | 3.87 | 10.1 | 30 | 17.7 | 0.2 |
| | | | 216 | 1.00 | 3.86 | 10.2 | 30 | 17.4 | 0.2 |
| | | | 217 | 1.00 | 3.87 | 10.2 | 30 | 17.7 | 0.2 |

TABLE 11B

| | | | | | | Median | | | Particle |
|---|---|---|---|---|---|---|---|---|---|
| | | | | | | diameter | | Powder | size |
| | Example/ | Composition | | | | Powder | Powder | B | distribution |
| Sample | Comparative | Powder A | | | | A | B | pressure | D50 |
| No. | Example | Atomic ratio | | | | (μm) | (μm) | (MPa) | (μm) |
| 200 | Example | Fe_{53.90}Co_{23.10}B_{9.00}P_{9.00}Si_{5.00} | | | | 20 | 0.8 | 98 | 20.2 |
| 218 | Example | Fe_{53.87}Co_{23.09}B_{9.00}P_{9.00}Si_{5.00}Zn_{0.05} | | | | 20 | 0.8 | 98 | 20.4 |
| 219 | Example | Fe_{53.55}Co_{22.95}B_{9.00}P_{9.00}Si_{5.00}Zn_{0.50} | | | | 20 | 0.8 | 98 | 20.1 |
| 220 | Example | Fe_{53.20}Co_{22.80}B_{9.00}P_{9.00}Si_{5.00}Zn_{1.00} | | | | 20 | 0.8 | 98 | 20.3 |
| 221 | Example | Fe_{53.87}Co_{23.09}B_{9.00}P_{9.00}Si_{5.00}Ga_{0.05} | | | | 20 | 0.8 | 98 | 20.2 |
| 222 | Example | Fe_{53.55}Co_{22.95}B_{9.00}P_{9.00}Si_{5.00}Ga_{0.50} | | | | 20 | 0.8 | 98 | 20.2 |
| 223 | Example | Fe_{53.20}Co_{22.80}B_{9.00}P_{9.00}Si_{5.00}Ga_{1.00} | | | | 20 | 0.8 | 98 | 20.4 |
| 224 | Example | Fe_{53.87}Co_{23.09}B_{9.00}P_{9.00}Si_{5.00}As_{0.05} | | | | 20 | 0.8 | 98 | 20.1 |
| 225 | Example | Fe_{53.55}Co_{22.95}B_{9.00}P_{9.00}Si_{5.00}As_{0.50} | | | | 20 | 0.8 | 98 | 20.4 |
| 226 | Example | Fe_{53.20}Co_{22.80}B_{9.00}P_{9.00}Si_{5.00}As_{1.00} | | | | 20 | 0.8 | 98 | 20.1 |
| 227 | Example | Fe_{53.87}Co_{23.09}B_{9.00}P_{9.00}Si_{5.00}Ag_{0.05} | | | | 20 | 0.8 | 98 | 20.2 |
| 228 | Example | Fe_{53.55}Co_{22.95}B_{9.00}P_{9.00}Si_{5.00}Ag_{0.50} | | | | 20 | 0.8 | 98 | 20.2 |
| 229 | Example | Fe_{53.20}Co_{22.80}B_{9.00}P_{9.00}Si_{5.00}Ag_{1.00} | | | | 20 | 0.8 | 98 | 20.4 |
| 230 | Example | Fe_{53.87}Co_{23.09}B_{9.00}P_{9.00}Si_{5.00}Sn_{0.05} | | | | 20 | 0.8 | 98 | 20.1 |
| 231 | Example | Fe_{53.55}Co_{22.95}B_{9.00}P_{9.00}Si_{5.00}Sn_{0.50} | | | | 20 | 0.8 | 98 | 20.5 |
| 232 | Example | Fe_{53.20}Co_{22.80}B_{9.00}P_{9.00}Si_{5.00}Sn_{1.00} | | | | 20 | 0.8 | 98 | 20.2 |
| 233 | Example | Fe_{53.87}Co_{23.09}B_{9.00}P_{9.00}Si_{5.00}Sb_{0.05} | | | | 20 | 0.8 | 98 | 20.5 |
| 234 | Example | Fe_{53.55}Co_{22.95}B_{9.00}P_{9.00}Si_{5.00}Sb_{0.50} | | | | 20 | 0.8 | 98 | 20.5 |
| 235 | Example | Fe_{53.20}Co_{22.80}B_{9.00}P_{9.00}Si_{5.00}Sb_{1.00} | | | | 20 | 0.8 | 98 | 20.2 |
| | | | | | | | | Core properties | |
| | | | | | | | | Rate of | Rate of |
| | | | | M comparison | | | | improve- | improve- |
| | | | | | | 0.5 × | | ment | ment of |
| | | | Sample | 1 | M | D50 | μ | of Isat | core loss |
| | | | No. | (μm) | (μm) | (μm) | (—) | (%) | (%) |
| | | | 200 | 1.00 | 3.88 | 10.1 | 30 | 17.7 | 0.2 |
| | | | 218 | 1.00 | 3.81 | 10.2 | 30 | 17.5 | 0.2 |
| | | | 219 | 1.00 | 3.83 | 10.1 | 30 | 17.7 | 0.2 |
| | | | 220 | 1.00 | 3.80 | 10.2 | 30 | 17.5 | 0.2 |
| | | | 221 | 1.00 | 3.86 | 10.1 | 30 | 17.7 | 0.2 |
| | | | 222 | 1.00 | 3.88 | 10.1 | 30 | 17.5 | 0.2 |
| | | | 223 | 1.00 | 3.88 | 10.2 | 30 | 17.5 | 0.2 |
| | | | 224 | 1.00 | 3.83 | 10.1 | 30 | 17.5 | 0.2 |
| | | | 225 | 1.00 | 3.83 | 10.2 | 30 | 17.7 | 0.2 |
| | | | 226 | 1.00 | 3.84 | 10.1 | 30 | 17.6 | 0.2 |
| | | | 227 | 1.00 | 3.81 | 10.1 | 30 | 17.7 | 0.2 |
| | | | 228 | 1.00 | 3.88 | 10.1 | 30 | 17.6 | 0.2 |
| | | | 229 | 1.00 | 3.86 | 10.2 | 30 | 17.6 | 0.2 |
| | | | 230 | 1.00 | 3.87 | 10.1 | 30 | 17.4 | 0.2 |
| | | | 231 | 1.00 | 3.88 | 10.2 | 30 | 17.6 | 0.2 |
| | | | 232 | 1.00 | 3.88 | 10.1 | 30 | 17.7 | 0.2 |
| | | | 233 | 1.00 | 3.86 | 10.2 | 30 | 17.7 | 0.2 |
| | | | 234 | 1.00 | 3.85 | 10.3 | 30 | 17.5 | 0.2 |
| | | | 235 | 1.00 | 3.80 | 10.1 | 30 | 17.4 | 0.2 |

TABLE 11C

| | | | | | | | | | | Core properties | | |
|---|---|---|---|---|---|---|---|---|---|---|---|---|
| | | | | | Pow- | Particle | | | | | Rate of | improve- |
| | Example/ | | Median | | der B | size dis- | M comparison | | | | improve- | ment |
| Sam- | Com- | Composition | diameter | | pre- | tribution | | | 0.5 × | | ment | Rate of |
| ple | parative | Powder A | Powder | Powder | ssure | D50 | 1 | M | D50 | μ | of Isat | of core |
| No. | Example | Atomic ratio | A (μm) | B (μm) | (MPa) | (μm) | (μm) | (μm) | (μm) | (—) | (%) | loss (%) |
| 200 | Example | Fe_{53.90}Co_{23.10}B_{9.00}P_{9.00}Si_{5.00} | 20 | 0.8 | 98 | 20.2 | 1.00 | 3.88 | 10.1 | 30 | 17.7 | 0.2 |
| 236 | Example | Fe_{53.87}Co_{23.09}B_{9.00}P_{9.00}Si_{5.00}Au_{0.05} | 20 | 0.8 | 98 | 20.3 | 1.00 | 3.86 | 10.2 | 30 | 17.6 | 0.2 |
| 237 | Example | Fe_{53.55}Co_{22.95}B_{9.00}P_{9.00}Si_{5.00}Au_{0.50} | 20 | 0.8 | 98 | 20.2 | 1.00 | 3.83 | 10.1 | 30 | 17.6 | 0.2 |
| 238 | Example | Fe_{53.20}Co_{22.80}B_{9.00}P_{9.00}Si_{5.00}Au_{1.00} | 20 | 0.8 | 98 | 20.3 | 1.00 | 3.88 | 10.1 | 30 | 17.7 | 0.2 |
| 239 | Example | Fe_{53.87}Co_{23.09}B_{9.00}P_{9.00}Si_{5.00}Bi_{0.05} | 20 | 0.8 | 98 | 20.4 | 1.00 | 3.84 | 10.2 | 30 | 17.5 | 0.2 |
| 240 | Example | Fe_{53.55}Co_{22.95}B_{9.00}P_{9.00}Si_{5.00}Bi_{0.50} | 20 | 0.8 | 98 | 20.4 | 1.00 | 3.88 | 10.2 | 30 | 17.6 | 0.2 |
| 241 | Example | Fe_{53.20}Co_{22.80}B_{9.00}P_{9.00}Si_{5.00}Bi_{1.00} | 20 | 0.8 | 98 | 20.5 | 1.00 | 3.82 | 10.3 | 30 | 17.6 | 0.2 |
| 242 | Example | Fe_{53.87}Co_{23.09}B_{9.00}P_{9.00}Si_{5.00}Y_{0.05} | 20 | 0.8 | 98 | 20.3 | 1.00 | 3.85 | 10.1 | 30 | 17.7 | 0.2 |
| 243 | Example | Fe_{53.55}Co_{22.95}B_{9.00}P_{9.00}Si_{5.00}Y_{0.50} | 20 | 0.8 | 98 | 20.1 | 1.00 | 3.81 | 10.1 | 30 | 17.4 | 0.2 |
| 244 | Example | Fe_{53.20}Co_{22.80}B_{9.00}P_{9.00}Si_{5.00}Y_{1.00} | 20 | 0.8 | 98 | 20.1 | 1.00 | 3.89 | 10.1 | 30 | 17.5 | 0.2 |
| 245 | Example | Fe_{53.87}Co_{23.09}B_{9.00}P_{9.00}Si_{5.00}La_{0.05} | 20 | 0.8 | 98 | 20.3 | 1.00 | 3.83 | 10.2 | 30 | 17.6 | 0.2 |
| 246 | Example | Fe_{53.55}Co_{22.95}B_{9.00}P_{9.00}Si_{5.00}La_{0.50} | 20 | 0.8 | 98 | 20.2 | 1.00 | 3.84 | 10.1 | 30 | 17.7 | 0.2 |
| 247 | Example | Fe_{53.20}Co_{22.80}B_{9.00}P_{9.00}Si_{5.00}La_{1.00} | 20 | 0.8 | 98 | 20.4 | 1.00 | 3.86 | 10.2 | 30 | 17.4 | 0.2 |
| 248 | Example | Fe_{53.87}Co_{23.09}B_{9.00}P_{9.00}Si_{5.00}Pt_{0.05} | 20 | 0.8 | 98 | 20.3 | 1.00 | 3.84 | 10.2 | 30 | 17.5 | 0.2 |
| 249 | Example | Fe_{53.55}Co_{22.95}B_{9.00}P_{9.00}Si_{5.00}Pt₀₅₀ | 20 | 0.8 | 98 | 20.2 | 1.00 | 3.83 | 10.1 | 30 | 17.7 | 0.2 |
| 250 | Example | Fe_{53.20}Co_{22.80}B_{9.00}P_{9.00}Si_{5.00}Pt_{1.00} | 20 | 0.8 | 98 | 20.1 | 1.00 | 3.84 | 10.1 | 30 | 17.6 | 0.2 |
| 251 | Example | Fe_{53.87}Co_{23.09}B_{9.00}P_{9.00}Si_{5.00}S_{0.05} | 20 | 0.8 | 98 | 20.4 | 1.00 | 3.88 | 10.2 | 30 | 17.6 | 0.2 |
| 252 | Example | Fe_{53.55}Co_{22.95}B_{9.00}P_{9.00}Si_{5.00}S_{0.50} | 20 | 0.8 | 98 | 20.1 | 1.00 | 3.81 | 10.1 | 30 | 17.5 | 0.2 |
| 253 | Example | Fe_{53.20}Co_{22.80}B_{9.00}P_{9.00}Si_{5.00}S_{1.00} | 20 | 0.8 | 98 | 20.5 | 1.00 | 3.87 | 10.3 | 30 | 17.4 | 0.2 |
| 254 | Example | Fe_{53.89}Co_{23.10}B_{9.00}P_{9.00}Si_{5.00}Mg_{0.01} | 20 | 0.8 | 98 | 20.4 | 1.00 | 3.81 | 10.2 | 30 | 17.7 | 0.2 |
| 255 | Example | Fe_{53.88}Co_{23.09}B_{9.00}P_{9.00}Si_{5.00}Mg_{0.03} | 20 | 0.8 | 98 | 20.2 | 1.00 | 3.88 | 10.1 | 30 | 17.4 | 0.2 |
| 256 | Example | Fe_{53.83}Co_{23.07}B_{9.00}P_{9.00}Si_{5.00}Mg_{0.10} | 20 | 0.8 | 98 | 20.1 | 1.00 | 3.88 | 10.1 | 30 | 17.7 | 0.2 |
| 257 | Example | Fe_{53.89}Co_{23.10}B_{9.00}P_{9.00}Si_{5.00}Ca_{0.01} | 20 | 0.8 | 98 | 20.1 | 1.00 | 3.80 | 10.1 | 30 | 17.7 | 0.2 |
| 258 | Example | Fe_{53.88}Co_{23.09}B_{9.00}P_{9.00}Si_{5.00}Ca_{0.03} | 20 | 0.8 | 98 | 20.4 | 1.00 | 3.88 | 10.2 | 30 | 17.6 | 0.2 |
| 259 | Example | Fe_{53.83}Co_{23.07}B_{9.00}P_{9.00}Si_{5.00}Ca_{0.10} | 20 | 0.8 | 98 | 20.3 | 1.00 | 3.83 | 10.1 | 30 | 17.4 | 0.2 |
| 260 | Example | Fe_{53.89}Co_{23.10}B_{9.00}P_{9.00}Si_{5.00}N_{0.01} | 20 | 0.8 | 98 | 20.2 | 1.00 | 3.82 | 10.1 | 30 | 17.7 | 0.2 |
| 261 | Example | Fe_{53.88}Co_{23.09}B_{9.00}P_{9.00}Si_{5.00}N_{0.03} | 20 | 0.8 | 98 | 20.4 | 1.00 | 3.85 | 10.2 | 30 | 17.6 | 0.2 |
| 262 | Example | Fe_{53.83}Co_{23.07}B_{9.00}P_{9.00}Si_{5.00}N_{0.10} | 20 | 0.8 | 98 | 20.4 | 1.00 | 3.83 | 10.2 | 30 | 17.6 | 0.2 |

According to Tables 11A to 11C, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

### (Experiment 12)

Except that X2 (Cr) was substituted by X3 (Nb) in the powder A, Experiment 12 was conducted as in Sample No. 106 and a Comparative Example carried out substantially as in Sample No. 106 except that M was too small due to the powder B not being agglomerated. Experiment 12 was further conducted as in such an Example and such a Comparative Example except that X3 and the X3 content were changed and, in response to changes in the X3 content, the B content, the P content, and the Si content were changed. Table 12 shows the results.

TABLE 12

| | | | | | | | | | | Core properties | | |
|---|---|---|---|---|---|---|---|---|---|---|---|---|
| | | | Median | | | Particle | | | | | Rate of | Rate of |
| | Example/ | | diameter | | Powder | size dis- | M comparison | | | | improve- | improve- |
| | Com- | Composition | Pow- | Pow- | B | tribution | | | 0.5 × | | ment | ment |
| Sample | parative | Powder A | der A | der B | pressure | D50 | 1 | M | D50 | μ | of Isat | of core |
| No. | Example | Atomic ratio | (μm) | (μm) | (MPa) | (μm) | (μm) | (μm) | (μm) | (—) | (%) | loss (%) |
| 271 | Example | Fe_{53.20}Co_{22.80}B_{9.00}P_{9.00}Si_{5.00}Nb_{1.00} | 20 | 0.8 | 98 | 20.3 | 1.00 | 3.86 | 10.1 | 30 | 17.7 | 0.2 |
| 272 | Example | Fe_{53.20}Co_{22.80}B_{8.00}P_{8.00}Si_{5.00}Nb_{3.00} | 20 | 0.8 | 98 | 20.5 | 1.00 | 3.84 | 10.3 | 30 | 17.5 | 0.2 |
| 273 | Example | Fe_{53.20}Co_{22.80}B_{8.00}P_{7.00}Si_{4.00}Nb_{5.00} | 20 | 0.8 | 98 | 20.3 | 1.00 | 3.86 | 10.1 | 30 | 17.4 | 0.2 |
| 274 | Example | Fe_{53.20}Co_{22.80}B_{7.00}P_{5.00}Si_{3.00}Nb_{9.00} | 20 | 0.8 | 98 | 20.1 | 1.00 | 3.84 | 10.1 | 30 | 17.4 | 0.2 |
| 275 | Example | Fe_{53.20}Co_{22.80}B_{6.00}P_{5.00}Si_{3.00}Nb_{10.00} | 20 | 0.8 | 98 | 20.3 | 1.00 | 3.81 | 10.2 | 30 | 7.1 | 0.2 |
| 276 | Example | Fe_{53.20}Co_{22.80}B_{9.00}P_{9.00}Si_{5.00}Zr_{1.00} | 20 | 0.8 | 98 | 20.4 | 1.00 | 3.81 | 10.2 | 30 | 17.4 | 0.2 |
| 277 | Example | Fe_{53.20}Co_{22.80}B_{8.00}P_{8.00}Si_{5.00}Zr_{3.00} | 20 | 0.8 | 98 | 20.3 | 1.00 | 3.87 | 10.1 | 30 | 17.4 | 0.2 |
| 278 | Example | Fe_{53.20}Co_{22.80}B_{8.00}P_{7.00}Si_{4.00}Zr_{5.00} | 20 | 0.8 | 98 | 20.4 | 1.00 | 3.84 | 10.2 | 30 | 17.7 | 0.2 |
| 279 | Example | Fe_{53.20}Co_{22.80}B_{7.00}P_{5.00}Si_{3.00}Zr_{9.00} | 20 | 0.8 | 98 | 20.5 | 1.00 | 3.88 | 10.3 | 30 | 17.7 | 0.2 |
| 280 | Example | Fe_{53.20}Co_{22.80}B_{6.00}P_{5.00}Si_{3.00}Zr_{10.00} | 20 | 0.8 | 98 | 20.5 | 1.00 | 3.83 | 10.3 | 30 | 7.1 | 0.2 |
| 281 | Example | Fe_{53.20}Co_{22.80}B_{9.00}P_{9.00}Si_{5.00}Mo_{1.00} | 20 | 0.8 | 98 | 20.2 | 1.00 | 3.84 | 10.1 | 30 | 17.7 | 0.2 |
| 282 | Example | Fe_{53.20}Co_{22.80}B_{8.00}P_{8.00}Si_{5.00}Mo_{3.00} | 20 | 0.8 | 98 | 20.3 | 1.00 | 3.86 | 10.1 | 30 | 17.7 | 0.2 |
| 283 | Example | Fe_{53.20}Co_{22.80}B_{8.00}P_{7.00}Si_{4.00}Mo_{5.00} | 20 | 0.8 | 98 | 20.2 | 1.00 | 3.87 | 10.1 | 30 | 17.7 | 0.2 |
| 284 | Example | Fe_{53.20}Co_{22.80}B_{7.00}P_{5.00}Si_{3.00}Mo_{9.00} | 20 | 0.8 | 98 | 20.3 | 1.00 | 3.83 | 10.1 | 30 | 17.7 | 0.2 |
| 285 | Example | Fe_{53.20}Co_{22.80}B_{6.00}P_{5.00}Si_{3.00}Mo_{10.00} | 20 | 0.8 | 98 | 20.1 | 1.00 | 3.86 | 10.1 | 30 | 7.0 | 0.2 |
| 286 | Example | Fe_{53.20}Co_{22.80}B_{9.00}P_{9.00}Si_{5.00}Hf_{1.00} | 20 | 0.8 | 98 | 20.1 | 1.00 | 3.84 | 10.1 | 30 | 17.7 | 0.2 |
| 287 | Example | Fe_{53.20}Co_{22.80}B_{8.00}P_{8.00}Si_{5.00}Hf_{3.00} | 20 | 0.8 | 98 | 20.5 | 1.00 | 3.88 | 10.3 | 30 | 17.6 | 0.2 |
| 288 | Example | Fe_{53.20}Co_{22.80}B_{8.00}P_{7.00}Si_{4.00}Hf_{5.00} | 20 | 0.8 | 98 | 20.3 | 1.00 | 3.86 | 10.1 | 30 | 17.6 | 0.2 |
| 289 | Example | Fe_{53.20}Co_{22.80}B_{7.00}P_{5.00}Si_{3.00}Hf_{9.00} | 20 | 0.8 | 98 | 20.4 | 1.00 | 3.82 | 10.2 | 30 | 17.4 | 0.2 |
| 290 | Example | Fe_{53.20}Co_{22.80}B_{6.00}P_{5.00}Si_{3.00}Hf_{10.00} | 20 | 0.8 | 98 | 20.5 | 1.00 | 3.86 | 10.3 | 30 | 7.0 | 0.2 |
| 291 | Example | Fe_{53.20}Co_{22.80}B_{9.00}P_{9.00}Si_{5.00}Ta_{1.00} | 20 | 0.8 | 98 | 20.3 | 1.00 | 3.85 | 10.2 | 30 | 17.6 | 0.2 |
| 292 | Example | Fe_{53.20}Co_{22.80}B_{8.00}P_{8.00}Si_{5.00}Ta_{3.00} | 20 | 0.8 | 98 | 20.3 | 1.00 | 3.82 | 10.2 | 30 | 17.5 | 0.2 |
| 293 | Example | Fe_{53.20}Co_{22.80}B_{8.00}P_{7.00}Si_{4.00}Ta_{5.00} | 20 | 0.8 | 98 | 20.3 | 1.00 | 3.82 | 10.1 | 30 | 17.5 | 0.2 |
| 294 | Example | Fe_{53.20}Co_{22.80}B_{7.00}P_{5.00}Si_{3.00}Ta_{9.00} | 20 | 0.8 | 98 | 20.4 | 1.00 | 3.84 | 10.2 | 30 | 17.4 | 0.2 |
| 295 | Example | Fe_{53.20}Co_{22.80}B_{6.00}P_{5.00}Si_{3.00}Ta_{10.00} | 20 | 0.8 | 98 | 20.4 | 1.00 | 3.86 | 10.2 | 30 | 7.1 | 0.2 |
| 296 | Example | Fe_{53.20}Co_{22.80}B_{9.00}P_{9.00}Si_{5.00}W_{1.00} | 20 | 0.8 | 98 | 20.5 | 1.00 | 3.84 | 10.3 | 30 | 17.6 | 0.2 |
| 297 | Example | Fe_{53.20}Co_{22.80}B_{8.00}P_{8.00}Si_{5.00}W_{3.00} | 20 | 0.8 | 98 | 20.2 | 1.00 | 3.82 | 10.1 | 30 | 17.7 | 0.2 |
| 298 | Example | Fe_{53.20}Co_{22.80}B_{8.00}P_{7.00}Si_{4.00}W_{5.00} | 20 | 0.8 | 98 | 20.3 | 1.00 | 3.85 | 10.2 | 30 | 17.4 | 0.2 |
| 299 | Example | Fe_{53.20}Co_{22.80}B_{7.00}P_{5.00}Si_{3.00}W_{9.00} | 20 | 0.8 | 98 | 20.5 | 1.00 | 3.81 | 10.2 | 30 | 17.7 | 0.2 |
| 300 | Example | Fe_{53.20}Co_{22.80}B_{6.00}P_{5.00}Si_{3.00}W_{10.00} | 20 | 0.8 | 98 | 20.4 | 1.00 | 3.85 | 10.2 | 30 | 7.1 | 0.2 |

According to Table 12, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 271 to 274, 276 to 279, 281 to 284, 286 to 289, 291 to 294, and 296 to 299, in which the X3 content was 0 at % or more and 9.00 at % or less, the rates of improvement of Isat were better compared to Sample Nos. 275, 280, 285, 290, 295, and 300, in which the X3 content exceeded 9.00 at %. It is assumed that a reason why the rates of improvement of Isat of Sample Nos. 275, 280, 285, 290, 295, and 300 were low was that their high X3 content reduced the Curie points, reducing the saturation flux density at room temperature to reduce magnetic properties.

### (Experiment 13)

Experiment 13 was conducted as in Sample Nos. 1 and 6 except that the composition of the powder B was changed. Table 13 shows the results. In each sample, the powder B was appropriately prepared using a known method.

In Sample Nos. 62 and 63, the composition of the powder B was a composition substantially containing only Co. In Sample Nos. 64 and 65, the composition of the powder B was, in atomic ratio, 50.0Fe-50.0Co. In Sample Nos. 66 and 67, the composition of the powder B was, in atomic ratio, 90.0Fe-10.0Si. In Sample Nos. 68 and 69, the composition of the powder B was, in atomic ratio, 20.0Fe-80.0Ni. Using XRD, it was confirmed that all of the powders B of Sample Nos. 62 to 69 had a crystalline structure.

TABLE 13

| | | | | | | | | | Core properties | | |
|---|---|---|---|---|---|---|---|---|---|---|---|
| | | | | | Particle size | M comparison | | | | Rate of | Rate of |
| | Example/ | Composition | | Powder B | distribution | | | 0.5 × | | improvement | improvement |
| Sample | Comparative | Powder A | Powder B | pressure | D50 | 1 | M | D50 | μ | of Isat | of core loss |
| No. | Example | (—) | (—) | (MPa) | (μm) | (μm) | (μm) | (μm) | (—) | (%) | (%) |
| 1 | Comparative Example | FeCoBPSiCr | Fe | 0 | 20.2 | 1.00 | 0.95 | 10.1 | 30 | — | — |
| 6 | Example | FeCoBPSiCr | Fe | 98 | 20.1 | 1.00 | 3.81 | 10.1 | 30 | 17.4 | 0.2 |
| 62 | Comparative Example | FeCoBPSiCr | Co | 0 | 20.3 | 1.00 | 0.95 | 10.1 | 30 | — | — |
| 63 | Example | FeCoBPSiCr | Co | 98 | 20.2 | 1.00 | 3.85 | 10.1 | 30 | 17.4 | 0.2 |
| 64 | Comparative Example | FeCoBPSiCr | FeCo | 0 | 20.4 | 1.00 | 0.94 | 10.2 | 30 | — | — |
| 65 | Example | FeCoBPSiCr | FeCo | 98 | 20.2 | 1.00 | 3.83 | 10.1 | 30 | 17.5 | 0.2 |
| 66 | Comparative Example | FeCoBPSiCr | FeSi | 0 | 20.4 | 1.00 | 0.95 | 10.2 | 30 | — | — |
| 67 | Example | FeCoBPSiCr | FeSi | 98 | 20.2 | 1.00 | 3.80 | 10.1 | 30 | 17.4 | 0.2 |
| 68 | Comparative Example | FeCoBPSiCr | FeNi | 0 | 20.4 | 1.00 | 0.95 | 10.2 | 30 | — | — |
| 69 | Example | FeCoBPSiCr | FeNi | 98 | 20.3 | 1.00 | 3.82 | 10.1 | 30 | 17.3 | 0.2 |

According to Table 13, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition and the microstructure of the powder B being changed.

### (Experiment 14)

Experiment 14 was conducted substantially as in Sample Nos. 56 and 57 except that the volume-based median diameter (D50) of the powder A was changed. Table 14 shows the results.

TABLE 14

| | | | | | | | | | Core properties | | |
|---|---|---|---|---|---|---|---|---|---|---|---|
| | | Median | | | Particle size | M comparison | | | | Rate of | Rate of |
| | | diameter | | Powder B | distribution | | | 0.5 × | | improvement | improvement |
| Sample | Example/ | Powder A | Powder B | pressure | D50 | 1 | M | D50 | μ | of Isat | of core loss |
| No. | Comparative Example | (μm) | (μm) | (MPa) | (μm) | (μm) | (μm) | (μm) | (—) | (%) | (%) |
| 96 | Comparative Example | 4 | 0.8 | 0 | 4.0 | 1.00 | 0.42 | 2.0 | 30 | — | — |
| 97 | Example | 4 | 0.8 | 98 | 4.0 | 1.00 | 1.06 | 2.0 | 30 | 6.6 | 0.2 |
| 98 | Comparative Example | 8 | 0.8 | 0 | 8.0 | 1.00 | 0.95 | 4.0 | 30 | — | — |
| 99 | Example | 8 | 0.8 | 98 | 8.0 | 1.00 | 1.85 | 4.0 | 30 | 10.3 | 0.2 |
| 100 | Comparative Example | 10 | 0.8 | 0 | 10.0 | 1.00 | 0.96 | 5.0 | 30 | — | — |
| 101 | Example | 10 | 0.8 | 98 | 10.0 | 1.00 | 2.26 | 5.0 | 30 | 11.4 | 0.2 |
| 102 | Comparative Example | 15 | 0.8 | 0 | 15.1 | 1.00 | 0.98 | 7.5 | 30 | — | — |
| 103 | Example | 15 | 0.8 | 98 | 15.0 | 1.00 | 3.25 | 7.5 | 30 | 14.8 | 0.2 |
| 56 | Comparative Example | 20 | 0.8 | 0 | 20.3 | 1.00 | 0.99 | 10.1 | 30 | — | — |
| 57 | Example | 20 | 0.8 | 98 | 20.1 | 1.00 | 3.81 | 10.1 | 30 | 17.3 | 0.2 |
| 104 | Comparative Example | 30 | 0.8 | 0 | 29.9 | 1.00 | 0.99 | 14.9 | 30 | — | — |
| 105 | Example | 30 | 0.8 | 98 | 29.8 | 1.00 | 6.26 | 14.9 | 30 | 17.8 | 0.2 |
| 106 | Comparative Example | 40 | 0.8 | 0 | 40.2 | 1.00 | 1.00 | 20.1 | 30 | — | — |
| 107 | Example | 40 | 0.8 | 98 | 40.1 | 1.00 | 8.33 | 20.1 | 30 | 13.5 | 0.2 |
| 108 | Comparative Example | 50 | 0.8 | 0 | 59.7 | 1.00 | 1.00 | 29.9 | 30 | — | — |
| 109 | Example | 50 | 0.8 | 98 | 60.0 | 1.00 | 15.04 | 30.0 | 30 | 5.0 | 0.2 |

According to Table 14, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the volume-based median diameter (D50) of the powder A being changed.

In particular, in each Example in which D50 was 8.0 μm or more and 45.0 μm or less, DC superimposition characteristics were better.

Note that Experiments 3 and 14 were experiments conducted for the same purpose except that the composition and the microstructure of the powder A differed between Experiments 3 and 14.

### (Experiment 15)

Experiment 15 was conducted as in Sample Nos. 1, 6, and 12 to 17 of Experiments 1 and 2 except that the powder B having a volume-based median diameter of 0.8 μm was partly substituted by a powder C, which was a carbonyl iron powder, similar to the powder B except for having a volume-based median diameter of 3 μm. Note that, unlike the powder B, the powder C did not agglomerate. Table 15 shows the results.

TABLE 15

| | | | | | | | | | | Core properties | | |
|---|---|---|---|---|---|---|---|---|---|---|---|---|
| | | | | | | Particle | | | | | Rate of | Rate of |
| | Example/ | Mixing ratio | | | Powder | size | M comparison | | | | improve- | improve- |
| | | Powder | Powder | Powder | B | distribution | | | 0.5 × | | ment | ment |
| Sample | Comparative | A | B | C | pressure | D50 | 1 | M | D50 | μ | of Isat | of core |
| No. | Example | (wt %) | (wt %) | (wt %) | (MPa) | (μm) | (μm) | (μm) | (μm) | (—) | (%) | loss (%) |
| 70 | Comparative | 90 | 5 | 5 | 0 | 20.1 | 1.00 | 0.93 | 10.1 | 30 | — | — |
| | Example | | | | | | | | | | | |
| 71 | Example | 90 | 5 | 5 | 98 | 20.2 | 1.00 | 3.23 | 10.1 | 30 | 15.6 | 0.2 |
| 72 | Comparative | 80 | 10 | 10 | 0 | 20.2 | 1.00 | 0.94 | 10.1 | 30 | — | — |
| | Example | | | | | | | | | | | |
| 73 | Example | 80 | 10 | 10 | 98 | 20.1 | 1.00 | 3.85 | 10.1 | 30 | 17.2 | 0.2 |
| 74 | Comparative | 50 | 25 | 25 | 0 | 19.8 | 1.00 | 0.96 | 9.9 | 30 | — | — |
| | Example | | | | | | | | | | | |
| 75 | Example | 50 | 25 | 25 | 98 | 19.9 | 1.00 | 5.11 | 9.9 | 30 | 18.1 | 0.2 |
| 76 | Comparative | 30 | 35 | 35 | 0 | 19.8 | 1.00 | 0.97 | 9.9 | 30 | — | — |
| | Example | | | | | | | | | | | |
| 77 | Example | 30 | 35 | 35 | 98 | 19.7 | 1.00 | 8.44 | 9.9 | 30 | 12.1 | 0.2 |

According to Table 15, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite use of the powder C in addition to the powders A and B.

### (Experiment 16)

Experiment 16 was conducted as in Sample Nos. 70 and 71 of Experiment 15 except that the composition and the microstructure of the powder C were changed. Table 16 shows the results.

The composition and the microstructure of the powder C of Sample Nos. 78 and 79 were the same as those of the powder B of Sample Nos. 62 and 63. The composition and the microstructure of the powder C of Sample Nos. 80 and 81 were the same as those of the powder B of Sample Nos. 64 and 65. The composition and the microstructure of the powder C of Sample Nos. 82 and 83 were the same as those of the powder B of Sample Nos. 66 and 67. The composition and the microstructure of the powder C of Sample Nos. 84 and 85 were the same as those of the powder B of Sample Nos. 68 and 69. In each of Sample Nos. 78 to 85, the powder C was appropriately prepared using a known method.

The composition and the microstructure of the powder C of Sample Nos. 86 and 87 were the same as those of the powder A of Sample Nos. 38 and 39. The composition and the microstructure of the powder C of Sample Nos. 88 and 89 were the same as those of the powder A of Sample Nos. 40 and 41. The composition and the microstructure of the powder C of Sample Nos. 90 and 91 were the same as those of the powder A of Sample Nos. 44 and 45. The composition and the microstructure of the powder C of Sample Nos. 92 and 93 were the same as those of the powder A of Sample Nos. 46 and 47. The composition and the microstructure of the powder C of Sample Nos. 94 and 95 were the same as those of the powder A of Sample Nos. 48 and 49. In each of Sample Nos. 86 to 95, the powder C was appropriately prepared using the gas atomization method, similarly to the powder A.

TABLE 16

| | | | | | | Particle | | | | Core properties | | |
|---|---|---|---|---|---|---|---|---|---|---|---|---|
| | | | | | Powder | size dis- | M comparison | | | | Rate of | Rate of |
| | Example/ | Composition | | | B | tribution | | | 0.5 × | | improve- | improvement |
| Sample | Comparative | Powder A | Powder B | Powder C | pressure | D50 | 1 | M | D50 | μ | ment of | of core loss |
| No. | Example | (—) | (—) | (—) | (MPa) | (μm) | (μm) | (μm) | (μm) | (—) | Isat (%) | (%) |
| 70 | Comparative | FeCoBPSiCr | Fe | Fe | 0 | 20.2 | 1.00 | 0.94 | 10.1 | 30 | — | — |
| | Example | | | | | | | | | | | |
| 71 | Example | FeCoBPSiCr | Fe | Fe | 98 | 20.1 | 1.00 | 3.85 | 10.1 | 30 | 17.2 | 0.2 |
| 78 | Comparative | FeCoBPSiCr | Fe | Co | 0 | 20.2 | 1.00 | 0.94 | 10.1 | 30 | — | — |
| | Example | | | | | | | | | | | |
| 79 | Example | FeCoBPSiCr | Fe | Co | 98 | 20.2 | 1.00 | 3.85 | 10.1 | 30 | 17.3 | 0.2 |
| 80 | Comparative | FeCoBPSiCr | Fe | FeCo | 0 | 20.2 | 1.00 | 0.94 | 10.1 | 30 | — | — |
| | Example | | | | | | | | | | | |
| 81 | Example | FeCoBPSiCr | Fe | FeCo | 98 | 20.1 | 1.00 | 3.84 | 10.1 | 30 | 17.2 | 0.2 |
| 82 | Comparative | FeCoBPSiCr | Fe | FeSi | 0 | 20.1 | 1.00 | 0.94 | 10.1 | 30 | — | — |
| | Example | | | | | | | | | | | |
| 83 | Example | FeCoBPSiCr | Fe | FeSi | 98 | 20.2 | 1.00 | 3.85 | 10.1 | 30 | 17.3 | 0.2 |
| 84 | Comparative | FeCoBPSiCr | Fe | FeNi | 0 | 20.2 | 1.00 | 0.93 | 10.1 | 30 | — | — |
| | Example | | | | | | | | | | | |
| 85 | Example | FeCoBPSiCr | Fe | FeNi | 98 | 20.2 | 1.00 | 3.85 | 10.1 | 30 | 17.4 | 0.2 |
| 86 | Comparative | FeCoBPSiCr | Fe | FeCoBPSi | 0 | 20.2 | 1.00 | 0.94 | 10.1 | 30 | — | — |
| | Example | | | | | | | | | | | |
| 87 | Example | FeCoBPSiCr | Fe | FeCoBPSi | 98 | 20.1 | 1.00 | 3.84 | 10.0 | 30 | 17.3 | 0.2 |
| 88 | Comparative | FeCoBPSiCr | Fe | FeBSiCCr | 0 | 20.2 | 1.00 | 0.94 | 10.1 | 30 | — | — |
| | Example | | | | | | | | | | | |
| 89 | Example | FeCoBPSiCr | Fe | FeBSiCCr | 98 | 20.0 | 1.00 | 3.86 | 10.0 | 30 | 17.2 | 0.2 |
| 90 | Comparative | FeCoBPSiCr | Fe | FeSiBNbCu | 0 | 20.1 | 1.00 | 0.94 | 10.1 | 30 | — | — |
| | Example | | | | | | | | | | | |
| 91 | Example | FeCoBPSiCr | Fe | FeSiBNbCu | 98 | 20.1 | 1.00 | 3.85 | 10.1 | 30 | 17.4 | 0.2 |
| 92 | Comparative | FeCoBPSiCr | Fe | FeBPSiCu | 0 | 20.1 | 1.00 | 0.93 | 10.1 | 30 | — | — |
| | Example | | | | | | | | | | | |
| 93 | Example | FeCoBPSiCr | Fe | FeBPSiCu | 98 | 20.1 | 1.00 | 3.85 | 10.1 | 30 | 17.3 | 0.2 |
| 94 | Comparative | FeCoBPSiCr | Fe | FeBPSiNbCr | 0 | 20.1 | 1.00 | 0.93 | 10.1 | 30 | — | — |
| | Example | | | | | | | | | | | |
| 95 | Example | FeCoBPSiCr | Fe | FeBPSiNbCr | 98 | 20.2 | 1.00 | 3.85 | 10.1 | 30 | 17.2 | 0.2 |

According to Table 16, in each Example, in which the powder B agglomerated to satisfy 1.0 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition and the microstructure of the powder C further being changed.

### (Experiment 17)

In Experiment 17, the powder A, which eventually became mostly the large particles in most Examples, was prepared using a water atomization method. The powder A had an Fe—Co—B—P—Si—Cr based composition. Specifically, the composition was 57.4Fe-24.6Co-11.0B-3.0P-3.0Si-1.0Cr in atomic ratio.

Conditions of the water atomization method were as follows. The pressure of high-pressure water was 50.0 MPa or more and 200 MPa or less. The spray amount of a molten metal was 0.5 kg/min or more and 4.0 kg/min or less.

A method of classifying the powder prepared using the water atomization method is described below. First, sieve classification with a sieve having an opening of 250 μm was carried out for the resultant powder to remove coarse particles. Then, air flow classification was carried out so that the powder A had an intended volume-based median diameter (D50). An air flow classification apparatus (FACULTY manufactured by HOSOKAWA MICRON CORPORATION) was used as a classification apparatus for air flow classification at a classifying rotor rotation speed of 4,000 rpm or more and 20,000 rpm or less.

Atomization conditions and air flow classification conditions were appropriately controlled so that the resultant powder A had a D50 shown in Table 17.

Using an ICP analysis, it was confirmed that the composition of a master alloy and the composition of the powder A of each sample approximately corresponded. It was confirmed that the volume-based median diameter (D50) of the resultant powder A was as shown in Table 17. The volume-based median diameter of the powder A was measured using the laser diffraction method with a dry type particle size distribution measurement instrument.

As the powder B, which eventually became mostly the particles other than the large particles in most Examples, a carbonyl iron powder was used. That is, the soft magnetic particles included in the powder B had a composition substantially containing only Fe. A coarse powder and/or a fine powder were appropriately removed using an air flow classification apparatus so that the powder B had a volume-based median diameter (D50) of 0.8 μm. Using an ICP analysis, it was confirmed that the powder B had the intended composition. Using the laser diffraction method with a dry type particle size distribution measurement instrument, it was confirmed that the volume-based median diameter (D50) of the resultant powder B was 0.8 μm.

X-ray diffraction (XRD) measurement was carried out for each powder to measure its amorphous ratio X. When the amorphous ratio X was 85% or more, the powder was deemed to have an amorphous structure. When the amorphous ratio X was less than 85% and the average crystal grain size was 100 nm or less, the powder was deemed to have a nanocrystalline structure. When the amorphous ratio X was less than 85% and the average crystal grain size exceeded 100 nm, the powder was deemed to have a crystalline structure. In Experiment 17, it was confirmed that the powder A had an amorphous structure and that the powder B had a crystalline structure in all samples.

Next, the powder B was agglomerated. First, the powder B and an epoxy resin were mixed. The amount of the epoxy resin added to the powder B was 0.2 parts by mass with respect to 100 parts by mass of the powder B. Then, a mold having a cylindrical shape with a diameter of ø 8 mm was filled with 1 g mixture of the powder B and the epoxy resin. Compression was carried out at a pressure shown in Table 17 for agglomeration. When the agglomerated powder B was prepared for more than 1 g, the above step was repeated multiple times. Note that, in Sample Nos. 301, 303, 305, 307, 309, 311, 313, 315, and 317, the powder B was not compressed and was not agglomerated.

Next, the powder A, the agglomerated powder B, and an epoxy resin were kneaded to give a resin compound. Note that, in Sample Nos. 301, 303, 305, 307, 309, 311, 313, 315, and 317, the powder A, the powder B, and the epoxy resin were kneaded to give a resin compound. The mixing ratio of the powder A to the powder B was 80:20 based on mass. The amount of the epoxy resin was 2.0 parts by mass to 3.0 parts by mass with respect to a total of 100 parts by mass of the powders A and B. The amount of the epoxy resin was controlled so that a magnetic core eventually obtained had a relative permeability μ of 30.

Next, a toroidal mold was filled with the resin compound, and pressure molding was carried out to give a toroidal molded body. The molding pressure was appropriately controlled within a range of 98 MPa or more and 981 MPa or less so that the magnetic core eventually obtained had a relative permeability μ of 30.

After that, the epoxy resin included in the resultant molded body was cured by heating to give the magnetic core. This heat treatment was carried out at 180° C. for 60 minutes. The magnetic core had an outside diameter of 11 mm, an inside diameter of 6.5 mm, and a thickness of 2.5 mm.

A section of the magnetic core of each sample cut in parallel to the molding direction (height direction) was observed using a SEM (SU-5000 manufactured by Hitachi High-Tech Corporation) to calculate D50 using the method described above. Table 17 shows the results.

Further, M was calculated using the method described above and was compared to 0.35 μm and D50/2. Table 17 shows the results.

Methods of measuring relative permeability u, DC superimposition characteristics Isat, and core loss of the toroidal core of each sample were the same as those of Experiment 1.

Table 17 shows the rate of improvement of Isat with respect to benchmark Isat of a sample carried out under the same conditions except that the powder B was not agglomerated. Provided that D50 was less than 4.0 μm, DC superimposition characteristics were deemed good when the rate of improvement of Isat was 0.2% or more; better when the rate of improvement of Isat was 0.5% or more; and best when the rate of improvement of Isat was 1.0% or more. Table 17 shows the results.

The rate of improvement of core loss with respect to benchmark core loss of a sample carried out under the same conditions except that the powder B was not agglomerated was calculated. Table 17 shows the results. Provided that D50 was less than 4.0 μm, a rate of improvement of core loss of 2.0% or more was deemed good; a rate of improvement of core loss of 5.0% or more was deemed better; a rate of improvement of core loss of 10.0% or more was deemed still better; and a rate of improvement of core loss of 15.0% or more was deemed best. Table 17 shows the results.

TABLE 17

| | | | | | | | | | Core properties | | | |
|---|---|---|---|---|---|---|---|---|---|---|---|---|
| | | Median | | | Particle size | M comparison | | | | Rate of | | Rate of |
| | | diameter | | Powder B | distribution | | | 0.5 × | | improve- | Core | improvement |
| Sample | Example/ | Powder A | Powder B | pressure | D50 | 0.35 | M | D50 | μ | mentof | loss | of core loss |
| No. | Comparative Example | (μm) | (μm) | (MPa) | (μm) | (μm) | (μm) | (μm) | (—) | Isat (%) | kW/m³ | (%) |
| 301 | Comparative Example | 0.7 | 0.8 | 0 | 0.7 | 0.35 | 0.20 | 0.35 | 30 | — | 161 | — |
| 302 | Comparative Example | 0.7 | 0.8 | 98 | 0.7 | 0.35 | 0.36 | 0.35 | 30 | 0.2 | 161 | 0.0 |
| 303 | Comparative Example | 0.8 | 0.8 | 0 | 0.8 | 0.35 | 0.20 | 0.40 | 30 | — | 161 | — |
| 304 | Example | 0.8 | 0.8 | 98 | 0.8 | 0.35 | 0.36 | 0.40 | 30 | 0.2 | 156 | 3.0 |
| 305 | Comparative Example | 1.0 | 0.8 | 0 | 1.0 | 0.35 | 0.21 | 0.50 | 30 | — | 161 | — |
| 306 | Example | 1.0 | 0.8 | 98 | 1.0 | 0.35 | 0.37 | 0.50 | 30 | 0.2 | 153 | 5.0 |
| 307 | Comparative Example | 1.5 | 0.8 | 0 | 1.5 | 0.35 | 0.21 | 0.75 | 30 | — | 163 | — |
| 308 | Example | 1.5 | 0.8 | 98 | 1.5 | 0.35 | 0.39 | 0.75 | 30 | 0.3 | 152 | 7.0 |
| 309 | Comparative Example | 2.0 | 0.8 | 0 | 2.0 | 0.35 | 0.22 | 1.00 | 30 | — | 166 | — |
| 310 | Example | 2.0 | 0.8 | 98 | 2.0 | 0.35 | 0.43 | 1.00 | 30 | 0.6 | 147 | 11.0 |
| 311 | Comparative Example | 2.5 | 0.8 | 0 | 2.5 | 0.35 | 0.22 | 1.25 | 30 | — | 169 | — |
| 312 | Example | 2.5 | 0.8 | 98 | 2.5 | 0.35 | 0.49 | 1.25 | 30 | 1.0 | 140 | 17.0 |
| 313 | Comparative Example | 3.0 | 0.8 | 0 | 3.0 | 0.35 | 0.24 | 1.50 | 30 | — | 173 | — |
| 314 | Example | 3.0 | 0.8 | 98 | 3.0 | 0.35 | 0.61 | 1.50 | 30 | 1.2 | 138 | 20.0 |
| 315 | Comparative Example | 3.5 | 0.8 | 0 | 3.5 | 0.35 | 0.28 | 1.75 | 30 | — | 177 | — |
| 316 | Example | 3.5 | 0.8 | 98 | 3.5 | 0.35 | 0.78 | 1.75 | 30 | 1.8 | 154 | 13.0 |
| 317 | Comparative Example | 3.9 | 0.8 | 0 | 3.9 | 0.35 | 0.35 | 1.95 | 30 | — | 181 | — |
| 318 | Example | 3.9 | 0.8 | 98 | 3.9 | 0.35 | 0.99 | 1.95 | 30 | 2.2 | 178 | 2.0 |

According to Table 17, in each Example, in which the powder B agglomerated to satisfy 0.35 μm<M<(0.5×D50), DC superimposition characteristics were improved, and core loss was improved, compared to a corresponding Comparative Example, in which M was too small due to the powder B not being agglomerated. However, in a Comparative Example (Sample No. 302) in which the powder B agglomerated but D50 was too small, core loss was not improved compared to Sample No. 301 under the same conditions except that the powder B was not agglomerated.

According to Table 17, in each Example, in which the volume-based median diameter (D50) of the powder A was changed within a predetermined range and the powder B agglomerated to satisfy 0.35 μm<M<(0.5×D50), DC superimposition characteristics were sufficiently improved, and core loss was improved, compared to a corresponding Comparative Example carried out under substantially the same conditions except that M was too small due to the powder B not being agglomerated.

In particular, in each Example in which D50 was 1.0 μm or more and 3.5 μm or less, the rate of improvement of core loss was better. In each Example in which D50 was 2.0 μm or more and 3.5 μm or less, DC superimposition characteristics as well as the rate of improvement of core loss were better.

### (Experiment 18)

Experiment 18 was conducted as in Sample Nos. 313 and 314 except that the composition of the powder A was changed. Mainly the total content of Fe and Co in the composition of the powder A was changed. Table 18 shows the results. As for Experiments 18 to 23, omitted is description of Comparative Examples carried out substantially as in their corresponding samples except that M was too small due to the powder B not being agglomerated. Note that, in Tables 18 to 23, Isat and core loss are omitted.

TABLE 18

| | | | | | | Particle | | | | Core properties | | |
|---|---|---|---|---|---|---|---|---|---|---|---|---|
| | Example/ | | Median | | Powder | size dis- | M comparison | | | | Rate of | Rate of |
| Sam- | Com- | Composition | diameter | | B | tribution | | | 0.5 × | | improve- | improve- |
| ple | parative | Powder A | Powder | Powder | pressure | D50 | 0.35 | M | D50 | μ | ment | ment of core |
| No. | Example | Atomic ratio | A (μm) | B (μm) | (MPa) | (μm) | (μm) | (μm) | (μm) | (—) | of Isat (%) | loss (%) |
| 321 | Example | Fe_{48.30}Co_{20.70}B_{6.50}P_{14.50}Si_{9.00}Cr_{1.00} | 3.0 | 0.8 | 98 | 3.0 | 0.35 | 0.62 | 1.50 | 30 | 1.2 | 10.1 |
| 322 | Example | Fe_{49.00}Co_{21.00}B_{7.00}P_{14.00}S_{i8.00}Cr_{1.00} | 3.0 | 0.8 | 98 | 3.0 | 0.35 | 0.62 | 1.50 | 30 | 1.2 | 20.1 |
| 323 | Example | Fe_{50.05}Co_{21.45}B_{7.50}P_{13.50}Si_{6.50}Cr_{1.00} | 3.0 | 0.8 | 98 | 3.0 | 0.35 | 0.62 | 1.50 | 30 | 1.2 | 20.0 |
| 324 | Example | Fe_{51.10}Co_{21.90}B_{8.00}P_{12.00}Si_{6.00}Cr_{1.00} | 3.0 | 0.8 | 98 | 3.0 | 0.35 | 0.62 | 1.50 | 30 | 1.2 | 20.0 |
| 325 | Example | Fe_{52.15}Co_{22.35}B_{8.50}P_{10.50}Si_{5.50}Cr_{1.00} | 3.0 | 0.8 | 98 | 3.0 | 0.35 | 0.61 | 1.50 | 30 | 1.2 | 20.3 |
| 326 | Example | Fe_{53.20}Co_{22.80}B_{9.00}P_{9.00}Si_{5.00}Cr_{1.00} | 3.0 | 0.8 | 98 | 3.0 | 0.35 | 0.62 | 1.50 | 30 | 1.2 | 20.4 |
| 327 | Example | Fe_{54.25}Co_{23.25}B_{9.50}P_{7.50}Si_{4.50}Cr_{1.00} | 3.0 | 0.8 | 98 | 3.0 | 0.35 | 0.61 | 1.50 | 30 | 1.2 | 20.0 |
| 328 | Example | Fe_{55.30}Co_{23.70}B_{10.00}P_{6.00}Si_{4.00}Cr_{1.00} | 3.0 | 0.8 | 98 | 3.0 | 0.35 | 0.62 | 1.50 | 30 | 1.2 | 20.2 |
| 329 | Example | Fe_{56.35}Co_{24.15}B_{10.50}P_{4.50}Si_{3.50}Cr_{1.00} | 3.0 | 0.8 | 98 | 3.0 | 0.35 | 0.62 | 1.50 | 30 | 1.2 | 20.2 |
| 314 | Example | Fe_{57.40}Co_{24.60}B_{11.00}P_{3.00}Si_{3.00}Cr_{1.00} | 3.0 | 0.8 | 98 | 3.0 | 0.35 | 0.61 | 1.50 | 30 | 1.2 | 20.0 |
| 330 | Example | Fe_{58.45}Co_{25.05}B_{10.00}P_{3.00}Si_{2.50}Cr_{1.00} | 3.0 | 0.8 | 98 | 3.0 | 0.35 | 0.61 | 1.50 | 30 | 1.2 | 20.0 |
| 331 | Example | Fe_{59.50}Co_{25.50}B_{9.00}P_{3.00}Si_{2.50}Cr_{0.50} | 3.0 | 0.8 | 98 | 3.0 | 0.35 | 0.62 | 1.50 | 30 | 1.2 | 20.4 |
| 332 | Example | Fe_{60.55}Co_{25.95}B_{8.00}P_{3.00}Si_{2.00}Cr_{0.50} | 3.0 | 0.8 | 98 | 3.0 | 0.35 | 0.61 | 1.50 | 30 | 1.2 | 20.3 |
| 333 | Example | Fe_{61.60}Co_{26.40}B_{7.00}P_{2.50}Si_{2.00}Cr_{0.50} | 3.0 | 0.8 | 98 | 3.0 | 0.35 | 0.62 | 1.50 | 30 | 1.2 | 20.1 |
| 334 | Example | Fe_{63.00}Co_{27.00}B_{6.00}P_{2.00}Si_{1.50}Cr_{0.50} | 3.0 | 0.8 | 98 | 3.0 | 0.35 | 0.61 | 1.50 | 30 | 1.2 | 20.1 |
| 335 | Example | Fe_{64.40}Co_{27.60}B_{5.00}P_{1.50}Si_{1.00}Cr_{0.50} | 3.0 | 0.8 | 98 | 3.0 | 0.35 | 0.62 | 1.50 | 30 | 1.2 | 20.4 |
| 336 | Example | Fe_{65.80}Co_{28.20}B_{2.50}P_{1.50}Si_{1.50}Cr_{0.50} | 3.0 | 0.8 | 98 | 3.0 | 0.35 | 0.62 | 1.50 | 30 | 1.2 | 20.0 |
| 337 | Example | Fe_{67.20}Co_{28.80}B_{2.00}P_{1.50}Si_{0.50} | 3.0 | 0.8 | 98 | 3.0 | 0.35 | 0.62 | 1.50 | 30 | 1.2 | 20.0 |
| 338 | Example | Fe_{67.90}Co_{29.10}B_{1.50}P_{1.50} | 3.0 | 0.8 | 98 | 3.0 | 0.35 | 0.62 | 1.50 | 30 | 1.2 | 10.1 |

According to Table 18, in each Example, in which the powder B agglomerated to satisfy 0.35 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 314 and 322 to 337, in which the total content of Fe and Co was 70.00 at % or more and 96.00 at % or less, the rates of improvement of core loss were better compared to Sample Nos. 321 and 338, in which the total content of Fe and Co was outside the above range.

For having a low magnetic element content, Sample No. 321 had lower soft magnetic properties of the powder A compared to other samples. For having lower amorphousness of the powder A than other samples, Sample No. 338 had lower soft magnetic properties of the powder A compared to other samples.

It is assumed that a reason why the rates of improvement of core loss of Sample Nos. 321 and 338 were low was that low soft magnetic properties of the powder A made M less affect core loss.

### (Experiment 19)

Except that the Fe content, the Co content, and the Ni content of the powder A were changed, Experiment 19 was conducted as in Sample No. 326 and a Comparative Example carried out substantially as in Sample No. 326 except that M was too small due to the powder B not being agglomerated. Table 19 shows the results.

TABLE 19

| | | | | | Pow- | Particle | | | | Core properties | | |
|---|---|---|---|---|---|---|---|---|---|---|---|---|
| | Example/ | | Median | | der | size dis- | M comparison | | | | Rate of | Rate of im- |
| Sam- | Com- | Composition | diameter | | B pre- | tribution | | | 0.5 × | | improve- | provement |
| ple | parative | Powder A | Powder | Powder | ssure | D50 | 0.35 | M | D50 | μ | ment of | of core |
| No. | Example | Atomic ratio | A (μm) | B (μm) | (MPa) | (μm) | (μm) | (μm) | (μm) | (—) | Isat (%) | loss (%) |
| 341 | Example | Fe_{76.00}Co_{0.00}B_{9.00}P_{9.00}Si_{5.00}Cr_{1.00} | 3.0 | 0.8 | 98 | 3.0 | 0.35 | 0.62 | 1.50 | 30 | 1.2 | 20.3 |
| 342 | Example | Fe_{68.40}Co_{7.60}B_{9.00}P_{9.00}Si_{5.00}Cr_{1.00} | 3.0 | 0.8 | 98 | 3.0 | 0.35 | 0.61 | 1.50 | 30 | 1.2 | 20.3 |
| 343 | Example | Fe_{60.80}Co_{15.20}B_{9.00}P_{9.00}Si_{5.00}Cr_{1.00} | 3.0 | 0.8 | 98 | 3.0 | 0.35 | 0.62 | 1.50 | 30 | 1.2 | 20.0 |
| 326 | Example | Fe_{53.20}Co_{22.80}B_{9.00}P_{9.00}Si_{5.00}Cr_{1.00} | 3.0 | 0.8 | 98 | 3.0 | 0.35 | 0.62 | 1.50 | 30 | 1.2 | 20.4 |
| 344 | Example | Fe_{45.60}Co_{30.40}B_{9.00}P_{9.00}Si_{5.00}Cr_{1.00} | 3.0 | 0.8 | 98 | 3.0 | 0.35 | 0.62 | 1.50 | 30 | 1.2 | 20.3 |
| 345 | Example | Fe_{38.00}Co_{38.00}B_{9.00}P_{9.00}Si_{5.00}Cr_{1.00} | 3.0 | 0.8 | 98 | 3.0 | 0.35 | 0.62 | 1.50 | 30 | 1.2 | 20.3 |
| 346 | Example | Fe_{30.40}Co_{45.60}B_{9.00}P_{9.00}Si_{5.00}Cr_{1.00} | 3.0 | 0.8 | 98 | 3.0 | 0.35 | 0.62 | 1.50 | 30 | 1.2 | 10.2 |
| 347 | Example | Fe_{68.40}Co_{7.60}B_{9.00}P_{9.00}Si_{5.00}Cr_{1.00} | 3.0 | 0.8 | 98 | 3.0 | 0.35 | 0.62 | 1.50 | 30 | 1.2 | 20.4 |
| 348 | Example | Fe_{60.80}Ni_{15.30}B_{9.00}P_{9.00}Si_{5.00}Cr_{1.00} | 3.0 | 0.8 | 98 | 3.0 | 0.35 | 0.62 | 1.50 | 30 | 1.2 | 20.3 |
| 349 | Example | Fe_{53.20}Ni_{22.80}B_{9.00}P_{9.00}Si_{5.00}Cr_{1.00} | 3.0 | 0.8 | 98 | 3.0 | 0.35 | 0.61 | 1.50 | 30 | 1.2 | 20.2 |
| 350 | Example | Fe_{45.60}Ni_{30.40}B_{9.00}P_{9.00}Si_{5.00}Cr_{1.00} | 3.0 | 0.8 | 98 | 3.0 | 0.35 | 0.61 | 1.50 | 30 | 1.2 | 20.2 |
| 351 | Example | Fe_{38.00}Ni_{38.00}B_{9.00}P_{9.00}Si_{5.00}Cr_{1.00} | 3.0 | 0.8 | 98 | 3.0 | 0.35 | 0.61 | 1.50 | 30 | 1.2 | 20.3 |
| 352 | Example | Fe_{30.40}Ni_{45.60}B_{9.00}P_{9.00}Si_{5.00}Cr_{1.00} | 3.0 | 0.8 | 98 | 3.0 | 0.35 | 0.61 | 1.50 | 30 | 1.2 | 10.0 |
| 353 | Example | Fe_{68.40}Co_{3.80}Ni_{3.80}B_{9.00}P_{9.00}Si_{5.00}Cr_{.00} | 3.0 | 0.8 | 98 | 3.0 | 0.35 | 0.62 | 1.50 | 30 | 1.2 | 20.2 |
| 354 | Example | Fe_{60.80}Co_{7.60}Ni_{7.60}B_{9.00}P_{9.00}Si_{5.00}Cr_{1.00} | 3.0 | 0.8 | 98 | 3.0 | 0.35 | 0.61 | 1.50 | 30 | 1.2 | 20.2 |
| 355 | Example | Fe_{45.60}Co_{15.20}Ni_{15.20}B_{9.00}P_{9.00}Si_{5.00}Cr_{1.00} | 3.0 | 0.8 | 98 | 3.0 | 0.35 | 0.61 | 1.50 | 30 | 1.2 | 20.1 |
| 356 | Example | Fe_{38.00}Co_{19.00}Ni_{19.00}B_{9.00}P_{9.00}Si_{5.00}Cr_{1.00} | 3.0 | 0.8 | 98 | 3.0 | 0.35 | 0.62 | 1.50 | 30 | 1.2 | 20.4 |
| 357 | Example | Fe_{30.40}Co_{2.80}Ni_{2.80}B_{9.00}P_{9.00}Si_{5.00}Cr_{1.00} | 3.0 | 0.8 | 98 | 3.0 | 0.35 | 0.61 | 1.50 | 30 | 1.2 | 10.2 |

According to Table 19, in each Example, in which the powder B agglomerated to satisfy 0.35 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 326, 341 to 345, 347 to 351, and 353 to 356, in which the Fe content was not lower than the total content of Co and Ni, the rates of improvement of core loss were better compared to Sample Nos. 346, 352, and 357, in which the Fe content was lower than the total content of Co and Ni. It is assumed that a reason why the rates of improvement of core loss of Sample Nos. 346, 352, and 357 were low was reduction of soft magnetic properties of the powder A compared to other samples.

### (Experiment 20)

Experiment 20 was conducted as in Sample Nos. 40 and 41 except that the median diameter of the powder A was changed. A sample carried out as in Sample No. 41 except that the median diameter of the powder A was changed was referred to as Sample No. 368.

Further, except that the C content and the Cr content of the powder A were mainly changed, Experiment 20 was conducted as in Sample No. 368 and a Comparative Example carried out substantially as in Sample No. 368 except that M was too small due to the powder B not being agglomerated. Table 20 shows the results.

TABLE 20

| | | | | | | Particle | | | | Core properties | | |
|---|---|---|---|---|---|---|---|---|---|---|---|---|
| | Example/ | | Median | | Powder | size dis- | M comparison | | | | Rate of | Rate of im- |
| Sam- | Com- | Composition | diameter | | B | tribution | | | 0.5 × | | improve- | provement |
| ple | parative | Powder A | Powder | Powder | pressure | D50 | 0.35 | M | D50 | μ | ment of | of core |
| No. | Example | Atomic ratio | A (μm) | B (μm) | (MPa) | (μm) | (μm) | (μm) | (μm) | (—) | Isat (%) | loss (%) |
| 361 | Example | Fe_{72.70}B_{12.00}Si_{12.10}C_{0.00}Cr_{3.20} | 3 | 0.8 | 98 | 3.0 | 0.35 | 0.61 | 1.50 | 30 | 1.2 | 10.1 |
| 362 | Example | Fe_{72.70}B_{12.00}Si_{12.30}C_{0.00}Cr_{3.00} | 3 | 0.8 | 98 | 3.0 | 0.35 | 0.61 | 1.50 | 30 | 1.2 | 20.2 |
| 363 | Example | Fe_{72.70}B_{12.00}Si_{12.60}C_{0.00}Cr_{2.70} | 3 | 0.8 | 98 | 3.0 | 0.35 | 0.62 | 1.50 | 30 | 1.2 | 20.0 |
| 364 | Example | Fe_{72.70}B_{12.00}Si_{12.80}C_{0.00}Cr_{2.50} | 3 | 0.8 | 98 | 3.0 | 0.35 | 0.62 | 1.50 | 30 | 1.2 | 20.2 |
| 365 | Example | Fe_{72.70}B_{11.80}Si_{12.60}C_{0.50}Cr_{2.40} | 3 | 0.8 | 98 | 3.0 | 0.35 | 0.62 | 1.50 | 30 | 1.2 | 20.1 |
| 366 | Example | Fe_{72.70}B_{11.50}Si_{12.40}C_{1.00}Cr_{2.40} | 3 | 0.8 | 98 | 3.0 | 0.35 | 0.61 | 1.50 | 30 | 1.2 | 20.2 |
| 367 | Example | Fe_{72.70}B_{11.00}Si_{11.80}C_{2.30}Cr_{2.20} | 3 | 0.8 | 98 | 3.0 | 0.35 | 0.62 | 1.50 | 30 | 1.2 | 20.1 |
| 368 | Example | Fe_{72.70}B_{10.80}Si_{11.60}C_{2.70}Cr_{2.20} | 3 | 0.8 | 98 | 3.0 | 0.35 | 0.61 | 1.50 | 30 | 1.2 | 20.3 |
| 369 | Example | Fe_{72.70}B_{10.50}Si_{11.20}C_{3.50}Cr_{2.10} | 3 | 0.8 | 98 | 3.0 | 0.35 | 0.62 | 1.50 | 30 | 1.2 | 20.3 |
| 370 | Example | Fe_{72.70}B_{10.30}Si_{11.00}C_{4.00}Cr_{2.00} | 3 | 0.8 | 98 | 3.0 | 0.35 | 0.61 | 1.50 | 30 | 1.2 | 20.2 |
| 371 | Example | Fe_{72.70}B_{9.80}Si_{10.50}C_{5.00}Cr_{2.00} | 3 | 0.8 | 98 | 3.0 | 0.35 | 0.61 | 1.50 | 30 | 1.2 | 20.1 |
| 372 | Example | Fe_{72.70}B_{9.60}Si_{10.30}C_{5.50}Cr_{1.90} | 3 | 0.8 | 98 | 3.0 | 0.35 | 0.61 | 1.50 | 30 | 1.2 | 10.2 |

According to Table 20, in each Example, in which the powder B agglomerated to satisfy 0.35 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 362 to 371, in which the C content was 0 at % or more and 5.00 at % or less and the X2 (Cr) content was 0 at % or more and 3.00 at % or less, the rates of improvement of core loss were better compared to Sample No. 361, in which the X2 content exceeded 3.00 at %, and Sample No. 372, in which the C content exceeded 5.00 at %. It is assumed that a reason why the rate of improvement of core loss of Sample No. 361 was low was that the higher the X2 content, the lower the soft magnetic properties of the powder A tended to be. It is assumed that a reason why the rate of improvement of core loss of Sample No. 372 was low was that its high C content reduced amorphousness of the powder A to reduce its soft magnetic properties.

### (Experiment 21)

Experiment 21 was conducted as in Sample Nos. 42 and 43 except that the median diameter of the powder A was changed. A sample carried out as in Sample No. 43 except that the median diameter of the powder A was changed was referred to as Sample No. 384. Further, except that the B content and the Fe content of the powder A were mainly changed, Experiment 21 was conducted as in Sample No. 384 and a Comparative Example carried out substantially as in Sample No. 384 except that M was too small due to the powder B not being agglomerated. Table 21 shows the results.

Experiment 21 was conducted as in Sample Nos. 44 and 45 except that the median diameter of the powder A was changed. A sample carried out as in Sample No. 45 except that the median diameter of the powder A was changed was referred to as Sample No. 394. Further, except that the B content and the Si content of the powder A were mainly changed, Experiment 21 was conducted as in Sample No. 394 and a Comparative Example carried out substantially as in Sample No. 394 except that M was too small due to the powder B not being agglomerated. Table 21 shows the results.

Experiment 21 was conducted as in Sample Nos. 46 and 47 except that the median diameter of the powder A was changed. A sample carried out as in Sample No. 47 except that the median diameter of the powder A was changed was referred to as Sample No. 397. Further, except that the B content and the Si content of the powder A were mainly changed, Experiment 21 was conducted as in Sample No. 397 and a Comparative Example carried out substantially as in Sample No. 397 except that M was too small due to the powder B not being agglomerated. Table 21 shows the results.

Experiment 21 was conducted as in Sample Nos. 48 and 49 except that the median diameter of the powder A was changed. A sample carried out as in Sample No. 49 except that the median diameter of the powder A was changed was referred to as Sample No. 407. Further, except that the B content, the P content, and the Nb content of the powder A were mainly changed, Experiment 21 was conducted as in Sample No. 407 and a Comparative Example carried out substantially as in Sample No. 407 except that M was too small due to the powder B not being agglomerated. Table 21 shows the results.

TABLE 21

| | | | | | Pow- | Particle | | | | Core properties | | |
|---|---|---|---|---|---|---|---|---|---|---|---|---|
| | Example/ | | Median | | der | size dis- | M comparison | | | | Rate of | Rate of im- |
| Sam- | Com- | Composition | diameter | | B pres- | tribution | | | 0.5 × | | improve- | provement |
| ple | parative | Powder A | Powder | Powder | sure | D50 | 0.35 | M | D50 | μ | ment of | of core |
| No. | Example | Atomic ratio | A (μm) | B (μm) | (MPa) | (μm) | (μm) | (μm) | (μm) | (—) | Isat (%) | loss (%) |
| 381 | Example | Fe_{85.20}B_{9.80}Si_{3.40}C_{1.60} | 3.0 | 0.8 | 98 | 3.0 | 0.35 | 0.61 | 1.50 | 30 | 1.2 | 20.2 |
| 382 | Example | Fe_{84.00}B_{11.00}Si_{3.40}C_{1.60} | 3.0 | 0.8 | 98 | 3.0 | 0.35 | 0.62 | 1.50 | 30 | 1.2 | 20.3 |
| 383 | Example | Fe_{82.80}B_{12.20}Si_{3.40}C_{1.60} | 3.0 | 0.8 | 98 | 3.0 | 0.35 | 0.61 | 1.50 | 30 | 1.2 | 20.3 |
| 384 | Example | Fe_{81.00}B_{13.40}Si_{3.40}C_{1.60} | 3.0 | 0.8 | 98 | 3.0 | 0.35 | 0.61 | 1.50 | 30 | 1.2 | 20.2 |
| 385 | Example | Fe_{80.40}B_{14.60}Si_{3.40}C_{1.60} | 3.0 | 0.8 | 98 | 3.0 | 0.35 | 0.61 | 1.50 | 30 | 1.2 | 20.3 |
| 386 | Example | Fe_{79.30}B_{15.70}Si_{3.40}C_{1.60} | 3.0 | 0.8 | 98 | 3.0 | 0.35 | 0.61 | 1.50 | 30 | 1.2 | 20.3 |
| 387 | Example | Fe_{78.10}B_{16.90}Si_{3.40}C_{1.60} | 3.0 | 0.8 | 98 | 3.0 | 0.35 | 0.62 | 1.50 | 30 | 1.2 | 20.1 |
| 388 | Example | Fe_{76.90}B_{18.10}Si_{3.40}C_{1.60} | 3.0 | 0.8 | 98 | 3.0 | 0.35 | 0.62 | 1.50 | 30 | 1.2 | 20.0 |
| 389 | Example | Fe_{75.00}B_{20.00}Si_{3.40}C_{1.60} | 3.0 | 0.8 | 98 | 3.0 | 0.35 | 0.62 | 1.50 | 30 | 1.2 | 20.4 |
| 390 | Example | Fe_{74.50}B_{20.50}Si_{3.40}C_{1.60} | 3.0 | 0.8 | 98 | 3.0 | 0.35 | 0.61 | 1.50 | 30 | 1.2 | 10.0 |
| 391 | Example | Fe_{73.50}B_{7.00}Si_{15.50}Cu_{1.00}Nb_{3.00} | 3.0 | 0.8 | 98 | 3.0 | 0.35 | 0.61 | 1.50 | 30 | 1.2 | 10.0 |
| 392 | Example | Fe_{73.50}B_{7.50}Si_{15.00}Cu_{1.00}Nb_{3.00} | 3.0 | 0.8 | 98 | 3.0 | 0.35 | 0.62 | 1.50 | 30 | 1.2 | 20.3 |
| 393 | Example | Fe_{73.50}B_{8.00}Si_{14.50}Cu_{1.00}Nb_{3.00} | 3.0 | 0.8 | 98 | 3.0 | 0.35 | 0.62 | 1.50 | 30 | 1.2 | 20.2 |
| 394 | Example | Fe_{73.50}B_{9.00}Si_{13.50}Cu_{1.00}Nb_{3.00} | 3.0 | 0.8 | 98 | 3.0 | 0.35 | 0.62 | 1.50 | 30 | 1.2 | 20.3 |
| 395 | Example | Fe_{73.50}B_{10.00}Si_{12.50}Cu_{1.00}Nb_{3.00} | 3.0 | 0.8 | 98 | 3.0 | 0.35 | 0.61 | 1.50 | 30 | 1.2 | 20.2 |
| 396 | Example | Fe_{73.50}B_{11.00}Si_{11.50}Cu_{1.00}Nb_{3.00} | 3.0 | 0.8 | 98 | 3.0 | 0.35 | 0.62 | 1.50 | 30 | 1.2 | 20.1 |
| 397 | Example | Fe_{82.00}B_{11.00}P_{5.00}Si_{1.00}Cu_{1.00} | 3.0 | 0.8 | 98 | 3.0 | 0.35 | 0.63 | 1.50 | 30 | 1.2 | 20.3 |
| 398 | Example | Fe_{82.00}B_{9.00}P_{5.00}Si_{3.00}Cu_{1.00} | 3.0 | 0.8 | 98 | 3.0 | 0.35 | 0.63 | 1.50 | 30 | 1.2 | 20.4 |
| 399 | Example | Fe_{82.00}B_{7.00}P_{5.00}Si_{5.00}Cu_{1.00} | 3.0 | 0.8 | 98 | 3.0 | 0.35 | 0.62 | 1.50 | 30 | 1.2 | 20.3 |
| 400 | Example | Fe_{82.00}B_{5.00}P_{5.00}Si_{7.00}Cu_{1.00} | 3.0 | 0.8 | 98 | 3.0 | 0.35 | 0.62 | 1.50 | 30 | 1.2 | 20.1 |
| 401 | Example | Fe_{82.00}B_{3.00}P_{5.00}Si_{9.00}Cu_{1.00} | 3.0 | 0.8 | 98 | 3.0 | 0.35 | 0.62 | 1.50 | 30 | 1.2 | 20.4 |
| 402 | Example | Fe_{82.00}B_{2.00}P_{5.00}Si_{10.00}Cu_{1.00} | 3.0 | 0.8 | 98 | 3.0 | 0.35 | 0.62 | 1.50 | 30 | 1.2 | 20.3 |
| 403 | Example | Fe_{82.00}B_{1.00}P_{5.00}Si_{11.00}Cu_{1.00} | 3.0 | 0.8 | 98 | 3.0 | 0.35 | 0.62 | 1.50 | 30 | 1.2 | 10.0 |
| 404 | Example | Fe_{78.00}B_{6.00}P_{2.50}Si_{2.50}Cr_{1.00}Nb_{10.00} | 3.0 | 0.8 | 98 | 3.0 | 0.35 | 0.61 | 1.50 | 30 | 1.2 | 10.2 |
| 405 | Example | Fe_{78.00}B_{7.00}P_{2.50}Si_{2.50}Cr_{1.00}Nb_{9.00} | 3.0 | 0.8 | 98 | 3.0 | 0.35 | 0.62 | 1.50 | 30 | 1.2 | 20.1 |
| 406 | Example | Fe_{78.00}B_{8.00}P_{3.00}Si_{2.50}Cr_{1.00}Nb_{7.50} | 3.0 | 0.8 | 98 | 3.0 | 0.35 | 0.61 | 1.50 | 30 | 1.2 | 20.4 |
| 407 | Example | Fe_{78.00}B_{9.00}P_{3.00}Si_{3.00}Cr_{1.00}Nb_{6.00} | 3.0 | 0.8 | 98 | 3.0 | 0.35 | 0.62 | 1.50 | 30 | 1.2 | 20.0 |
| 408 | Example | Fe_{78.00}B_{10.00}P_{3.00}Si_{3.00}Cr_{1.00}Nb_{5.00} | 3.0 | 0.8 | 98 | 3.0 | 0.35 | 0.62 | 1.50 | 30 | 1.2 | 20.2 |
| 409 | Example | Fe_{78.00}B_{11.00}P_{3.00}Si_{3.00}Cr_{1.00}Nb_{4.00} | 3.0 | 0.8 | 98 | 3.0 | 0.35 | 0.61 | 1.50 | 30 | 1.2 | 20.1 |
| 410 | Example | Fe_{78.00}B_{12.00}P_{3.00}Si_{3.00}Cr_{1.00}Nb_{3.00} | 3.0 | 0.8 | 98 | 3.0 | 0.35 | 0.61 | 1.50 | 30 | 1.2 | 20.3 |

According to Table 21, in each Example, in which the powder B agglomerated to satisfy 0.35 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 381 to 389, 392 to 402, and 405 to 410, in which the B content was 2.00 at % or more and 20.00 at % or less, the Si content was 0 at % or more and 15.00 at % or less, and the X3 (Nb) content was 0 at % or more and 9.00 at % or less, the rates of improvement of core loss were better compared to Sample No. 390, in which the B content exceeded 20.00 at %; Sample No. 391, in which the Si content exceeded 15.00 at %; Sample No. 403, in which the B content fell below 2.00 at %; and Sample No. 404, in which the X3 content exceeded 9.00 at %. It is assumed that a reason why the rates of improvement of core loss of Sample Nos. 390 and 403 were low was that too high or too low a B content reduced the amorphousness of the powder A to reduce its soft magnetic properties. It is assumed that a reason why the rate of improvement of core loss of Sample No. 391 was low was that its high Si content reduced the saturation flux density of the powder A to reduce soft magnetic properties. It is assumed that a reason why the rate of improvement of core loss of Sample No. 404 was low was that its high X3 content reduced the Curie point, reducing the saturation flux density of the powder A at room temperature to reduce soft magnetic properties.

### (Experiment 22)

With mainly X2 and/or the X2 content of the powder A being changed, Experiment 22 was conducted (each sample and a corresponding Comparative Example carried out substantially as in the sample except that M was too small due to the powder B not being agglomerated). Note that, in Sample No. 420, X2 was not contained. Also note that, in Sample Nos. 421 to 482, Fe and Co of Sample No. 420 were partly substituted by X2. Tables 22A to 22C show the results.

TABLE 22A

| | | | | | | Particle | | | | Core properties | | |
|---|---|---|---|---|---|---|---|---|---|---|---|---|
| | Example/ | | Median | | Powder | size dis- | M comparison | | | | Rate of | Rate of im- |
| | Com- | Composition | diameter | | B | tribution | | | 0.5 × | | improve- | provement |
| Sample | parative | Powder A | Powder | Powder | pressure | D50 | 0.35 | M | D50 | μ | ment of | of core |
| No. | Example | Atomic ratio | A (μm) | B (μm) | (MPa) | (μm) | (μm) | (μm) | (μm) | (—) | Isat (%) | loss (%) |
| 420 | Example | Fe_{53.90}Co_{23.10}B_{9.00}P_{9.00}Si_{5.00} | 3 | 0.8 | 98 | 3.0 | 0.35 | 0.62 | 1.50 | 30 | 1.2 | 20.0 |
| 421 | Example | Fe_{53.87}Co_{23.09}B_{9.00}P_{9.00}Si_{5.00}Cu_{0.05} | 3 | 0.8 | 98 | 3.0 | 0.35 | 0.61 | 1.50 | 30 | 1.2 | 20.1 |
| 422 | Example | Fe_{53.55}Co_{22.95}B_{9.00}P_{9.00}Si_{5.00}Cu_{0.50} | 3 | 0.8 | 98 | 3.0 | 0.35 | 0.61 | 1.50 | 30 | 1.2 | 20.2 |
| 423 | Example | Fe_{53.20}Co_{22.80}B_{9.00}P_{9.00}Si_{5.00}Cu_{1.00} | 3 | 0.8 | 98 | 3.0 | 0.35 | 0.61 | 1.50 | 30 | 1.2 | 20.1 |
| 424 | Example | Fe_{51.80}Co_{22.20}B_{9.00}P_{9.00}Si_{5.00}Cu_{3.00} | 3 | 0.8 | 98 | 3.0 | 0.35 | 0.61 | 1.50 | 30 | 1.2 | 20.2 |
| 425 | Example | Fe_{53.87}Co_{23.09}B_{9.00}P_{9.00}Si_{5.00}Al_{0.05} | 3 | 0.8 | 98 | 3.0 | 0.35 | 0.62 | 1.50 | 30 | 1.2 | 20.3 |
| 426 | Example | Fe_{53.55}Co_{22.95}B_{9.00}P_{9.00}Si_{5.00}Al_{0.50} | 3 | 0.8 | 98 | 3.0 | 0.35 | 0.62 | 1.50 | 30 | 1.2 | 20.3 |
| 427 | Example | Fe_{53.20}Co_{22.80}B_{9.00}P_{9.00}Si_{5.00}Al_{1.00} | 3 | 0.8 | 98 | 3.0 | 0.35 | 0.62 | 1.50 | 30 | 1.2 | 20.0 |
| 428 | Example | Fe_{51.80}Co_{22.20}B_{9.00}P_{9.00}Si_{5.00}Al_{3.00} | 3 | 0.8 | 98 | 3.0 | 0.35 | 0.61 | 1.50 | 30 | 1.2 | 20.2 |
| 429 | Example | Fe_{53.87}Co_{23.09}B_{9.00}P_{9.00}Si_{5.00}Ti_{0.05} | 3 | 0.8 | 98 | 3.0 | 0.35 | 0.62 | 1.50 | 30 | 1.2 | 20.1 |
| 430 | Example | Fe_{53.55}Co_{22.95}B_{9.00}P_{9.00}Si_{5.00}Ti_{0.50} | 3 | 0.8 | 98 | 3.0 | 0.35 | 0.62 | 1.50 | 30 | 1.2 | 20.4 |
| 431 | Example | Fe_{53.20}Co_{22.80}B_{9.00}P_{9.00}Si_{5.00}Ti_{1.00} | 3 | 0.8 | 98 | 3.0 | 0.35 | 0.62 | 1.50 | 30 | 1.2 | 20.0 |
| 432 | Example | Fe_{53.87}Co_{23.09}B_{9.00}P_{9.00}Si_{5.00}V_{0.05} | 3 | 0.8 | 98 | 3.0 | 0.35 | 0.61 | 1.50 | 30 | 1.2 | 20.0 |
| 433 | Example | Fe_{53.55}Co_{22.95}B_{9.00}P_{9.00}Si_{5.00}V_{0.50} | 3 | 0.8 | 98 | 3.0 | 0.35 | 0.62 | 1.50 | 30 | 1.2 | 20.3 |
| 434 | Example | Fe_{53.20}Co_{22.80}B_{9.00}P_{9.00}Si_{5.00}V_{1.00} | 3 | 0.8 | 98 | 3.0 | 0.35 | 0.61 | 1.50 | 30 | 1.2 | 20.1 |
| 435 | Example | Fe_{53.87}Co_{23.09}B_{9.00}P_{9.00}Si_{5.00}Mn_{0.05} | 3 | 0.8 | 98 | 3.0 | 0.35 | 0.61 | 1.50 | 30 | 1.2 | 20.3 |
| 436 | Example | Fe_{53.55}Co_{22.95}B_{9.00}P_{9.00}Si_{5.00}Mn_{0.50} | 3 | 0.8 | 98 | 3.0 | 0.35 | 0.62 | 1.50 | 30 | 1.2 | 20.3 |
| 437 | Example | Fe_{53.20}Co_{22.80}B_{9.00}P_{9.00}Si_{5.00}Mn_{1.00} | 3 | 0.8 | 98 | 3.0 | 0.35 | 0.61 | 1.50 | 30 | 1.2 | 20.2 |

TABLE 22B

| | | | | | Pow- | Particle | | | | Core properties | | |
|---|---|---|---|---|---|---|---|---|---|---|---|---|
| | Example/ | | Median | | der | size dis- | M comparison | | | | Rate of | Rate of im- |
| Sam- | Com- | Composition | diameter | | B pre- | tribution | | | 0.5 × | | improve- | provement |
| ple | parative | Powder A | Powder | Powder | ssure | D50 | 0.35 | M | D50 | μ | ment of | of core |
| No. | Example | Atomic ratio | A (μm) | B (μm) | (MPa) | (μm) | (μm) | (μm) | (μm) | (&) | Isat (%) | loss (%) |
| 420 | Example | Fe_{53.90}Co_{23.10}B_{9.00}P_{9.00}Si_{5.00} | 3 | 0.8 | 98 | 3.0 | 0.35 | 0.62 | 1.50 | 30 | 1.2 | 20.0 |
| 438 | Example | Fe_{53.87}Co_{23.09}B_{9.00}P_{9.00}Si_{5.00}Zn_{0.05} | 3 | 0.8 | 98 | 3.0 | 0.35 | 0.62 | 1.50 | 30 | 1.2 | 20.0 |
| 439 | Example | Fe_{53.55}Co_{22.95}B_{9.00}P_{9.00}Si_{5.00}Zn_{0.50} | 3 | 0.8 | 98 | 3.0 | 0.35 | 0.61 | 1.50 | 30 | 1.2 | 20.3 |
| 440 | Example | Fe_{53.20}Co_{22.80}B_{9.00}P_{9.00}Si_{5.00}Zn_{1.00} | 3 | 0.8 | 98 | 3.0 | 0.35 | 0.61 | 1.50 | 30 | 1.2 | 20.0 |
| 441 | Example | Fe_{53.87}Co_{23.09}B_{9.00}P_{9.00}Si_{5.00}Ga_{0.05} | 3 | 0.8 | 98 | 3.0 | 0.35 | 0.61 | 1.50 | 30 | 1.2 | 20.2 |
| 442 | Example | Fe_{53.55}Co_{22.95}B_{9.00}P_{9.00}Si_{5.00}Ga_{0.50} | 3 | 0.8 | 98 | 3.0 | 0.35 | 0.61 | 1.50 | 30 | 1.2 | 20.2 |
| 443 | Example | Fe_{53.20}Co_{22.80}B_{9.00}P_{9.00}Si_{5.00}Ga_{1.00} | 3 | 0.8 | 98 | 3.0 | 0.35 | 0.62 | 1.50 | 30 | 1.2 | 20.3 |
| 444 | Example | Fe_{53.87}Co_{23.09}B_{9.00}P_{9.00}Si_{5.00}As_{0.05} | 3 | 0.8 | 98 | 3.0 | 0.35 | 0.62 | 1.50 | 30 | 1.2 | 20.3 |
| 445 | Example | Fe_{53.55}Co_{22.95}B_{9.00}P_{9.00}Si_{5.00}As_{0.50} | 3 | 0.8 | 98 | 3.0 | 0.35 | 0.61 | 1.50 | 30 | 1.2 | 20.4 |
| 446 | Example | Fe_{53.20}Co_{22.80}B_{9.00}P_{9.00}Si_{5.00}As_{1.00} | 3 | 0.8 | 98 | 3.0 | 0.35 | 0.61 | 1.50 | 30 | 1.2 | 20.1 |
| 447 | Example | Fe_{53.87}Co_{23.09}B_{9.00}P_{9.00}Si_{5.00}Ag_{0.05} | 3 | 0.8 | 98 | 3.0 | 0.35 | 0.61 | 1.50 | 30 | 1.2 | 20.2 |
| 448 | Example | Fe_{53.55}Co_{22.95}B_{9.00}P_{9.00}Si_{5.00}Ag_{0.50} | 3 | 0.8 | 98 | 3.0 | 0.35 | 0.62 | 1.50 | 30 | 1.2 | 20.0 |
| 449 | Example | Fe_{53.20}Co_{22.80}B_{9.00}P_{9.00}Si_{5.00}Ag_{1.00} | 3 | 0.8 | 98 | 3.0 | 0.35 | 0.61 | 1.50 | 30 | 1.2 | 20.2 |
| 450 | Example | Fe_{53.87}Co_{23.09}B_{9.00}P_{9.00}Si_{5.00}Sn_{0.05} | 3 | 0.8 | 98 | 3.0 | 0.35 | 0.62 | 1.50 | 30 | 1.2 | 20.2 |
| 451 | Example | Fe_{53.55}Co_{22.95}B_{9.00}P_{9.00}Si_{5.00}Sn_{0.50} | 3 | 0.8 | 98 | 3.0 | 0.35 | 0.62 | 1.50 | 30 | 1.2 | 20.0 |
| 452 | Example | Fe_{53.20}Co_{22.80}B_{9.00}P_{9.00}Si_{5.00}Sn_{1.00} | 3 | 0.8 | 98 | 3.0 | 0.35 | 0.62 | 1.50 | 30 | 1.2 | 20.0 |
| 453 | Example | Fe_{53.87}Co_{23.09}B_{9.00}P_{9.00}Si_{5.00}Sb_{0.05} | 3 | 0.8 | 98 | 3.0 | 0.35 | 0.61 | 1.50 | 30 | 1.2 | 20.1 |
| 454 | Example | Fe_{53.55}Co_{22.95}B_{9.00}P_{9.00}Si_{5.00}Sb_{0.50} | 3 | 0.8 | 98 | 3.0 | 0.35 | 0.61 | 1.50 | 30 | 1.2 | 20.1 |
| 455 | Example | Fe_{53.20}Co_{22.80}B_{9.00}P_{9.00}Si_{5.00}Sb_{1.00} | 3 | 0.8 | 98 | 3.0 | 0.35 | 0.61 | 1.50 | 30 | 1.2 | 20.4 |

TABLE 22C

| | | | | | | Particle | | | | Core properties | | |
|---|---|---|---|---|---|---|---|---|---|---|---|---|
| | Example/ | | Median | | Powder | size dis- | M comparison | | | | Rate of | Rate of im- |
| | Com- | Composition | diameter | | B | tribution | | | 0.5 × | | improve- | provement |
| Sample | parative | Powder A | Powder | Powder | pressure | D50 | 0.35 | M | D50 | | ment of | of core |
| No. | Example | Atomic ratio | A (μm) | B (μm) | (MPa) | (μm) | (μm) | (μm) | (μm) | (&) | Isat (%) | loss (%) |
| 456 | Example | Fe_{53.87}Co_{23.09}B_{9.00}P_{9.00}Si_{5.00}Au_{0.05} | 3 | 0.8 | 98 | 3.0 | 0.35 | 0.61 | 1.50 | 30 | 1.2 | 20.1 |
| 457 | Example | Fe_{53.55}Co_{22.95}B_{9.00}P_{9.00}Si_{5.00}Au_{0.50} | 3 | 0.8 | 98 | 3.0 | 0.35 | 0.62 | 1.50 | 30 | 1.2 | 20.3 |
| 458 | Example | Fe_{53.20}Co_{22.80}B_{9.00}P_{9.00}Si_{5.00}Au_{1.00} | 3 | 0.8 | 98 | 3.0 | 0.35 | 0.62 | 1.50 | 30 | 1.2 | 20.3 |
| 459 | Example | Fe_{53.87}Co_{23.09}B_{9.00}P_{9.00}Si_{5.00}Bi_{1.05} | 3 | 0.8 | 98 | 3.0 | 0.35 | 0.62 | 1.50 | 30 | 1.2 | 20.1 |
| 460 | Example | Fe_{53.55}Co_{22.95}B_{9.00}P_{9.00}Si_{5.00}Bi_{1.50} | 3 | 0.8 | 98 | 3.0 | 0.35 | 0.62 | 1.50 | 30 | 1.2 | 20.1 |
| 461 | Example | Fe_{53.20}Co_{22.80}B_{9.00}P_{9.00}Si_{5.00}Bi_{1.00} | 3 | 0.8 | 98 | 3.0 | 0.35 | 0.62 | 1.50 | 30 | 1.2 | 20.3 |
| 462 | Example | Fe_{53.87}Co_{23.09}B_{9.00}P_{9.00}Si_{5.00}Y_{0.05} | 3 | 0.8 | 98 | 3.0 | 0.35 | 0.61 | 1.50 | 30 | 1.2 | 20.3 |
| 463 | Example | Fe_{53.55}Co_{22.95}B_{9.00}P_{9.00}Si_{5.00}Y_{0.50} | 3 | 0.8 | 98 | 3.0 | 0.35 | 0.62 | 1.50 | 30 | 1.2 | 20.3 |
| 464 | Example | Fe_{53.20}Co_{22.80}B_{9.00}P_{9.00}Si_{5.00}Y_{1.00} | 3 | 0.8 | 98 | 3.0 | 0.35 | 0.61 | 1.50 | 30 | 1.2 | 20.2 |
| 465 | Example | Fe_{53.87}Co_{23.09}B_{9.00}P_{9.00}Si_{5.00}La_{0.05} | 3 | 0.8 | 98 | 3.0 | 0.35 | 0.62 | 1.50 | 30 | 1.2 | 20.4 |
| 466 | Example | Fe_{53.55}Co_{22.95}B_{9.00}P_{9.00}Si_{5.00}La_{0.50} | 3 | 0.8 | 98 | 3.0 | 0.35 | 0.62 | 1.50 | 30 | 1.2 | 20.1 |
| 467 | Example | Fe_{53.20}Co_{22.80}B_{9.00}P_{9.00}Si_{5.00}La_{1.00} | 3 | 0.8 | 98 | 3.0 | 0.35 | 0.62 | 1.50 | 30 | 1.2 | 20.4 |
| 468 | Example | Fe_{53.87}Co_{23.09}B_{9.00}P_{9.00}Si_{5.00}Pt_{0.05} | 3 | 0.8 | 98 | 3.0 | 0.35 | 0.61 | 1.50 | 30 | 1.2 | 20.3 |
| 469 | Example | Fe_{53.55}Co_{22.95}B_{9.00}P_{9.00}Si_{5.00}Pt_{0.50} | 3 | 0.8 | 98 | 3.0 | 0.35 | 0.62 | 1.50 | 30 | 1.2 | 20.3 |
| 470 | Example | Fe_{53.20}Co_{22.80}B_{9.00}P_{9.00}Si_{5.00}Pt_{1.00} | 3 | 0.8 | 98 | 3.0 | 0.35 | 0.62 | 1.50 | 30 | 1.2 | 20.2 |
| 471 | Example | Fe_{53.87}Co_{23.09}B_{9.00}P_{9.00}Si_{5.00}S_{0.05} | 3 | 0.8 | 98 | 3.0 | 0.35 | 0.62 | 1.50 | 30 | 1.2 | 20.2 |
| 472 | Example | Fe_{53.55}Co_{22.95}B_{9.00}P_{9.00}Si_{5.00}S_{0.50} | 3 | 0.8 | 98 | 3.0 | 0.35 | 0.62 | 1.50 | 30 | 1.2 | 20.3 |
| 473 | Example | Fe_{53.20}Co_{22.80}B_{9.00}P_{9.00}Si_{5.00}S_{1.00} | 3 | 0.8 | 98 | 3.0 | 0.35 | 0.61 | 1.50 | 30 | 1.2 | 20.2 |
| 474 | Example | Fe_{53.89}Co_{23.10}B_{9.00}P_{9.00}Si_{5.00}Mg_{0.01} | 3 | 0.8 | 98 | 3.0 | 0.35 | 0.62 | 1.50 | 30 | 1.2 | 20.1 |
| 475 | Example | Fe_{53.88}Co_{23.09}B_{9.00}P_{9.00}Si_{5.00}Mg_{0.03} | 3 | 0.8 | 98 | 3.0 | 0.35 | 0.62 | 1.50 | 30 | 1.2 | 20.1 |
| 476 | Example | Fe_{53.83}Co_{23.07}B_{9.00}P_{9.00}Si_{5.00}Mg_{0.10} | 3 | 0.8 | 98 | 3.0 | 0.35 | 0.62 | 1.50 | 30 | 1.2 | 20.2 |
| 477 | Example | Fe_{53.89}Co_{23.10}B_{9.00}P_{9.00}Si_{5.00}Ca_{0.01} | 3 | 0.8 | 98 | 3.0 | 0.35 | 0.61 | 1.50 | 30 | 1.2 | 20.3 |
| 478 | Example | Fe_{53.88}Co_{23.09}B_{9.00}P_{9.00}Si_{5.00}Ca_{0.03} | 3 | 0.8 | 98 | 3.0 | 0.35 | 0.62 | 1.50 | 30 | 1.2 | 20.1 |
| 479 | Example | Fe_{53.83}Co_{23.07}B_{9.00}P_{9.00}Si_{5.00}Ca_{0.10} | 3 | 0.8 | 98 | 3.0 | 0.35 | 0.61 | 1.50 | 30 | 1.2 | 20.2 |
| 480 | Example | Fe_{53.89}Co_{23.10}B_{9.00}P_{9.00}Si_{5.00}N_{0.01} | 3 | 0.8 | 98 | 3.0 | 0.35 | 0.61 | 1.50 | 30 | 1.2 | 20.3 |
| 481 | Example | Fe_{53.88}Co_{23.09}B_{9.00}P_{9.00}Si_{5.00}N_{0.03} | 3 | 0.8 | 98 | 3.0 | 0.35 | 0.61 | 1.50 | 30 | 1.2 | 20.1 |
| 482 | Example | Fe_{53.83}Co_{23.07}B_{9.00}P_{9.00}Si_{5.00}N_{0.10} | 3 | 0.8 | 98 | 3.0 | 0.35 | 0.62 | 1.50 | 30 | 1.2 | 20.0 |

According to Tables 22A to 22C, in each Example, in which the powder B agglomerated to satisfy 0.35 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

### (Experiment 23)

Except that X2 (Cr) was substituted by X3 (Nb) in the powder A, Experiment 23 was conducted as in Sample No. 326 and a Comparative Example carried out substantially as in Sample No. 326 except that M was too small due to the powder B not being agglomerated. Experiment 23 was further conducted as in such an Example and such a Comparative Example except that X3 and the X3 content were changed and, in response to changes in the X3 content, the B content, the P content, and the Si content were changed. Table 23 shows the results.

TABLE 23

| | | | | | | Particle | | | | Core properties | | |
|---|---|---|---|---|---|---|---|---|---|---|---|---|
| | Example/ | | Median | | Powder | size dis- | M comparison | | | | Rate of | Rate of im- |
| Sam- | Com- | Composition | diameter | | B pre- | tribution | | | 0.5 × | | improve- | provement |
| ple | parative | Powder A | Powder | Powder | ssure | D50 | 0.35 | M | D50 | | ment of | of core |
| No. | Example | Atomic ratio | A (μm) | B (μm) | (MPa) | (μm) | (μm) | (μm) | (μm) | μ | Isat (%) | loss (%) |
| 491 | Example | Fe_{53.20}Co_{22.80}B_{9.00}P_{9.00}Si_{5.00}Nb_{1.00} | 3 | 0.8 | 98 | 3.0 | 0.35 | 0.61 | 1.50 | 30 | 1.2 | 20.0 |
| 492 | Example | Fe_{53.20}Co_{22.80}B_{8.00}P_{8.00}Si_{5.00}Nb_{3.00} | 3 | 0.8 | 98 | 3.0 | 0.35 | 0.61 | 1.50 | 30 | 1.2 | 20.4 |
| 493 | Example | Fe_{53.20}Co_{22.80}B_{8.00}P_{7.00}Si_{4.00}Nb_{5.00} | 3 | 0.8 | 98 | 3.0 | 0.35 | 0.62 | 1.50 | 30 | 1.2 | 20.1 |
| 494 | Example | Fe_{53.20}Co_{22.80}B_{7.00}P_{5.00}Si_{3.00}Nb_{9.00} | 3 | 0.8 | 98 | 3.0 | 0.35 | 0.62 | 1.50 | 30 | 1.2 | 20.0 |
| 495 | Example | Fe_{53.20}Co_{22.80}B_{6.00}P_{5.00}Si_{3.00}Nb_{10.00} | 3 | 0.8 | 98 | 3.0 | 0.35 | 0.62 | 1.50 | 30 | 1.2 | 10.0 |
| 496 | Example | Fe_{53.20}Co_{22.80}B_{9.00}P_{9.00}Si_{5.00}Zr_{1.00} | 3 | 0.8 | 98 | 3.0 | 0.35 | 0.61 | 1.50 | 30 | 1.2 | 20.2 |
| 497 | Example | Fe_{53.20}Co_{22.80}B_{8.00}P_{8.00}Si_{5.00}Zr_{3.00} | 3 | 0.8 | 98 | 3.0 | 0.35 | 0.61 | 1.50 | 30 | 1.2 | 20.0 |
| 498 | Example | Fe_{53.20}Co_{22.80}B_{8.00}P_{7.00}Si_{4.00}Zr_{5.00} | 3 | 0.8 | 98 | 3.0 | 0.35 | 0.62 | 1.50 | 30 | 1.2 | 20.1 |
| 499 | Example | Fe_{53.20}Co_{22.80}B_{7.00}P_{5.00}Si_{3.00}Zr_{9.00} | 3 | 0.8 | 98 | 3.0 | 0.35 | 0.62 | 1.50 | 30 | 1.2 | 20.1 |
| 500 | Example | Fe_{53.20}Co_{22.80}B_{6.00}P_{5.00}Si_{3.00}Zr_{10.00} | 3 | 0.8 | 98 | 3.0 | 0.35 | 0.61 | 1.50 | 30 | 1.2 | 10.0 |
| 501 | Example | Fe_{53.20}Co_{22.80}B_{9.00}P_{9.00}Si_{5.00}Mo_{1.00} | 3 | 0.8 | 98 | 3.0 | 0.35 | 0.61 | 1.50 | 30 | 1.2 | 20.1 |
| 502 | Example | Fe_{53.20}Co_{22.80}B_{8.00}P_{8.00}Si_{5.00}Mo_{3.00} | 3 | 0.8 | 98 | 3.0 | 0.35 | 0.61 | 1.50 | 30 | 1.2 | 20.3 |
| 503 | Example | Fe_{53.20}Co_{22.80}B_{8.00}P_{7.00}Si_{4.00}Mo_{5.00} | 3 | 0.8 | 98 | 3.0 | 0.35 | 0.62 | 1.50 | 30 | 1.2 | 20.2 |
| 504 | Example | Fe_{53.20}Co_{22.80}B_{7.00}P_{5.00}Si_{3.00}Mo_{9.00} | 3 | 0.8 | 98 | 3.0 | 0.35 | 0.62 | 1.50 | 30 | 1.2 | 20.1 |
| 505 | Example | Fe_{53.20}Co_{22.80}B_{6.00}P_{5.00}Si_{3.00}Mo_{10.00} | 3 | 0.8 | 98 | 3.0 | 0.35 | 0.62 | 1.50 | 30 | 1.2 | 10.1 |
| 506 | Example | Fe_{53.20}Co_{22.80}B_{9.00}P_{9.00}Si_{5.00}Hf_{1.00} | 3 | 0.8 | 98 | 3.0 | 0.35 | 0.62 | 1.50 | 30 | 1.2 | 20.3 |
| 507 | Example | Fe_{53.20}Co_{22.80}B_{8.00}P_{8.00}Si_{5.00}Hf_{3.00} | 3 | 0.8 | 98 | 3.0 | 0.35 | 0.62 | 1.50 | 30 | 1.2 | 20.3 |
| 508 | Example | Fe_{53.20}Co_{22.80}B_{8.00}P_{7.00}Si_{4.00}Hf_{5.00} | 3 | 0.8 | 98 | 3.0 | 0.35 | 0.62 | 1.50 | 30 | 1.2 | 20.2 |
| 509 | Example | Fe_{53.20}Co_{22.80}B_{7.00}P_{5.00}Si_{3.00}Hf_{9.00} | 3 | 0.8 | 98 | 3.0 | 0.35 | 0.62 | 1.50 | 30 | 1.2 | 20.1 |
| 510 | Example | Fe_{53.20}Co_{22.80}B_{6.00}P_{5.00}Si_{3.00}Hf_{10.00} | 3 | 0.8 | 98 | 3.0 | 0.35 | 0.61 | 1.50 | 30 | 1.2 | 10.1 |
| 511 | Example | Fe_{53.20}Co_{22.80}B_{9.00}P_{9.00}Si_{5.00}Ta_{1.00} | 3 | 0.8 | 98 | 3.0 | 0.35 | 0.61 | 1.50 | 30 | 1.2 | 20.2 |
| 512 | Example | Fe_{53.20}Co_{22.80}B_{8.00}P_{8.00}Si_{5.00}Ta_{3.00} | 3 | 0.8 | 98 | 3.0 | 0.35 | 0.61 | 1.50 | 30 | 1.2 | 20.3 |
| 513 | Example | Fe_{53.20}Co_{22.80}B_{8.00}P_{7.00}Si_{4.00}Ta_{5.00} | 3 | 0.8 | 98 | 3.0 | 0.35 | 0.61 | 1.50 | 30 | 1.2 | 20.3 |
| 514 | Example | Fe_{53.20}Co_{22.80}B_{7.00}P_{5.00}Si_{3.00}Ta_{9.00} | 3 | 0.8 | 98 | 3.0 | 0.35 | 0.61 | 1.50 | 30 | 1.2 | 20.2 |
| 515 | Example | Fe_{53.20}Co_{22.80}B_{6.00}P_{5.00}Si_{3.00}Ta_{10.00} | 3 | 0.8 | 98 | 3.0 | 0.35 | 0.62 | 1.50 | 30 | 1.2 | 10.1 |
| 516 | Example | Fe_{53.20}Co_{22.80}B_{9.00}P_{9.00}Si_{5.00}W_{1.00} | 3 | 0.8 | 98 | 3.0 | 0.35 | 0.62 | 1.50 | 30 | 1.2 | 20.1 |
| 517 | Example | Fe_{53.20}Co_{22.80}B_{8.00}P_{8.00}Si_{5.00}W_{3.00} | 3 | 0.8 | 98 | 3.0 | 0.35 | 0.62 | 1.50 | 30 | 1.2 | 20.2 |
| 518 | Example | Fe_{53.20}Co_{22.80}B_{8.00}P_{7.00}Si_{4.00}W_{5.00} | 3 | 0.8 | 98 | 3.0 | 0.35 | 0.61 | 1.50 | 30 | 1.2 | 20.2 |
| 519 | Example | Fe_{53.20}Co_{22.80}B_{7.00}P_{5.00}Si_{3.00}W_{9.00} | 3 | 0.8 | 98 | 3.0 | 0.35 | 0.62 | 1.50 | 30 | 1.2 | 20.1 |
| 520 | Example | Fe_{53.20}Co_{22.80}B_{6.00}P_{5.00}Si_{3.00}W_{10.00} | 3 | 0.8 | 98 | 3.0 | 0.35 | 0.62 | 1.50 | 30 | 1.2 | 10.2 |

According to Table 23, in each Example, in which the powder B agglomerated to satisfy 0.35 μm<M<(0.5×D50), DC superimposition characteristics were sufficiently improved, and core loss was improved, compared to a corresponding Comparative Example carried out under substantially the same conditions except that M was too small due to the powder B not being agglomerated, despite the composition of the powder A being changed.

In particular, in Sample Nos. 491 to 494, 496 to 499, 501 to 504, 506 to 509, 511 to 514, and 516 to 519, in which the X3 content was 0 at % or more and 9.00 at % or less, the rates of improvement of core loss were better compared to Sample Nos. 495, 500, 505, 510, 515, and 520, in which the X3 content exceeded 9.00 at %. It is assumed that a reason why the rates of improvement of core loss of Sample Nos. 495, 500, 505, 510, 515, and 520 were low was that their high X3 content reduced the Curie points of the powders A, reducing the saturation flux density of the powders A at room temperature to reduce soft magnetic properties.

Using a TEM, electron diffraction patterns were obtained to confirm the microstructures of the soft magnetic particles included in the magnetic core of each sample manufactured in Experiments 1 to 23. It was confirmed that the microstructures of the soft magnetic particles derived from the powder A, the soft magnetic particles derived from the powder B, and the soft magnetic particles derived from the powder C did not substantially change after molding.

1. A magnetic core comprising:
soft magnetic particles,
wherein 1.0 μm<M<(0.5×D50) is satisfied, where
M denotes a median of AL of large particles;
AL denotes an average distance from one of the large particles to three of the large particles nearest to the one of the large particles; and
the large particles denote soft magnetic particles having a particle size of (0.5×D50) or more in a volume-based particle size distribution of the soft magnetic particles.

2. The magnetic core according to claim 1, wherein D50 is 4.0 μm or more and 60.0 μm or less.

3. The magnetic core according to claim 1, wherein
a composition of at least some of the soft magnetic particles is represented by a composition formula (Fe₁₋ₚX1ₚ)_{100-(a+b+c+d++f)}BₐP_{b}Si_{c}C_{d}X2ₑX3_{f} in atomic ratio, where
X1 comprises at least one selected from the group consisting of Co and Ni;
X2 comprises at least one selected from the group consisting of Ti, Cr, Mn, Al, Ga, Ag, Zn, S, Ca, Mg, V, Sn, As, Sb, Bi, N, Au, Cu, a rare earth element, and a platinum-group element;
X3 comprises at least one selected from the group consisting of Zr, Nb, Mo, Hf, Ta, and W; and
0≤p≤0.5,
2.00≤a≤20.00,
0.00≤b≤14.00,
0.00≤c≤15.00,
0.00≤d≤5.00,
0.00≤e≤3.00,
0.00≤f≤9.00, and
70.00≤100−(a+b+c+d+e+f)≤96.00 are satisfied.

4. The magnetic core according to claim 1, wherein at least some of the soft magnetic particles comprise only Fe or comprise Fe and Co and/or Ni.

5. A magnetic device comprising the magnetic core according to claim 1.

6. An electronic apparatus comprising the magnetic core according to claim 1.

7. A magnetic core comprising:
soft magnetic particles,
wherein
0.35 μm<M<(0.5×D50) is satisfied; and
D50 is 0.80 μm or more and less than 4.0 μm,
where
M denotes a median of AL of large particles;
AL denotes an average distance from one of the large particles to three of the large particles nearest to the one of the large particles; and
the large particles denote soft magnetic particles having a particle size of (0.5×D50) or more in a volume-based particle size distribution of the soft magnetic particles.

8. The magnetic core according to claim 7, wherein
a composition of at least some of the soft magnetic particles is represented by a composition formula (Fe₁₋ₚX1ₚ)_{100 (a+b+c+d+e+f)}BₐP_{b}Si_{c}C_{d}X2ₑX3_{f} in atomic ratio,
where
X1 comprises at least one selected from the group consisting of Co and Ni;
X2 comprises at least one selected from the group consisting of Ti, Cr, Mn, Al, Ga, Ag, Zn, S, Ca, Mg, V, Sn, As, Sb, Bi, N, Au, Cu, a rare earth element, and a platinum-group element;
X3 comprises at least one selected from the group consisting of Zr, Nb, Mo, Hf, Ta, and W; and
0≤p≤0.5,
2.00≤a≤20.00,
0.00≤b≤14.00,
0.00≤c≤15.00,
0.00≤d≤5.00,
0.00≤e≤3.00,
0.00≤f≤9.00, and
70.00≤100−(a+b+c+d+e+f)≤96.00 are satisfied.

9. The magnetic core according to claim 7, wherein at least some of the soft magnetic particles comprise only Fe or comprise Fe and Co and/or Ni.

10. A magnetic device comprising the magnetic core according to claim 7.

11. An electronic apparatus comprising the magnetic core according to claim 7.
